(19) United States
(12) Patent Application Publication
(10) Pub. No.: US 2025/0279425 A1
(43) Pub. Date: Sep. 4, 2025

(54) POSITIVE ELECTRODE ACTIVE MATERIAL, LITHIUM ION BATTERY, ELECTRONIC DEVICE, AND VEHICLE

(71) Applicant: SEMICONDUCTOR ENERGY LABORATORY CO., LTD., Atsugi-shi, Kanagawa-ken (JP)

(72) Inventors: Jo SAITO, Atsugi, Kanagawa (JP); Atsushi KAWATSUKI, Yokohama, Kanagawa (JP); Yohei MOMMA, Isehara, Kanagawa (JP); Shuhei YOSHITOMI, Ayase, Kanagawa (JP); Kenta NAKANISHI, Atsugi, Kanagawa (JP); Tetsuya KAKEHATA, Isehara, Kanagawa (JP)

(21) Appl. No.: 18/858,957

(22) PCT Filed: Apr. 12, 2023
(86) PCT No.: PCT/IB2023/053724

§ 371 Date: Oct. 22, 2024

(30) Foreign Application Priority Data
Apr. 25, 2022 (JP) 2022-071918

(51) Int. Cl. H01M 4/525; B60L 50/60; C01G 53/66; H01M 10/0525; H01M 10/0568; H01M 10/0569

(52) U.S. Cl. CPC H01M 4/525; C01G 53/66; H01M 10/0525; H01M 10/0568; H01M 10/0569; B60L 50/60; C01P 2002/72; C01P 2002/76; C01P 2002/77; C01P 2002/85; C01P 2006/40; H01M 2220/20; H01M 2300/004

(57) ABSTRACT

A lithium ion battery having excellent charge performance and discharge performance even in a low-temperature environment is provided. A lithium ion battery includes a positive electrode active material containing cobalt, oxygen, magnesium, aluminum, and nickel. The median diameter of the positive electrode active material is greater than or equal to 1 μm and less than or equal to 12 μm. Magnesium and aluminum are included in a surface portion. The surface portion is a region within 50 nm in depth from the surface of the positive electrode active material. The positive electrode active material includes a region where magnesium is distributed closer to the surface side of the positive electrode active material than aluminum is.

### TECHNICAL FIELD

The invention disclosed in this specification and the like (hereinafter sometimes referred to as “the present invention” in this specification and the like) relates to a power storage device, a secondary battery, and the like. In particular, the present invention relates to a lithium ion battery.

The present invention relates to an object, a method, or a manufacturing method. Alternatively, the present invention relates to a process, a machine, manufacture, or a composition (composition of matter). Alternatively, the present invention relates to a semiconductor device, a display device, a light-emitting device, a power storage device, a lighting device, an electronic device, a vehicle, or a manufacturing method thereof.

### BACKGROUND ART

In recent years, a variety of power storage devices such as lithium ion batteries, lithium ion capacitors, and air batteries have been actively developed. In particular, demands for lithium ion batteries with high output and high energy density have rapidly grown with the development of the semiconductor industry, for portable information terminals such as mobile phones, smartphones, and laptop computers, portable music players, digital cameras, medical equipment, electric-powered vehicles such as hybrid electric vehicles (HVs), electric vehicles (EVs), and plug-in hybrid electric vehicles (PHVs), and the like, and the lithium ion batteries are essential as rechargeable energy supply sources for today's information society.

In a lithium ion battery, charge performance and/or discharge performance changes depending on a charge environment and/or a discharge environment of the battery. For example, it is known that the discharge capacity of a lithium ion battery changes depending on a discharge temperature.

Thus, a lithium ion battery having excellent battery performance even in a low-temperature environment is required (e.g., see Patent Document 1).

As image processing software, for example, ImageJ (Non-Patent Document 1 to Non-Patent Document 3) is known. Using this software makes it possible to analyze the shape of a positive electrode active material, for example.

### REFERENCE

### Patent Document

[Patent Document 1] Japanese Published Patent Application No. 2015-026608

### Non-Patent Documents

[Non-Patent Document 1] Rasband, W. S., ImageJ, U. S. National Institutes of Health, Bethesda, Maryland, USA, http://rsb.info.nih.gov/ij/, 1997-2012.
[Non-Patent Document 2] Schneider, C. A., Rasband, W. S., Eliceiri, K. W., “NIH Image to ImageJ: 25 years of image analysis”, Nature Methods, 9, 671-675, 2012.
[Non-Patent Document 3] Abramoff, M. D., Magelhaes, P. J., Ram, S. J., “Image Processing with ImageJ”, Biophotonics International, volume 11, issue 7, pp. 36-42, 2004.

### SUMMARY OF THE INVENTION

### Problems to be Solved by the Invention

Patent Document 1 describes that a lithium ion battery capable of operating even in a low-temperature environment (e.g., lower than or equal to 0° C.) can be obtained with the use of the nonaqueous solvent described in Patent Document 1. However, even the lithium ion battery described in Patent Document 1 does not have high discharge capacity when discharging in a low-temperature environment, and further improvement is desired.

In order to achieve a lithium ion battery capable of operating even in a low-temperature environment, it is required to develop not only a nonaqueous solvent (electrolyte) but also a positive electrode and a negative electrode suitable for a lithium ion battery capable of operating even in a low-temperature environment. More specifically, in the case of a positive electrode, development of a positive electrode active material suitable for a lithium ion battery capable of operating even in a low-temperature environment is required.

An object of one embodiment of the present invention is to provide a positive electrode active material applicable to a lithium ion battery having excellent discharge performance even in a low-temperature environment. Specifically, an object is to provide a positive electrode active material applicable to a lithium ion battery with high discharge capacity and/or high discharge energy density even when discharge is performed in a low-temperature environment.

Note that in this specification and the like, a “low-temperature environment” is lower than or equal to 0° C. In the case where a “low-temperature environment” is stated in this specification and the like, a given temperature lower than or equal to 0° C. can be selected. For example, in the case where a “low-temperature environment” is stated in this specification and the like, any one of lower than or equal to 0° C., lower than or equal to −10° C., lower than or equal to −20° C., lower than or equal to −30° C., lower than or equal to −40° C., lower than or equal to −50° C., lower than or equal to −60° C., lower than or equal to −80° C., and lower than or equal to −100° C. can be selected.

Another object of one embodiment of the present invention is to provide a lithium ion battery having excellent discharge performance even in a low-temperature environment. Another object of one embodiment of the present invention is to provide a lithium ion battery having excellent charge performance even in a low-temperature environment.

Specifically, an object is to provide a lithium ion battery that has high discharge capacity and/or high discharge energy density even when discharge is performed in a low-temperature environment (e.g., lower than or equal to 0° C., −10° C., lower than or equal to −20° C., preferably lower than or equal to −30° C., further preferably lower than or equal to −40° C., still further preferably lower than or equal to −50° C., most preferably lower than or equal to −60° C.). Another object is to provide a lithium ion battery that has a low decrease rate of the discharge capacity when discharge is performed in a low-temperature environment (e.g., lower than or equal to 0° C., −10° C., lower than or equal to −20° C., preferably lower than or equal to −30° C., further preferably lower than or equal to −40° C., still further preferably lower than or equal to −50° C., most preferably lower than or equal to −60° C.) with respect to the discharge capacity when discharge is performed at 25° C. Another object is to provide a lithium ion battery that has a low decrease rate of the discharge energy density when discharge is performed in a low-temperature environment (e.g., lower than or equal to 0° C., −10° C., lower than or equal to −20° C., preferably lower than or equal to −30° C., further preferably lower than or equal to −40° C., still further preferably lower than or equal to −50° C., most preferably lower than or equal to −60° C.) with respect to the discharge energy density when discharge is performed at 25° C.

Another object is to provide a secondary battery with high charge voltage. Another object is to provide a highly safe or highly reliable secondary battery. Another object is to provide a secondary battery that is less likely to deteriorate. Another object is to provide a long-life secondary battery. Another object is to provide a novel secondary battery.

Another object is to provide a novel material, a novel active material, a novel power storage device, or a manufacturing method thereof.

Note that the description of these objects does not preclude the presence of other objects. One embodiment of the present invention does not need to achieve all these objects. Other objects can be derived from the descriptions of the specification, the drawings, the claims, and the like.

### Means for Solving the Problems

One embodiment of the present invention is a positive electrode active material containing cobalt, oxygen, magnesium, aluminum, and nickel. A median diameter that is a particle diameter of the positive electrode active material is greater than or equal to 1 μm and less than or equal to 12 μm. The positive electrode active material includes the magnesium and the aluminum in a surface portion. The surface portion is a region within 50 nm in depth from a surface of the positive electrode active material. When the positive electrode active material is subjected to EDX line analysis in a depth direction, the positive electrode active material includes a region where the magnesium is distributed closer to a surface side of the positive electrode active material than the aluminum is.

In the above embodiment, it is preferable that the positive electrode active material have a layered rock-salt crystal structure belonging to a space group R-3m, the surface portion include a basal region including a surface parallel to a (001) plane of the crystal structure and an edge region including a surface in a direction intersecting with the (001) plane, and when the positive electrode active material is subjected to EDX line analysis in the depth direction, the edge region include a region where distribution of the magnesium and distribution of the nickel overlap with each other.

In the above embodiment, the nickel is substantially absent in the basal region in some cases.

In any of the above embodiments, it is preferable that when the positive electrode active material is analyzed by XPS, the number of atoms of the magnesium with respect to the number of atoms of the cobalt (Mg/Co) be greater than or equal to 0.400 and less than or equal to 1.500, and the number of atoms of the nickel with respect to the number of the atoms of the cobalt (Ni/Co) be greater than or equal to 0.050 and less than or equal to 0.150.

In the above embodiment, it is preferable that the positive electrode active material contain fluorine, and when the positive electrode active material is analyzed by XPS, the number of atoms of the fluorine with respect to the number of the atoms of the cobalt (F/Co) be greater than or equal to 0.100 and less than or equal to 1.000.

Another embodiment of the present invention is a lithium ion battery that includes a positive electrode including the positive electrode active material according to any one of the above embodiments, and an electrolyte. The electrolyte includes lithium hexafluorophosphate, ethylene carbonate, ethyl methyl carbonate, and dimethyl carbonate.

In the above lithium ion battery, given that a volume of the total content of the ethylene carbonate, the ethyl methyl carbonate, and the dimethyl carbonate in the electrolyte is 100 vol %, a volume ratio between the ethylene carbonate, the ethyl methyl carbonate, and the dimethyl carbonate is preferably x:y:100-x-y (where 5≤x≤35 and 0<x<65).

In the above lithium ion battery, the electrolyte preferably includes the lithium hexafluorophosphate of more than or equal to 0.5 mol/L and less than or equal to 1.5 mol/L with respect to the volume of the total content of the ethylene carbonate, the ethyl methyl carbonate, and the dimethyl carbonate.

Another embodiment of the present invention is an electronic device including the above lithium ion battery.

Another embodiment of the present invention is a vehicle including the above lithium ion battery.

### Effect of the Invention

One embodiment of the present invention can provide a composite oxide (positive electrode active material) applicable to a lithium ion battery having excellent discharge performance even in a low-temperature environment. Specifically, it is possible to provide a positive electrode active material applicable to a lithium ion battery having high discharge capacity and/or high discharge energy density even when discharge is performed in a low-temperature environment.

Another embodiment of the present invention can provide a lithium ion battery having high discharge capacity and/or high discharge energy density even when discharge is performed in a low-temperature environment (e.g., lower than or equal to 0° C., −10° C., lower than or equal to −20° C., preferably lower than or equal to −30° C., further preferably lower than or equal to −40° C., still further preferably lower than or equal to −50° C., most preferably lower than or equal to −60° C.). Another embodiment of the present invention can provide a lithium ion battery that has a low decrease rate of the discharge capacity when discharge is performed in a low-temperature environment (e.g., lower than or equal to 0° C., −10° C., lower than or equal to −20° C., preferably lower than or equal to −30° C., further preferably lower than or equal to −40° C., still further preferably lower than or equal to −50° C., most preferably lower than or equal to −60° C.) with respect to the discharge capacity when discharge is performed at 25° C. Another embodiment of the present invention can provide a lithium ion battery that has a low decrease rate of the discharge energy density when discharge is performed in a low-temperature environment (e.g., lower than or equal to 0° C., −10° C., lower than or equal to −20° C., preferably lower than or equal to −30° C., further preferably lower than or equal to −40° C., still further preferably lower than or equal to −50° C., most preferably lower than or equal to −60° C.) with respect to the discharge energy density when discharge is performed at 25° C.

Another embodiment of the present invention can provide a secondary battery with high charge voltage. Another embodiment of the present invention can provide a highly safe or highly reliable secondary battery. Another embodiment of the present invention can provide a secondary battery that is less likely to deteriorate. Another embodiment of the present invention can provide a long-life secondary battery. Another embodiment of the present invention can provide a novel secondary battery.

Another embodiment of the present invention can provide a novel material, a novel active material, a novel power storage device, or a manufacturing method thereof.

### BRIEF DESCRIPTION OF THE DRAWINGS

FIG. 1A is a cross-sectional view illustrating an inner structure of a secondary battery, and FIG. 1B is a cross-sectional view illustrating a positive electrode and an electrolyte of the secondary battery.

FIG. 2A and FIG. 2B are cross-sectional views illustrating a positive electrode active material.

FIG. 3A to FIG. 3F are cross-sectional views illustrating a positive electrode active material.

FIG. 4 is a diagram illustrating crystal structures of a positive electrode active material.

FIG. 5 is a diagram illustrating crystal structures of a conventional positive electrode active material.

FIG. 6 is a diagram showing XRD patterns calculated from crystal structures.

FIG. 7 is a diagram showing XRD patterns calculated from crystal structures.

FIG. 8A to FIG. 8D are diagrams showing methods for forming a positive electrode active material.

FIG. 9 is a diagram showing a method for forming a positive electrode active material.

FIG. 10A to FIG. 10C are diagrams showing methods for forming a positive electrode active material.

FIG. 11A to FIG. 11D are cross-sectional views illustrating examples of a positive electrode of a secondary battery.

FIG. 12A is an exploded perspective view of a coin-type secondary battery, FIG. 12B is a perspective view of the coin-type secondary battery, and FIG. 12C is a cross-sectional perspective view thereof.

FIG. 13A illustrates an example of a cylindrical secondary battery. FIG. 13B illustrates an example of the cylindrical secondary battery. FIG. 13C illustrates an example of a plurality of cylindrical secondary batteries. FIG. 13D illustrates an example of a power storage system including a plurality of cylindrical secondary batteries.

FIG. 14A and FIG. 14B are diagrams illustrating examples of a secondary battery, and FIG. 14C is a diagram illustrating the internal state of a secondary battery.

FIG. 15A to FIG. 15C are diagrams illustrating an example of a secondary battery.

FIG. 16A and FIG. 16B are diagrams each illustrating the appearance of a secondary battery.

FIG. 17A to FIG. 17C are diagrams illustrating a method for fabricating a secondary battery.

FIG. 18A to FIG. 18C are diagrams illustrating structure examples of a battery pack.

FIG. 19A is a perspective view of a battery pack of one embodiment of the present invention, FIG. 19B is a block diagram of the battery pack, and FIG. 19C is a block diagram of a vehicle including the battery pack.

FIG. 20A to FIG. 20D are diagrams illustrating examples of transport vehicles. FIG. 20E is a diagram illustrating an example of an artificial satellite.

FIG. 21A and FIG. 21B are diagrams illustrating power storage devices of one embodiment of the present invention.

FIG. 22A is a diagram illustrating an electric bicycle, FIG. 22B is a diagram illustrating a secondary battery of an electric bicycle, and FIG. 22C is a diagram illustrating a motor scooter.

FIG. 23A to FIG. 23D are diagrams illustrating examples of electronic devices.

FIG. 24A illustrates examples of wearable devices, FIG. 24B is a perspective view of a watch-type device, and FIG. 24C is a diagram illustrating a side surface of the watch-type device.

FIG. 25A and FIG. 25B are graphs showing particle size distribution of lithium cobalt oxide described in Example 1.

FIG. 26A and FIG. 26B are SEM images of samples.

FIG. 27A to FIG. 27C are diagrams illustrating a method for quantifying the smoothness of a positive electrode active material.

FIG. 28A to FIG. 28C are diagrams illustrating a method for quantifying the smoothness of a positive electrode active material.

FIG. 29A and FIG. 29B are graphs showing discharge curves of Charge and discharge test 1 at varying temperatures described in Example 2.

FIG. 30 is a graph showing discharge curves of Charge and discharge test 2 at varying temperatures described in Example 2.

FIG. 31 is a graph showing discharge capacity measured at varying rates at −40° C. described in Example 2.

FIG. 32A and FIG. 32B are graphs showing a charge and discharge cycle test described in Example 3.

FIG. 33A and FIG. 33B are graphs showing a charge and discharge cycle test described in Example 3.

FIG. 34A to FIG. 34C are graphs showing XRD analysis in a high-voltage charged state described in Example 3.

FIG. 35A and FIG. 35B are graphs showing STEM-EDX analysis described in Example 3.

FIG. 36A to FIG. 36C are graphs showing STEM-EDX analysis described in Example 3.

FIG. 37A to FIG. 37C are graphs showing STEM-EDX analysis described in Example 3.

### MODE FOR CARRYING OUT THE INVENTION

Embodiments of the present invention will be described in detail with reference to the drawings as appropriate. Note that the present invention is not limited to the following description, and it will be readily understood by those skilled in the art that modes and details of the present invention can be modified in various ways without departing from the spirit and scope of the present invention. Therefore, in the embodiments of the present invention described below, reference numerals denoting the same portions are used in common in different drawings.

Furthermore, the embodiments and examples described below can be implemented by being combined with any of the embodiments, examples, and the like described in this specification and the like unless otherwise mentioned.

“Electronic devices” in this specification and the like mean all devices including power storage devices, and electro-optical devices including power storage devices, information terminal devices including power storage devices, and the like are all electronic devices.

In this specification and the like, a “power storage device” refers to every element and device having a function of storing power. For example, a power storage device (also referred to as a “secondary battery”) such as a lithium ion battery, a lithium ion capacitor, and an electric double layer capacitor are included.

In this specification and the like, a space group is represented using the short notation of the international notation (or the Hermann-Mauguin notation). In addition, the Miller index is used for the expression of crystal planes and crystal orientations. An individual plane that shows a crystal plane is denoted by “( )”. In the crystallography, a bar is placed over a number in the expression of space groups, crystal planes, and crystal orientations: in this specification and the like, because of format limitations, space groups, crystal planes, and crystal orientations are sometimes expressed by placing “-” (a minus sign) in front of the number instead of placing a bar over the number. Furthermore, an individual direction that shows an orientation in a crystal is denoted by “[ ]”, a set direction that shows all of the equivalent orientations is denoted by “< >”, an individual plane that shows a crystal plane is denoted by “( )”, and a set plane having equivalent symmetry is denoted by “{ }”. A trigonal system represented by the space group R-3m is generally represented by a composite hexagonal lattice for easy understanding of the structure and is also represented by a composite hexagonal lattice in this specification and the like unless otherwise specified. In some cases, not only (hkl) but also (hkil) is used as the Miller index. Here, i is −(h+k).

In addition, a given integer of 1 or more is represented by h, k, i, or/in some cases. Examples of (001) include (001), (003), and (006).

The space group of a crystal structure is identified by XRD, electron diffraction, neutron diffraction, or the like. Thus, in this specification and the like, belonging to a space group, being attributed to a space group, or being a space group can be rephrased as being identified as a space group.

In this specification and the like, the theoretical capacity of a positive electrode active material refers to the amount of electricity for the case where lithium that can be inserted and extracted in the positive electrode active material is all extracted. For example, the theoretical capacity of LiCoO₂ is 274 mAh/g, the theoretical capacity of LiNiO₂ is 275 mAh/g, and the theoretical capacity of LiMn₂O₄ is 148 mAh/g.

The remaining amount of lithium that can be inserted into and extracted from a positive electrode active material can be represented by x (the occupancy rate of Li in lithium sites) in a compositional formula, e.g., LiₓCoO₂. In the case of a positive electrode active material included in a secondary battery, x=(theoretical capacity-charge capacity)/theoretical capacity can be satisfied. For example, in the case where a secondary battery using LiCoO₂ as a positive electrode active material is charged to 219.2 mAh/g, it can be said that the positive electrode active material is represented by Li_{0.2}CoO₂ or x=0.2. Note that “x in LiₓCoO₂ is small” means, for example, x≤0.24, and means, for example, 0.1<x≤0.24 in consideration of the practical range of using LiₓCoO₂ as the positive electrode active material of a secondary battery.

In the case where lithium cobalt oxide almost satisfies the stoichiometric proportion, lithium cobalt oxide is LiCoO₂ and x=1. In a secondary battery after its discharge ends, it can be said that contained lithium cobalt oxide is LiCoO₂ and x=1. In general, in a lithium ion battery using LiCoO₂, the discharge voltage rapidly decreases before the discharge voltage reaches 2.5 V. For this reason, in this specification and the like, for example, a state in which voltage becomes 2.5 V (counter electrode is lithium) at a current of 100 mA/g or lower is regarded as a state in which discharge ends with x of 1. Accordingly, for example, in order to obtain lithium cobalt oxide with x of 0.2, charge to 219.2 mAh/g is performed from a state in which discharge ends.

Charge capacity and/or discharge capacity used for calculation of x in LiₓCoO₂ is preferably measured under the condition where there is no influence or small influence of a short circuit and/or decomposition of an electrolyte. For example, it is not preferable to use data on a secondary battery in which a sudden voltage change that seems to result from a short circuit occurs, for calculation of x.

Furthermore, when the arrangement of anions is close to a cubic close-packed structure, the arrangement can be regarded as the cubic close-packed structure. The arrangement of anions forming the cubic close-packed structure refers to a state where anions in a second layer are positioned right above voids between anions packed in a first layer, and anions in a third layer are placed at the positions that are positioned right above voids between the anions in the second layer and are not positioned right above the anions in the first layer. Accordingly, anions do not necessarily form a cubic lattice structure. In addition, actual crystals always have a defect and thus, analysis results are not necessarily consistent with the theory. For example, in an electron diffraction pattern or an FFT (fast Fourier transform) pattern of a TEM image or the like, a spot may appear at a position slightly different from a theoretical position. For example, anions may be regarded as forming a cubic close-packed structure when a difference in orientation from a theoretical position is 5° or less or 2.5° or less.

In this specification and the like, a “layered rock-salt crystal structure of a composite oxide containing lithium and a transition metal” refers to a crystal structure in which a rock-salt ion arrangement where cations and anions are alternately arranged is included and the transition metal and lithium are regularly arranged to form a two-dimensional plane, so that lithium can be two-dimensionally diffused. Note that a defect such as a cation or anion vacancy may exist. Moreover, in the layered rock-salt crystal structure, strictly, a lattice of a rock-salt crystal is distorted in some cases.

In this specification and the like, a “rock-salt crystal structure” refers to a structure in which cations and anions are alternately arranged. Note that a cation or anion vacancy may be included.

In this specification and the like, “uniformity” refers to a phenomenon in which, in a solid made of a plurality of elements (e.g., A, B, and C), a certain element (e.g., A) is distributed with similar features in specific regions. Specifically, it is acceptable for the specific regions to have substantially the same concentration of the element. For example, a difference in the concentration of the element between the specific regions can be 10% or less. Examples of the specific regions include a surface portion, a surface, a projected portion, a depressed portion, and an inner portion.

In this specification and the like, “segregation” refers to a phenomenon in which, in a solid made of a plurality of elements (e.g., A, B, and C), a certain element (e.g., B) is spatially non-uniformly distributed. Alternatively, “segregation” means that the concentration of a certain element is different from those of the other elements. This may be rephrased as uneven distribution, precipitation, non-uniformity, deviation, or a mixture of a high-concentration portion and a low-concentration portion.

In this specification and the like, a “surface portion” of a particle of an active material or the like is a region that is less than or equal to 50 nm, preferably less than or equal to 35 nm, further preferably less than or equal to 20 nm, most preferably less than or equal to 10 nm inward from the surface, for example. A plane generated by a slipping or a crack can be considered as a surface. In this specification and the like, a region at a position deeper than the surface portion is referred to as an “inner portion” in some cases. In this specification and the like, a “grain boundary” refers to a portion where particles adhere to each other, a portion where crystal orientation changes inside a particle (including a central portion), a portion including many defects, a portion with a disordered crystal structure, or the like. The grain boundary is one of plane defects. The “vicinity of a grain boundary” refers to a region positioned within 20 nm, preferably within 10 nm from the grain boundary. In this specification and the like, a “particle” is not necessarily spherical (with a circular cross section). Other examples of the cross-sectional shapes of particles include an ellipse, a rectangle, a trapezoid, a triangle, a quadrilateral with rounded corners, and an asymmetrical shape, and a particle may have an indefinite shape.

In the case where the features of individual particles of a positive electrode active material are described in the following embodiment and the like, not all the particles necessarily have the features. When 50% or more, preferably 70% or more, further preferably 90% or more of three or more randomly selected particles of a positive electrode active material have the features, for example, it can be said that an effect of improving the characteristics of the positive electrode active material and a secondary battery including the positive electrode active material is sufficiently obtained.

### Embodiment 1

In this embodiment, a lithium ion battery having excellent charge performance and discharge performance even in a low-temperature environment will be described.

### [Lithium Ion Battery]

A lithium ion battery of one embodiment of the present invention includes a positive electrode, a negative electrode, and an electrolyte. When the electrolyte includes an electrolyte solution, a separator is provided between the positive electrode and the negative electrode. An exterior body covering at least part of peripheries of the positive electrode, the negative electrode, and the electrolyte may be further provided.

In this embodiment, the description is made focusing on a lithium ion battery structure that is needed to provide a lithium ion battery having excellent discharge performance even in a low-temperature environment (e.g., lower than or equal to 0° C., −10° C., lower than or equal to −20° C., preferably lower than or equal to −30° C., further preferably lower than or equal to −40° C., still further preferably lower than or equal to −50° C., most preferably lower than or equal to −60° C.) and/or a lithium ion battery having excellent charge performance even in a low-temperature environment. Specifically, a positive electrode active material included in a positive electrode and an electrolyte are mainly described. A method for forming the positive electrode active material included in a lithium ion battery will be described in Embodiment 2, and the other components of the lithium ion battery of one embodiment of the present invention will be described in detail in Embodiment 3.

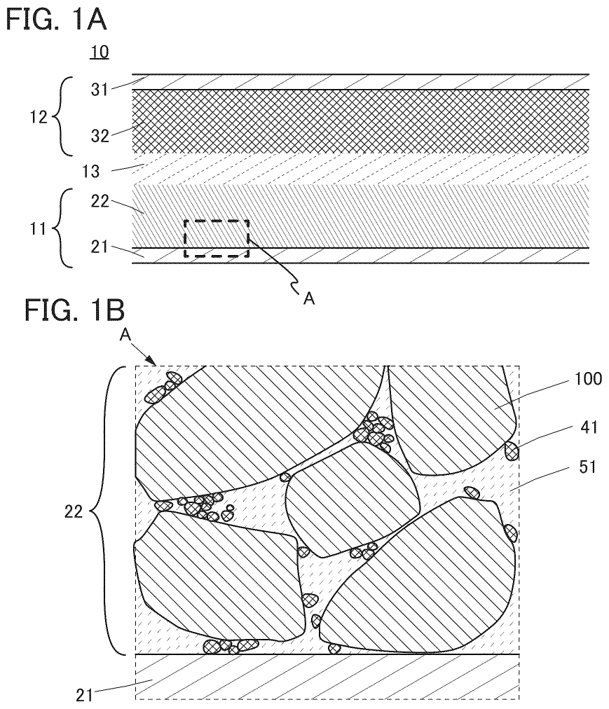

FIG. 1A is a schematic cross-sectional view illustrating an inner structure of a lithium ion battery 10. The lithium ion battery 10 includes a positive electrode 11, a negative electrode 12, and a separator 13. The positive electrode 11 includes a positive electrode current collector 21 and a positive electrode active material layer 22 over the positive electrode current collector 21, and the negative electrode 12 includes a negative electrode current collector 31 and a negative electrode active material layer 32. As illustrated, the positive electrode active material layer 22 and the negative electrode active material layer 32 face each other with the separator 13 therebetween. Although not illustrated in FIG. 1A, the lithium ion battery 10 includes electrolytes in a space included in the positive electrode active material layer 22, a space included in the separator 13, and a space included in the negative electrode active material layer 32.

Note that one positive electrode 11, one negative electrode 12, and one separator 13 are illustrated in FIG. 1A: however, the structure of the lithium ion battery of one embodiment of the present invention is not limited thereto. Two positive electrodes 11, two negative electrodes 12, and two separators 13 may be provided, or three or more positive electrodes 11, three or more negative electrodes 12, and three or more separators 13 may be stacked. Moreover, not a stacked-layer structure illustrated in FIG. 1A but a wound structure may be employed.

FIG. 1B is an enlarged view of a portion A surrounded by a dashed line in FIG. 1A.

The positive electrode active material layer 22 includes a positive electrode active material 100 and a conductive material 41. Although not illustrated, the positive electrode active material layer 22 may also include a binder in addition to the positive electrode active material 100 and the conductive material 41.

The space included in the positive electrode active material layer 22 is preferably filled with an electrolyte 51 as illustrated. For example, the proportion of the space included in the positive electrode active material layer 22 filled with the electrolyte 51 is preferably higher than or equal to 60%, further preferably higher than or equal to 70%, still further preferably higher than or equal to 80%, yet further preferably higher than or equal to 90%, yet still further preferably higher than or equal to 95%, most preferably higher than or equal to 99%. Note that the space included in the positive electrode active material layer 22 refers to a region other than a solid component (e.g., the positive electrode active material and the conductive material) in the positive electrode active material layer 22.

Although detailed descriptions are omitted, the space included in the negative electrode active material layer 32 is preferably filled with the electrolyte 51 as in the case of the positive electrode active material layer 22. For example, the proportion of the space included in the negative electrode active material layer 32 filled with the electrolyte 51 is preferably higher than or equal to 60%, further preferably higher than or equal to 70%, still further preferably higher than or equal to 80%, yet further preferably higher than or equal to 90%, yet still further preferably higher than or equal to 95%, most preferably higher than or equal to 99%. Note that the space included in the negative electrode active material layer 32 refers to a region other than a solid component (e.g., a negative electrode active material and a conductive material) in the negative electrode active material layer 32.

By filling with the electrolyte 51 throughout the positive electrode active material layer 22 and the negative electrode active material layer 32 in this manner, a region where the positive electrode active material and a negative electrode active material are in contact with the electrolyte can be increased. That is, a lithium ion battery can have excellent charge performance and discharge performance in a low-temperature environment.

In charging in a low-temperature environment, an energy barrier at the time of extracting lithium ions from a positive electrode active material tends to be high. That is, it can be said that overvoltage required for extracting lithium ions from the positive electrode active material becomes higher as the temperature of charging environment becomes lower. That is, the positive electrode active material might be exposed to high voltage (a higher potential than a lithium potential) in charging in a low-temperature environment. In other words, in charging in a low-temperature environment, charge capacity might be decreased when the positive electrode active material is not exposed to high voltage.

Thus, as a positive electrode active material included in a lithium ion battery having excellent charge performance and discharge performance even in a low-temperature environment, it is preferable to use a positive electrode active material that withstands high voltage and can have high charge capacity in charging in a low-temperature environment.

For an electrolyte included in a lithium ion battery having excellent charge performance and discharge performance even in a low-temperature environment, it is preferable to use a material that has high lithium ion conductivity even in charging and/or discharging (charge and discharge) in a low-temperature environment (e.g., 0° C., −10° C., −20° C., preferably −30° C., further preferably −40° C., still further preferably −50° C., most preferably −60° C.).

A positive electrode active material and an electrolyte that are preferable for a lithium ion battery having excellent charge performance and discharge performance even in a low-temperature environment will be described below in detail.

### [Positive Electrode]

A positive electrode includes a positive electrode active material layer and a positive electrode current collector. The positive electrode active material layer includes a positive electrode active material and may further include at least one of a conductive material and a binder.

### <Positive Electrode Active Material>

The positive electrode active material has functions of taking and releasing lithium ions in accordance with charge and discharge. For a positive electrode active material used as one embodiment of the present invention, it is possible to use a material with less deterioration (or a material with slight increase in resistance) due to charge and/or discharge in a low-temperature environment even at high charge voltage. Specifically, it is possible to use a positive electrode active material (composite oxide) with a later-described particle diameter (strictly, median diameter (D50)) of less than or equal to 12 μm (preferably less than or equal to 10.5 μm, further preferably less than or equal to 8 μm). This positive electrode active material includes any one or more of an additive element X, an additive element Y, and an additive element Z. The details of the additive element X, the additive element Y, and the additive element Z will be described in <Contained Elements>.

Note that when the particle diameter of the positive electrode active material is too small, application might be difficult to perform in the formation of the positive electrode. Alternatively, when the particle diameter of the positive electrode active material is too small, the surface area becomes too large, which might cause an excessive reaction between a positive electrode active material surface and an electrolyte. Alternatively, when the particle diameter of the positive electrode active material is too small, a large amount of conductive material functioning as a conduction path between particles needs to be mixed, which might lead to a decrease in capacity. Accordingly, the particle diameter (median diameter (D50)) of the positive electrode active material is preferably larger than or equal to 1 μm. The particle diameter of the positive electrode active material with the minimum size is preferably greater than or equal to 100 nm. In the case where the particle diameter of the positive electrode active material is larger than the thickness of an active material layer described later, the particle density of the active material layer cannot be increased: thus, the particle diameter of the largest particle is preferably less than or equal to 50 μm.

The particle diameter can be measured with a particle size distribution analyzer using a laser diffraction and scattering method, for example. D50 is a particle diameter when the accumulated amount of particles accounts for 50% of an accumulated particle amount curve that is the result of the particle size distribution measurement. The measurement of the size of a particle is not limited to laser diffraction particle size distribution measurement: the major axis of a particle cross section may be measured by analysis with a SEM, a TEM, or the like. Note that an example of a method for measuring D50 by analysis with a SEM, a TEM, or the like includes a method for measuring 20 or more particles to make an accumulated particle amount curve, and setting a particle diameter when the accumulation of particles accounts for 50% as D50.

In this specification and the like, “charge voltage” is represented with reference to the potential of lithium metal, unless otherwise specified. In this specification and the like, “high charge voltage” refers to, for example, a charge voltage higher than or equal to 4.5 V: a state where x in LiₓCoO₂ is small, e.g., 0.1<x≤0.24 can be obtained by high-voltage charging at preferably 4.55 V or higher, further preferably 4.6 V or higher, 4.65 V or higher, or 4.7 V or higher. Note that for the positive electrode active material, two or more kinds of materials having different particle diameters and/or compositions can be used as long as the materials have less deterioration due to charging and discharging even at high charge voltage. In this specification and the like, the term “having different compositions” includes not only the case where constituent elements contained in the materials are different but also the case where the constituent elements contained in the materials are the same but the proportions of the constituent elements contained in the materials are different.

As described above, “high charge voltage” in this specification and the like is higher than 5 or equal to 4.5 V with reference to the potential of lithium metal used for the negative electrode; however, “high charge voltage” refers to a voltage higher than or equal to 4.4 V with reference to the potential of a carbon material (e.g., graphite) used for the negative electrode. In short, a charge voltage higher than or equal to 4.5 V is referred to as high charge voltage in the case of using lithium metal as the negative electrode in a half cell, and a charge voltage higher than or equal to 4.4 V is referred to as high charge voltage in the case of using a carbon material (e.g., graphite) for the negative electrode in a full cell.

When a material with less deterioration (or a material with slight increase in resistance) due to charge and discharge in a low-temperature environment (e.g., 0° C.), −10° C., −20° C., preferably −30° C., further preferably −40° C., still further preferably −50° C., most preferably −60° C.) even at high charge voltage is used as the positive electrode active material, a lithium ion battery with high discharge capacity even in a low-temperature environment can be obtained. Alternatively, it is possible to obtain a lithium ion battery in which the discharge capacity in a low-temperature environment (e.g., 0° C., −10° C., −20° C., preferably −30° C., further preferably −40° C., still further preferably −50° C., most preferably −60° C.) is higher than or equal to 50% (preferably higher than or equal to 60%, further preferably higher than or equal to 70%, still further preferably higher than or equal to 80%, most preferably higher than or equal to 90%) of the discharge capacity at 20° C. Note that the above-described value is a value in the case where both of charge and discharge are performed in a low-temperature environment, and the measurement conditions other than the temperature (hereinafter sometimes referred to as “charge and discharge temperature” in this specification and the like) are the same between charge and discharge in a low-temperature environment and charge and discharge at 20° C.

More specifically, the discharge capacity when charge and discharge are performed at (° C.) is preferably higher than or equal to 85%, further preferably higher than or equal to 90%, still further preferably higher than or equal to 95%, yet further preferably higher than or equal to 98% of the discharge capacity when charge and discharge are performed at 20° C. The discharge capacity when charge and discharge are performed at −10° C. is preferably higher than or equal to 80%, further preferably higher than or equal to 85%, still further preferably higher than or equal to 90%, yet further preferably higher than or equal to 95% of the discharge capacity when charge and discharge are performed at 20° C. The discharge capacity when charge and discharge are performed at −20° C. is preferably higher than or equal to 75%, further preferably higher than or equal to 80%, still further preferably higher than or equal to 85%, yet further preferably higher than or equal to 90% of the discharge capacity when charge and discharge are performed at 20° C. The discharge capacity when charge and discharge are performed at −30° C. is preferably higher than or equal to 70%, further preferably higher than or equal to 75%, still further preferably higher than or equal to 80%, yet further preferably higher than or equal to 85% of the discharge capacity when charge and discharge are performed at 20° C. The discharge capacity when charge and discharge are performed at −40° C. is preferably higher than or equal to 60%, further preferably higher than or equal to 65%, still further preferably higher than or equal to 70%, yet further preferably higher than or equal to 75% of the discharge capacity when charge and discharge are performed at 20° C. The above discharge can be performed under the condition of, for example, a current rate being 0.1 C (note that 1 C=200 mA/g).

Alternatively, it is possible to obtain a lithium ion battery with high discharge energy density even in a low-temperature environment (e.g., 0° C., −10° C., −20° C., preferably −30° C., further preferably −40° C., still further preferably −50° C., most preferably −60° C.). Alternatively, it is possible to obtain a lithium ion battery in which the discharge energy density in a low-temperature environment (e.g., 0° C.), −10° C., −20° C., preferably −30° C., further preferably −40° C., still further preferably −50° C., most preferably −60° C.) is higher than or equal to 50% (preferably higher than or equal to 60%, further preferably higher than or equal to 70%, still further preferably higher than or equal to 80%, most preferably higher than or equal to 90%) of the discharge energy density at 20° C. Note that the measurement conditions other than the temperature are the same between charge and discharge in a low-temperature environment and charge and discharge at 20° C.

The temperature at the time of charge or discharge described in this specification and the like refer to the temperature of a lithium ion battery. In the measurement of the battery performance at varying temperatures, for example, a thermostatic chamber that is stable at desired temperature is used, a battery (e.g., a test battery or a half cell) that is a target of the measurement is installed in the thermostatic chamber, and then the measurement can start after sufficient time (e.g., 1 hour or longer) break until the temperature of the test cell is substantially equal to that of the thermostatic chamber. The method is not necessarily limited thereto.

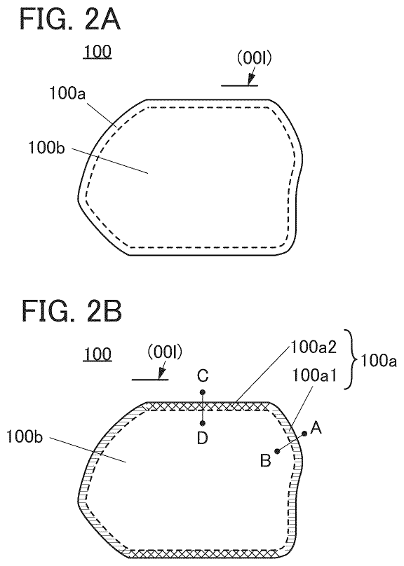

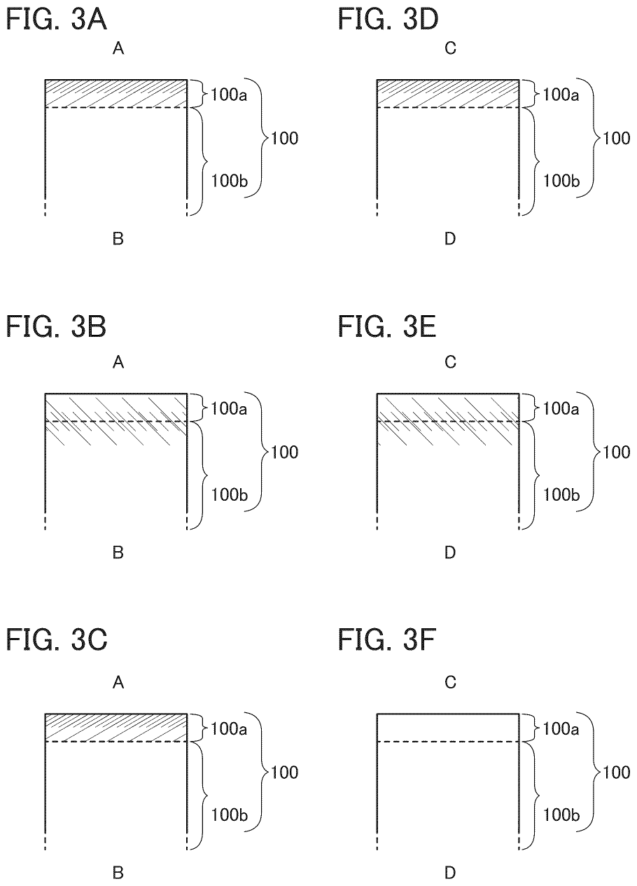

The positive electrode active material 100 with less deterioration due to repetition of charge at high charge voltage and discharge will be described with reference to FIG. 2 and FIG. 3.

FIG. 2A and FIG. 2B are cross-sectional views of the positive electrode active material 100 of one embodiment of the present invention. FIG. 3A to FIG. 3C show enlarged views of a portion near A-B in FIG. 2B. FIG. 3D to FIG. 3F show enlarged views of a portion near C-D in FIG. 2B.

As illustrated in FIG. 2A, the positive electrode active material 100 includes a surface portion 100a and an inner portion 100b. In each drawing, a dashed line denotes a boundary between the surface portion 100a and the inner portion 100b.

The surface portion 100a of the positive electrode active material 100 refers to, for example, a region that is within 50 nm in depth from the surface toward the inner portion, preferably within 35 nm in depth from the surface toward the inner portion, further preferably within 20 nm in depth from the surface toward the inner portion, most preferably within 10 nm in depth in a perpendicular direction or a substantially perpendicular direction from the surface toward the inner portion. Note that “substantially perpendicular” refers to a state where an angle is greater than or equal to 80° and less than or equal to 100°. A plane generated by a split and/or a crack can be regarded as a surface. The surface portion 100a can be rephrased as the vicinity of a surface, a region in the vicinity of a surface, or a shell.

The inner portion 100b refers to a region deeper than the surface portion 100a of the positive electrode active material. The inner portion 100b can be rephrased as an inner region or a core.

In the case where the positive electrode active material 100 has a layered rock-salt crystal structure of a space group R-3m, the surface portion 100a includes an edge region 100a1 and a basal region 100a2 as illustrated in FIG. 2B. Note that in FIG. 2A and FIG. 2B, the straight line denoted by (001) represents a (001) plane. Here, the edge region 100a1 has a surface exposed in a direction intersecting with the (001) plane, and a region within 50 nm in depth from the surface toward the inner portion, preferably within 35 nm in depth from the surface toward the inner portion, further preferably within 20 nm in depth from the surface toward the inner portion, most preferably within 10 nm in depth in a perpendicular direction or a substantially perpendicular direction from the surface toward the inner portion is referred to as the edge region 100a1. Note that “intersect” here means that an angle between a perpendicular line of a first plane (the (001) plane) and a normal of a second plane (a surface of the positive electrode active material 100) is greater than or equal to 10° and less than or equal to 90°, preferably greater than or equal to 30° and less than or equal to 90°.

Moreover, the basal region 100a2 has a surface parallel to the (001) plane, and a region within 50 nm in depth from the surface toward the inner portion, preferably within 35 nm in depth from the surface toward the inner portion, further preferably within 20 nm in depth from the surface toward the inner portion, most preferably within 10 nm in depth in a perpendicular direction or a substantially perpendicular direction from the surface toward the inner portion is referred to as the basal region 100a2. Note that “parallel” here means that an angle between the perpendicular line of the first plane (the (001) plane) and the normal of the second plane (the surface of the positive electrode active material 100) is greater than or equal to 0° and less than 10°, preferably greater than or equal to 0° and less than or equal to 5°, further preferably greater than or equal to 0° and less than or equal to 2.5°.

A surface of the positive electrode active material 100 refers to a surface of a composite oxide including the surface portion 100a and the inner portion 100b. Accordingly, the positive electrode active material 100 does not contain a material to which a metal oxide that does not contain a lithium site contributable to charge and discharge, such as aluminum oxide (Al₂O₃), is attached: or a carbonate, a hydroxy group, or the like that is chemically adsorbed after formation of the positive electrode active material. Note that the attached metal oxide refers to, for example, a metal oxide having a crystal orientation different from that of the inner portion 100b.

The orientations of crystals in two regions being substantially aligned with each other can be judged from a TEM (Transmission Electron Microscope) image, a STEM (Scanning Transmission Electron Microscope) image, a HAADF-STEM (High-angle Annular Dark Field Scanning TEM) image, an ABF-STEM (Annular Bright-Field Scanning Transmission Electron Microscope) image, an electron diffraction pattern, or the like. It can be judged also from an FFT pattern of a TEM image or an FFT pattern of a STEM image or the like. Furthermore, XRD (X-ray Diffraction), neutron diffraction, and the like can also be used for judging.

Furthermore, an electrolyte, a decomposition product of an electrolyte, an organic solvent, a binder, a conductive material, and a compound originating from any of these that are attached to the positive electrode active material 100 are not included either.

Since the positive electrode active material 100 is a compound containing oxygen and a transition metal into and from which lithium can be inserted and extracted, an interface between a region where oxygen and a transition metal M (e.g., Co, Ni, Mn, Fe, or the like) that is oxidized or reduced due to insertion and extraction of lithium are present and a region where oxygen and the transition metal M are absent is considered as the surface of the positive electrode active material. A plane generated by slipping and/or a crack can also be considered as the surface of the positive electrode active material. When the positive electrode active material is analyzed, a protective film is attached on its surface in some cases: however, the protective film is not included in the positive electrode active material. As the protective film, a single-layer film or a multilayer film of carbon, a metal, an oxide, a resin, or the like is sometimes used.

### <Contained Elements>

The positive electrode active material 100 contains lithium, cobalt, oxygen, and an additive element. Alternatively, the positive electrode active material 100 can contain lithium cobalt oxide (LiCoO₂) to which an additive element is added. Note that the positive electrode active material 100 of one embodiment of the present invention has a crystal structure described later. Thus, the composition of the lithium cobalt oxide is not strictly limited to Li:Co:O=1:1:2.

A positive electrode active material of a lithium ion secondary battery needs to contain a transition metal that can take part in an oxidation-reduction reaction in order to maintain a neutrally charged state even when lithium ions are inserted and extracted. It is preferable that the positive electrode active material 100 of one embodiment of the present invention mainly contain cobalt as the transition metal taking part in an oxidation-reduction reaction. In addition to cobalt, one or both of nickel and manganese may be used. Using cobalt at greater than or equal to 75 at %, preferably greater than or equal to 90 at %, further preferably greater than or equal to 95 at % as the transition metal M contained in the positive electrode active material 100 brings many advantages such as relatively easy synthesis, easy handling, and excellent cycle performance, which is preferable.

When cobalt is used as the transition metal contained in the positive electrode active material 100 at greater than or equal to 75 at %, preferably greater than or equal to 90 at %, further preferably greater than or equal to 95 at %, LiₓCoO₂ with small x is more stable than a composite oxide in which nickel accounts for the majority of the transition metal, such as lithium nickel oxide (LiNiO₂). This is probably because the influence of distortion by the Jahn-Teller effect is smaller in the case of using cobalt than in the case of using nickel. The Jahn-Teller effect in a transition metal compound varies in degree according to the number of electrons in the d orbital of the transition metal. The influence of the Jahn-Teller effect is large in a composite oxide having a layered rock-salt crystal structure, such as lithium nickel oxide, in which octahedral coordinated low-spin nickel (III) accounts for the majority of the transition metal, and a layer having an octahedral structure formed of nickel and oxygen is likely to be distorted. Thus, there is a concern that the crystal structure might break in charge and discharge cycles. The size of a nickel ion is larger than that of a cobalt ion and close to that of a lithium ion. Thus, there is a problem in that cation mixing between nickel and lithium is likely to occur in a composite oxide having a layered rock-salt crystal structure in which nickel accounts for the majority of the transition metal, such as lithium nickel oxide.

As the additive element contained in the positive electrode active material 100, one or two or more selected from magnesium, fluorine, nickel, aluminum, titanium, zirconium, vanadium, iron, manganese, chromium, niobium, arsenic, zinc, silicon, sulfur, phosphorus, boron, barium, bromine, and beryllium are preferably used. The total percentage of the transition metal among the additive elements is preferably less than 25 at %, further preferably less than 10 at %, still further preferably less than 5 at %.

That is, the positive electrode active material 100 can contain any one or more of lithium cobalt oxide containing magnesium; lithium cobalt oxide containing magnesium and aluminum; lithium cobalt oxide containing magnesium, aluminum, and titanium; lithium cobalt oxide containing magnesium and nickel; lithium cobalt oxide containing magnesium, aluminum, and nickel; lithium cobalt oxide containing magnesium and fluorine; lithium cobalt oxide containing magnesium, fluorine, and titanium; lithium cobalt oxide containing magnesium, fluorine, and aluminum; lithium cobalt oxide containing magnesium, fluorine, titanium, and aluminum; lithium cobalt oxide containing magnesium, fluorine, and nickel; lithium cobalt oxide containing magnesium, fluorine, nickel, and aluminum; and the like.

It can also be said that as the positive electrode active material 100 in a lithium ion battery, any one or more of a positive electrode active material containing cobalt, oxygen, and magnesium; a positive electrode active material containing cobalt, oxygen, magnesium, and aluminum; a positive electrode active material containing cobalt, oxygen, magnesium, aluminum, and titanium; a positive electrode active material containing cobalt, oxygen, magnesium, and nickel; a positive electrode active material containing cobalt, oxygen, magnesium, aluminum, and nickel; a positive electrode active material containing cobalt, oxygen, magnesium, and fluorine; a positive electrode active material containing cobalt, oxygen, magnesium, fluorine, and titanium; a positive electrode active material containing cobalt, oxygen, magnesium, fluorine, and aluminum; a positive electrode active material containing cobalt, oxygen, magnesium, fluorine, titanium, and aluminum; a positive electrode active material containing cobalt, oxygen, magnesium, fluorine, and nickel; a positive electrode active material containing cobalt, oxygen, magnesium, fluorine, nickel, and aluminum; and the like can be used.

The additive element is preferably dissolved in the positive electrode active material 100. For example, in STEM-EDX line analysis, a position where the amount of the detected additive element increases is preferably at a deeper level than a position where the amount of the detected transition metal M increases, i.e., on the inner portion side of the positive electrode active material 100.

These additive elements further stabilize the crystal structure of the positive electrode active material 100 as described later. In this specification and the like, the additive element can be rephrased as part of a raw material or a mixture.

Note that as the additive element, magnesium, fluorine, nickel, aluminum, titanium, zirconium, vanadium, iron, manganese, chromium, niobium, arsenic, zinc, silicon, sulfur, phosphorus, boron, barium, bromine, or beryllium is not necessarily contained.

When the positive electrode active material 100 is substantially free from manganese, for example, the above advantages such as relatively easy synthesis, easy handling, and excellent cycle performance are enhanced. The weight of manganese contained in the positive electrode active material 100 is preferably less than or equal to 600 ppm, further preferably less than or equal to 100 ppm, for example.

The surface portion 100a is a region from which lithium ions are extracted initially in charging, and is a region that tends to have a lower concentration of lithium than the inner portion 100b. It can be said that bonds between atoms are partly cut on the surface of the particle of the positive electrode active material 100 included in the surface portion 100a. Thus, the surface portion 100a is regarded as a region that tends to be unstable and easily starts deterioration of the crystal structure. Meanwhile, when the surface portion 100a can be made sufficiently stable, the layered structure, which is formed of octahedrons of cobalt and oxygen, of the inner portion 100b can be less likely to be broken even with small x in LiₓCoO₂, e.g., with x of less than or equal to 0.24. Furthermore, a shift in layers, which are formed of octahedrons of cobalt and oxygen, of the inner portion 100b can be inhibited.

In order that the surface portion 100a can have a stable composition and a stable crystal structure, the surface portion 100a preferably contains an additive element, further preferably contains a plurality of additive elements. The surface portion 100a preferably has a higher concentration of one or more selected from the additive elements than the inner portion 100b. The one or more selected from the additive elements contained in the positive electrode active material 100 preferably have a concentration gradient. It is further preferable that the additive elements contained in the positive electrode active material 100 be differently distributed. For example, it is further preferable that the additive elements exhibit concentration peaks at different depths from a surface. The concentration peak here refers to the local maximum value of the concentration in the surface portion 100a or the concentration in a region within 50 nm in depth from the surface.

Distribution of the additive elements is described. FIG. 3A to FIG. 3C are enlarged views of the portion near A-B in FIG. 2B and are diagrams illustrating the edge region 100a1 of the positive electrode active material 100. FIG. 3D to FIG. 3F are enlarged views of the portion near C-D in FIG. 2B and are diagrams illustrating the basal region 100a2 of the positive electrode active material 100.

For example, as shown by gradation in FIG. 3A and FIG. 3D, some of the additive elements, such as magnesium, fluorine, titanium, silicon, phosphorus, boron, and calcium, preferably have a concentration gradient in which the concentration increases from the inner portion 100b toward the surface. An additive element having such a concentration gradient is referred to as an additive element X.

It is preferable that another additive element such as aluminum or manganese have a concentration gradient as shown by shades of hatching in FIG. 3B and FIG. 3E and exhibit a concentration peak in a deeper region than the additive element X shown in FIG. 3A and FIG. 3D. The concentration peak may be located in the surface portion 100a or located deeper than the surface portion 100a. For example, the concentration peak is preferably located in a region at a depth of 5 nm to 30 nm inclusive from the surface toward the inner portion. An additive element having such a concentration gradient is referred to as an additive element Y.

As shown by presence or absence of hatching and shades of hatching in FIG. 3C and FIG. 3F, another additive element such as nickel or barium clearly exists in the edge region 100a1 but is substantially absent in the basal region 100a2 in some cases. Note that here, “clearly exist” refers to the case where the energy spectrum of characteristic X-ray of the element is detected in cross-sectional STEM-EDX analysis of the positive electrode active material 100.

Note that here, “substantially absent” refers to the case where the energy spectrum of characteristic X-ray of the element is not detected in cross-sectional STEM-EDX analysis of the positive electrode active material 100. This case can also be said that the amount of the element is below the lower detection limit in STEM-EDX analysis. An additive element having such distribution is referred to as an additive element Z.

For example, magnesium, which is an example of the additive element X, is divalent, and an magnesium ion is more stable in lithium sites than in cobalt sites in the layered rock-salt crystal structure and thus is likely to enter the lithium sites. An appropriate concentration of magnesium in the lithium sites of the surface portion 100a can facilitate maintenance of the layered rock-salt crystal structure. This is probably because magnesium in the lithium sites serves as a column supporting the CoO₂ layers. Moreover, magnesium can inhibit extraction of oxygen therearound in a state where x in LiₓCoO₂ is, for example, 0.24 or less. Magnesium is also expected to increase the density of the positive electrode active material 100. In addition, a high concentration of magnesium in the surface portion 100a probably increases the corrosion resistance to hydrofluoric acid generated by the decomposition of the electrolyte solution.

An appropriate concentration of magnesium can bring the above-described advantages without an adverse effect on insertion and extraction of lithium in charge and discharge. However, excess magnesium might adversely affect insertion and extraction of lithium. Furthermore, the effect of stabilizing the crystal structure might be reduced. This is probably because magnesium enters the cobalt sites in addition to the lithium sites. Moreover, a surplus magnesium compound (e.g., oxide or fluoride) which is substituted for neither the lithium site nor the cobalt site might segregate at the surface of the positive electrode active material or the like to serve as a resistance component of a secondary battery. As the concentration of magnesium in the positive electrode active material increases, the discharge capacity of the positive electrode active material decreases in some cases. This is probably because excess magnesium enters the lithium sites and the amount of lithium contributing to charging and discharging decreases.

Thus, the entire positive electrode active material 100 preferably contains an appropriate amount of magnesium. For example, the number of magnesium atoms is preferably greater than or equal to 0.001 times and less than or equal to 0.1 times, further preferably greater than 0.01 times and less than 0.04 times, still further preferably approximately 0.02 times the number of cobalt atoms. The amount of magnesium contained in the entire positive electrode active material 100 here may be a value obtained by element analysis on the entire positive electrode active material 100 with GD-MS, ICP-MS, or the like, or may be a value based on the ratio of the raw materials mixed in the formation process of the positive electrode active material 100, for example.

Aluminum, which is an example of the additive element Y, can be present in the cobalt site in the layered rock-salt crystal structure. Since aluminum is a trivalent representative element and its valence does not change, lithium around aluminum is unlikely to move even in charging and discharging. Thus, aluminum and lithium therearound serve as columns to inhibit a change in the crystal structure. Furthermore, aluminum has effects of inhibiting elution of cobalt around aluminum and improving continuous charge tolerance. Moreover, an Al—O bond is stronger than a Co—O bond: thus, extraction of oxygen around aluminum can be inhibited. These effects improve thermal stability. Thus, a secondary battery that includes the positive electrode active material 100 containing aluminum as the additive element can have higher level of safety. Furthermore, the positive electrode active material 100 can have a crystal structure that is unlikely to be broken by repeated charge and discharge.

Meanwhile, excess aluminum might adversely affect insertion and extraction of lithium.

Thus, the entire positive electrode active material 100 preferably contains an appropriate amount of aluminum. For example, in the entire positive electrode active material 100, the number of aluminum atoms is preferably greater than or equal to 0.05% and less than or equal to 4%, further preferably greater than or equal to 0.1% and less than or equal to 2%, still further preferably greater than or equal to 0.3% and less than or equal to 1.5% of the number of cobalt atoms. Alternatively, it is preferably greater than or equal to 0.05% and less than or equal to 2%. Alternatively, it is preferably greater than or equal to 0.1% and less than or equal to 4%. Here, the amount contained in the entire positive electrode active material 100 may be a value obtained by element analysis on the entire positive electrode active material 100 with GD-MS, ICP-MS, or the like or may be a value based on the ratio of the raw materials mixed in the process of forming the positive electrode active material 100, for example.

Nickel, which is an example of the additive element Z, can be present in both the cobalt site and the lithium site. Nickel preferably exists in the cobalt sites because a lower oxidation-reduction potential can be obtained as compared with the case where only cobalt is present in the cobalt sites, leading to an increase in discharge capacity.

In addition, when nickel is present in lithium sites, a shift in the layered structure formed of octahedrons of cobalt and oxygen might be inhibited. Moreover, a change in volume in charge and discharge is inhibited. Furthermore, the elastic modulus becomes large, i.e., hardness increases. This is probably because nickel in the lithium sites serves as a column supporting the CoO₂ layers. Thus, the crystal structure is expected to be more stable in a charged state particularly at high temperatures, e.g., 45° C. or higher, which is preferable.

Meanwhile, excess nickel increases the influence of distortion due to the Jahn-Teller effect, which is not preferable. Moreover, excess nickel might adversely affect insertion and extraction of lithium.

Thus, the entire positive electrode active material 100 preferably contains an appropriate amount of nickel. For example, the number of nickel atoms contained in the positive electrode active material 100 is preferably greater than 0% and less than or equal to 7.5%, further preferably greater than or equal to 0.05% and less than or equal to 4%, still further preferably greater than or equal to 0.1% and less than or equal to 2%, yet still further preferably greater than or equal to 0.2% and less than or equal to 1% of the number of cobalt atoms. Alternatively, it is preferably greater than 0% and less than or equal to 4%. Alternatively, it is preferably greater than 0% and less than or equal to 2%. Alternatively, it is preferably greater than or equal to 0.05% and less than or equal to 7.5%. Alternatively, it is preferably greater than or equal to 0.05% and less than or equal to 2%. Alternatively, it is preferably greater than or equal to 0.1% and less than or equal to 7.5%. Alternatively, it is preferably greater than or equal to 0.1% and less than or equal to 4%. The amount of nickel described here may be a value obtained by element analysis on the entire positive electrode active material with GD-MS, ICP-MS, or the like, or may be a value based on the ratio of the raw materials mixed in the process of forming the positive electrode active material, for example.

Fluorine, which is an example of the additive element X, is a monovalent anion: when fluorine is substituted for part of oxygen in the surface portion 100a, the lithium extraction energy is lowered. This is because the change in valence of cobalt ions associated with lithium extraction is from trivalent to tetravalent in the case of not containing fluorine and is from divalent to trivalent in the case of containing fluorine, and the oxidation-reduction potentials in these cases differ from each other. It can thus be said that when fluorine is substituted for part of oxygen in the surface portion 100a of the positive electrode active material 100, lithium ions near fluorine are likely to be extracted and inserted smoothly. Accordingly, a secondary battery including the positive electrode active material 100 can have improved charge and discharge performance, improved large current characteristics, or the like. When fluorine is present in the surface portion 100a, which has a surface in contact with the electrolyte solution, the corrosion resistance to hydrofluoric acid can be effectively increased. As will be described in the following embodiment, a fluoride such as lithium fluoride that has a lower melting point than another additive element source can serve as a fusing agent (also referred to as a flux agent) for lowering the melting point of the other additive element source.

An oxide of titanium, which is an example of the additive element X, is known to have superhydrophilicity. Accordingly, the positive electrode active material 100 that contains titanium oxide in the surface portion 100a presumably has good wettability with respect to a high-polarity solvent. In a secondary battery formed using this positive electrode active material 100, the positive electrode active material 100 and a high-polarity electrolyte solution can have favorable contact at the interface therebetween, which may inhibit an internal resistance increase.

When the surface portion 100a contains both magnesium and nickel as illustrated in FIG. 3A and FIG. 3C, divalent nickel can exist more stably in the vicinity of divalent magnesium. Thus, elution of magnesium might be inhibited even when x in LiₓCoO₂ is small. This can contribute to stabilization of the surface portion 100a.

Additive elements that are differently distributed, such as the additive element X, the additive element Y, and the additive element Z, are preferably contained together, in which case the crystal structure in a wider region can be stabilized. For example, in the case where the positive electrode active material 100 altogether contains magnesium, aluminum, and nickel, which are examples of the additive element X, the additive element Y, and the additive element Z, respectively, the crystal structure in a wider region can be stabilized as compared with the case where only one or two of the additive element X, the additive element Y, and the additive element Z are contained. In the case where the positive electrode active material 100 contains the additive element X, the additive element Y, and the additive element Z together as described above, the surface can be sufficiently stabilized by the additive element X such as magnesium and the additive element Z such as nickel; thus, the additive element Y such as aluminum is not necessary for the surface. It is preferable that aluminum be widely distributed in a deeper region. For example, it is preferable that aluminum be continuously detected in a region at a depth of 1 nm to 25 nm inclusive from the surface. Wide distribution of aluminum in a region at a depth of 0 nm to 50 nm inclusive from the surface, preferably a region at a depth of 1 nm to 50 nm inclusive from the surface is preferable because the crystal structure in a wider region can be stabilized.

In the case where the additive element Z is largely contained (also referred to as preferentially contained, selectively contained, or the like) in the edge region 100a1 as illustrated in FIG. 3C and FIG. 3F, the stability of the crystal structure of the edge region 100a1 for insertion and extraction of lithium ions into/from the positive electrode active material 100 in charge and discharge of a lithium ion battery is increased, which is preferable. For example, in the case where the positive electrode active material 100 is lithium cobalt oxide, the additive element Z having such distribution is preferable because an influence of adding the additive element Z, such as a decrease in discharge voltage or a decrease in discharge capacity, can be kept to the minimum.

When a plurality of the additive elements are contained as described above, the effects of the additive elements contribute synergistically to further stabilization of the surface portion 100a. In particular, magnesium, nickel, and aluminum are preferably contained, in which case a high effect of stabilizing the composition and the crystal structure can be obtained. In particular, the surface portion 100a of the positive electrode active material 100 preferably includes a region where magnesium is distributed closer to the surface than aluminum is. It is most preferable that, in addition to the region where magnesium and aluminum are distributed in the above manner, a region where the distribution of nickel and the distribution of magnesium overlap with each other be included in the edge region 100a1 in the surface portion 100a of the positive electrode active material 100.

### <Crystal Structure>

<x in LiₓCoO₂ being 1>

The positive electrode active material 100 of one embodiment of the present invention preferably has a layered rock-salt crystal structure belonging to the space group R-3m in a discharged state, i.e., a state where x in LiₓCoO₂ is 1. A composite oxide having a layered rock-salt structure excels as a positive electrode active material of a secondary battery because it has high discharge capacity and a two-dimensional diffusion path for lithium ions and is thus suitable for an insertion/extraction reaction of lithium ions. For this reason, it is particularly preferable that the inner portion 100b, which accounts for the majority of the volume of the positive electrode active material 100, have a layered rock-salt crystal structure.

Meanwhile, the surface portion 100a of the positive electrode active material 100 of one embodiment of the present invention preferably has a function of reinforcing the layered structure, which is formed of octahedrons of the transition metal M and oxygen, of the inner portion 100b so that the layered structure does not break even when lithium is extracted from the positive electrode active material 100 by charge. Alternatively, the surface portion 100a preferably functions as a barrier film for the positive electrode active material 100. Alternatively, the surface portion 100a, which is the outer portion of the positive electrode active material 100, preferably reinforces the positive electrode active material 100. Here, the term “reinforce” means inhibition of a change in the structures of the surface portion 100a and the inner portion 100b of the positive electrode active material 100, such as extraction of oxygen, and/or inhibition of oxidative decomposition of an electrolyte on the surface of the positive electrode active material 100.

Accordingly, the surface portion 100a preferably has a crystal structure different from that of the inner portion 100b. The surface portion 100a preferably has a more stable composition and a more stable crystal structure than those of the inner portion 100b at room temperature (25° C.). For example, at least part of the surface portion 100a of the positive electrode active material 100 of one embodiment of the present invention preferably has a rock-salt crystal structure. Alternatively, the surface portion 100a preferably has both a layered rock-salt crystal structure and a rock-salt crystal structure. Alternatively, the surface portion 100a preferably has features of both a layered rock-salt crystal structure and a rock-salt crystal structure.

It is preferable that some additive elements A, in particular, magnesium, nickel, and aluminum have higher concentrations in the surface portion 100a than in the inner portion 100b and exist randomly also in the inner portion 100b to have low concentrations. When magnesium and aluminum exist in the lithium sites of the inner portion 100b at appropriate concentrations, an effect of facilitating maintenance of the layered rock-salt crystal structure can be obtained in a manner similar to the above. When nickel exists in the inner portion 100b at an appropriate concentration, a shift in the layered structure formed of octahedrons of the transition metal M and oxygen might be inhibited in a manner similar to the above. Also in the case where both magnesium and nickel are contained, a synergistic effect of inhibiting elution of magnesium can be expected since divalent magnesium can be present more stably in the vicinity of divalent nickel.

It is preferable that the crystal structure continuously change from the inner portion 100b toward the surface owing to the above-described concentration gradient of the additive element A. Alternatively, the crystal orientations of the surface portion 100a and the inner portion 100b are preferably substantially aligned with each other.

For example, a crystal structure preferably changes continuously from the layered rock-salt inner portion 100b toward the surface and the surface portion 100a that have a rock-salt structure or have features of both a rock-salt structure and a layered rock-salt structure. Alternatively, the crystal orientation of the surface portion 100a having a rock-salt structure or features of both a rock-salt structure and a layered rock-salt structure is preferably substantially aligned with that of the layered rock-salt inner portion 100b.

In this specification and the like, a layered rock-salt crystal structure, which belongs to the space group R-3m, of a composite oxide containing lithium and the transition metal M such as cobalt refers to a crystal structure in which a rock-salt ion arrangement where cations and anions are alternately arranged is included and lithium and the transition metal M are regularly arranged to form a two-dimensional plane, so that lithium can be diffused two-dimensionally. Note that a defect such as a cation or anion vacancy may exist. Moreover, in the layered rock-salt crystal structure, strictly, a lattice of a rock-salt crystal is distorted in some cases.

A rock-salt crystal structure refers to a structure in which a cubic crystal structure with the space group Fm-3m or the like is included and cations and anions are alternately arranged. Note that a cation or anion vacancy may be included.

Having features of both a layered rock-salt crystal structure and a rock-salt crystal structure can be judged by electron diffraction, a TEM image, a cross-sectional STEM image, and the like.

There is no distinction among cation sites in a rock-salt structure. Meanwhile, a layered rock-salt crystal structure has two types of cation sites: one type is mostly occupied by lithium, and the other is occupied by the transition metal. A stacked-layer structure where two-dimensional planes of cations and two-dimensional planes of anions are alternately arranged is the same in a rock-salt structure and a layered rock-salt structure. Given that the center spot (transmission spot) among bright spots in an electron diffraction pattern corresponding to crystal planes that form the two-dimensional planes is at the origin point 000, the bright spot nearest to the center spot is on the (111) plane in an ideal rock-salt crystal structure, for instance, and on the (003) plane in a layered rock-salt crystal structure, for instance. For example, when electron diffraction patterns of rock-salt MgO and layered rock-salt LiCoO₂ are compared to each other, the distance between the bright spots on the (003) plane of LiCoO₂ is observed at a distance approximately half the distance between the bright spots on the (111) plane of MgO. Thus, when two phases of rock-salt MgO and layered rock-salt LiCoO₂, for example, are included in a region to be analyzed, a plane orientation in which bright spots with high luminance and bright spots with low luminance are alternately arranged exists in an electron diffraction pattern. A bright spot common between the rock-salt structure and the layered rock-salt structure has high luminance, whereas a bright spot caused only in the layered rock-salt structure has low luminance.

When a layered rock-salt crystal structure is observed from a direction perpendicular to the c-axis in a cross-sectional STEM image and the like, layers observed with high luminance and layers observed with low luminance are alternately observed. Such a feature is not observed in a rock-salt crystal structure because there is no distinction among cation sites therein. When a crystal structure having the features of both a rock-salt crystal structure and a layered rock-salt crystal structure is observed from a given crystal orientation, layers observed with high luminance and layers observed with low luminance are alternately observed in a cross-sectional STEM image and the like, and a metal that has a larger atomic number than lithium is present in part of the layers with low luminance, i.e., the lithium layers.

Anions of a layered rock-salt crystal and anions of a rock-salt crystal form a cubic close-packed structure (face-centered cubic lattice structure). Anions of an O3′ type crystal described later are presumed to form a cubic close-packed structure. Thus, when a layered rock-salt crystal and a rock-salt crystal are in contact with each other, there is a crystal plane at which orientations of cubic closest packed structures composed of anions are aligned with each other.

The description can also be made as follows. Anions on the {111} plane of a cubic crystal structure have a triangle lattice. A layered rock-salt structure, which belongs to the space group R-3m and is a rhombohedral structure, is generally represented by a composite hexagonal lattice for easy understanding of the structure, and the (0001) plane of the layered rock-salt structure has a hexagonal lattice. The triangle lattice on the {111} plane of the cubic crystal has atomic arrangement similar to that of the hexagonal lattice on the (0001) plane of the layered rock-salt structure. These lattices being consistent with each other can be expressed as “orientations of the cubic close-packed structures are aligned with each other”.

Note that a space group of the layered rock-salt crystal and the O3′ type crystal is R-3m, which is different from the space group Fm-3m of a rock-salt crystal (the space group of a general rock-salt crystal); thus, the Miller index of the crystal plane satisfying the above conditions in the layered rock-salt crystal and the O3′ type crystal is different from that in the rock-salt crystal. In this specification, a state where the orientations of the cubic close-packed structures composed of anions in the layered rock-salt crystal, the O3′ type crystal, and the rock-salt crystal are aligned with each other is sometimes referred to as a state where crystal orientations are substantially aligned with each other.

<State where x in LiₓCoO₂ is Small>

The crystal structure in a state where x in LiₓCoO₂ is small of the positive electrode active material 100 of one embodiment of the present invention is different from that of a conventional positive electrode active material because the positive electrode active material 100 has the above-described additive element A distribution and/or crystal structure in a discharged state. Here, “x is small” means 0.1<x≤0.24.

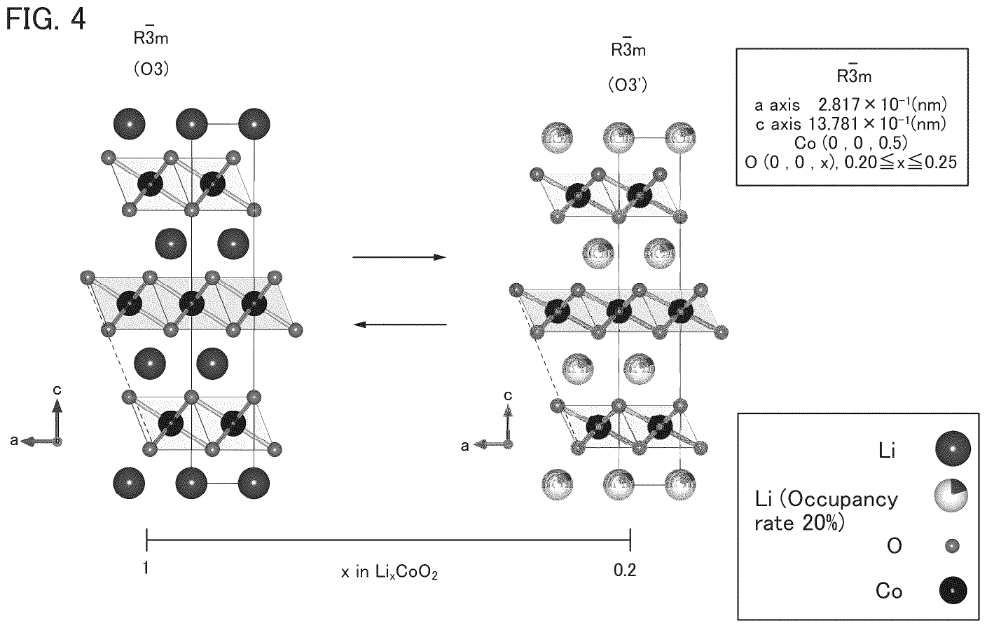

Changes in crystal structures due to a change in x in LiₓCoO₂ will be described with reference to FIG. 4 to FIG. 7 by comparison between a conventional positive electrode active material and the positive electrode active material 100 of one embodiment of the present invention.

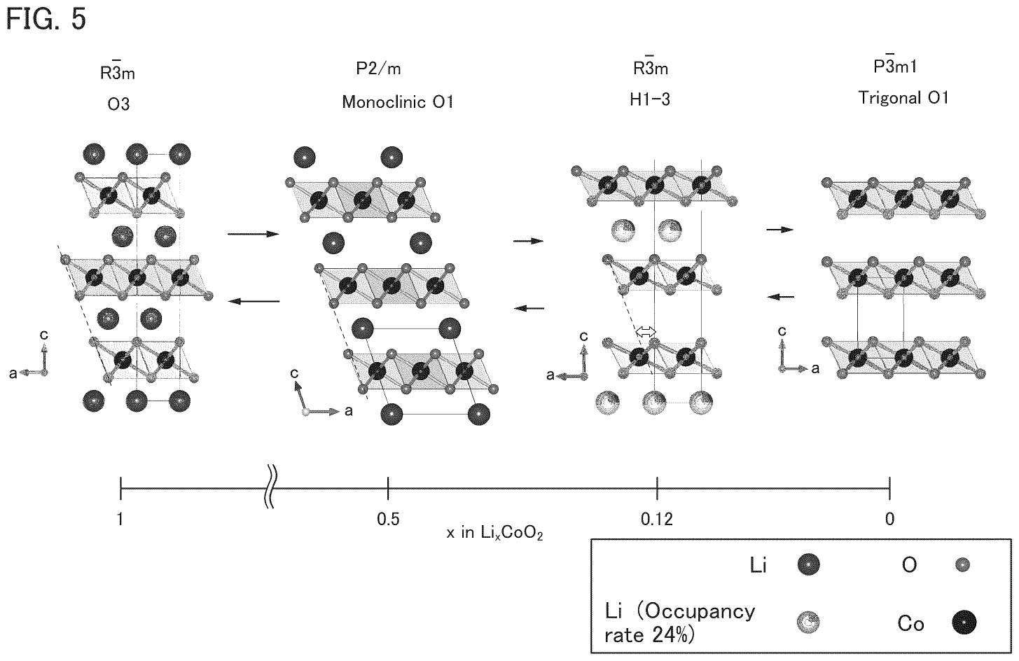

A change in the crystal structure of the conventional positive electrode active material is illustrated in FIG. 5. The conventional positive electrode active material shown in FIG. 5 is lithium cobalt oxide (LiCoO₂) without the additive element A in particular.

In FIG. 5, the crystal structure of lithium cobalt oxide with x in LiₓCoO₂ of 1 is denoted by R-3m O3. In this crystal structure, lithium occupies octahedral sites and a unit cell includes three CoO₂ layers. Thus, this crystal structure is referred to as an 03 type crystal structure in some cases. Note that here, the CoO₂ layer has a structure in which an octahedral structure with cobalt coordinated to six oxygen atoms continues on a plane in an edge-shared state. Such a layer is sometimes referred to as a layer formed of octahedrons of cobalt and oxygen.

Conventional lithium cobalt oxide with x being approximately 0.5 is known to have an improved symmetry of lithium and have a monoclinic crystal structure belonging to the space group P2/m. This structure includes one CoO₂ layer in a unit cell. Thus, this crystal structure is referred to as an O1 type structure or a monoclinic O1 type structure in some cases.

A positive electrode active material with x of 0 has a trigonal crystal structure belonging to the space group P-3 ml and includes one CoO₂ layer in a unit cell. Thus, this crystal structure is referred to as an O1 type structure or a trigonal O1 type structure in some cases. Moreover, in some cases, this crystal structure is referred to as a hexagonal 01 type structure when the trigonal crystal is converted into a composite hexagonal lattice.

Conventional lithium cobalt oxide with x being approximately 0.12 has a crystal structure belonging to the space group R-3m. This structure can also be regarded as a structure in which CoO₂ structures such as trigonal 01 type structures and LiCoO₂ structures such as R-3m O3 are alternately stacked. Thus, this crystal structure is referred to as an H1-3 type crystal structure in some cases. Note that the number of cobalt atoms per unit cell in the actual H1-3 type crystal structure is twice that in other structures. However, in this specification, FIG. 5, and other drawings, the c-axis of the H1-3 type crystal structure is half that of the unit cell for easy comparison with the other crystal structures.

For the H1-3 type crystal structure, the coordinates of cobalt and oxygen in the unit cell can be expressed as follows, for example: Co (0, 0, 0.42150±0.00016), O1 (0, 0, 0.27671±0.00045), and O2 (0, 0, 0.11535±0.00045). O1 and O2 are each an oxygen atom. A unit cell that should be used for representing a crystal structure in a positive electrode active material can be judged by the Rietveld analysis of XRD patterns, for example. In this case, a unit cell is selected such that the value of GOF (goodness of fit) is small.

When charging that makes x in LiₓCoO₂ be 0.24 or less and discharging are repeated, the crystal structure of conventional lithium cobalt oxide repeatedly changes between the R-3m O3 type crystal structure in a discharged state and the H1-3 type crystal structure (i.e., an unbalanced phase change).

However, there is a large shift in the CoO₂ layers between these two crystal structures. As indicated by a dotted line and an arrow in FIG. 5, the CoO₂ layer in the H1-3 type crystal structure largely shifts from that in R-3m O3 in a discharged state. Such a dynamic structural change can adversely affect the stability of the crystal structure.

A difference in volume between these two crystal structures is also large. The difference in volume per the same number of cobalt atoms between the R-3m O3 type crystal structure in a discharged state and the H1-3 type crystal structure is greater than 3.5%, typically greater than or equal to 3.9%.

In addition, a structure in which CoO₂ layers are arranged continuously, such as the trigonal O1 type structure, included in the H1-3 type crystal structure is highly likely to be unstable.

Accordingly, when charging that makes x be 0.24 or less and discharging are repeated, the crystal structure of conventional lithium cobalt oxide is gradually broken. The broken crystal structure triggers degradation of the cycle performance. This is because the broken crystal structure has a smaller number of sites where lithium can exist stably and makes it difficult to insert and extract lithium.

On the other hand, in the positive electrode active material 100 of one embodiment of the present invention shown in FIG. 4, a change in the crystal structure between a discharged state with x in LiₓCoO₂ being 1 and a state with x being 0.24 or less is smaller than that in a conventional positive electrode active material. Specifically, a shift in the CoO₂ layers between the state with x of 1 and the state with x of 0.24 or less can be small. Furthermore, a change in the volume can be small in the case where the positive electrode active materials have the same number of cobalt atoms. Thus, the positive electrode active material 100 of one embodiment of the present invention can have a crystal structure that is difficult to break even when charging that makes x be 0.24 or less and discharging are repeated, and enables excellent cycle performance. In addition, the positive electrode active material 100 of one embodiment of the present invention with x in LiₓCoO₂ being 0.24 or less can have a more stable crystal structure than a conventional positive electrode active material. Thus, the positive electrode active material 100 of one embodiment of the present invention with x in LiₓCoO₂ being kept at 0.24 or less inhibits a short circuit. This is preferable because the safety of the secondary battery is improved.

FIG. 4 shows crystal structures of the inner portion 100b of the positive electrode active material 100 in a state where x in LiₓCoO₂ is 1 and in a state where x in LiₓCoO₂ is approximately 0.2. The inner portion 100b, accounting for the majority of the volume of the positive electrode active material 100, largely contributes to charge and discharge and is accordingly a portion where a shift in CoO₂ layers and a volume change matter most.

The positive electrode active material 100 with x being 1 has the R-3m O3 type crystal structure, which is the same as that of conventional lithium cobalt oxide.

However, the positive electrode active material 100 has a crystal structure different from the H1-3 type crystal structure in a state where x is 0.24 or less, e.g., approximately 0.2 or approximately 0.12, with which conventional lithium cobalt oxide has the H1-3 type crystal structure.

The positive electrode active material 100 of one embodiment of the present invention with x being approximately 0.2 has a trigonal crystal structure belonging to the space group R-3m. The symmetry of the CoO₂ layers of this structure is the same as that of O3. Thus, this crystal structure is called an O3′ type crystal structure. In FIG. 4, this crystal structure is denoted by R-3m O3′.

In the unit cell of the O3′ type crystal structure, the coordinates of cobalt and oxygen can be represented by Co (0, 0, 0.5) and O (0, 0, x) within the range of 0.20≤x≤0.25. In the unit cell, the lattice constant of the a-axis is preferably 2.797≤a≤2.837 (×10⁻¹ nm), further preferably 2.807≤a≤2.827 (×10⁻¹ nm), typically a=2.817 (×10⁻¹ nm). The lattice constant of the c-axis is preferably 13.681≤c≤13.881 (×10⁻¹ nm), further preferably 13.751≤c≤13.811, typically c=13.781 (×10⁻¹ nm).

In the O3′ type crystal structure, an ion of cobalt, nickel, magnesium, or the like occupies a site coordinated to six oxygen atoms. Note that a light element such as lithium sometimes occupies a site coordinated to four oxygen atoms.

As denoted by the dotted lines in FIG. 4, the CoO₂ layers hardly shift between the R-3m (O3) in a discharged state and the O3′ type crystal structure.

The R-3m (03) type crystal structure in a discharged state and the O3′ type crystal structure which contain the same number of cobalt atoms have a difference in volume of 2.5% or less, specifically 2.2% or less, typically 1.8%.

As described above, in the positive electrode active material 100 of one embodiment of the present invention, a change in the crystal structure caused when x in LiₓCoO₂ is small, i.e., when a large amount of lithium is extracted, is smaller than that in a conventional positive electrode active material. In addition, a change in the volume per the same number of cobalt atoms is inhibited. Thus, the crystal structure of the positive electrode active material 100 is less likely to break even when charging that makes x be 0.24 or less and discharging are repeated. Thus, a decrease in charge and discharge capacity of the positive electrode active material 100 in charge and discharge cycles is inhibited. Furthermore, the positive electrode active material 100 can stably use a larger amount of lithium than a conventional positive electrode active material and thus has high discharge capacity per weight and per volume. Accordingly, with the use of the positive electrode active material 100, a secondary battery with high discharge capacity per weight and per volume can be fabricated.

Note that the positive electrode active material 100 is confirmed to have the O3′ type crystal structure in some cases when x in LiₓCoO₂ is greater than or equal to 0.15 and less than or equal to 0.24, and is assumed to have the O3′ type crystal structure even when x is greater than 0.24 and less than or equal to 0.27. However, the crystal structure is influenced by not only x in LiₓCoO₂ but also the number of charge and discharge cycles, a charge current and a discharge current, temperature, an electrolyte, and the like, so that the range of x is not limited to the above.

Hence, when x in LiₓCoO₂ in the positive electrode active material 100 is greater than 0.1 and less than or equal to 0.24, not all of the inner portion 100b of the positive electrode active material 100 has to have the O3′ type crystal structure. The positive electrode active material may include another crystal structure or may be partly amorphous.

In the positive electrode active material 100, when the charge voltage is increased, the H1-3 type crystal structure is eventually observed in some cases. As described above, the crystal structure is influenced by the number of charge and discharge cycles, a charge current and a discharge current, temperature, an electrolyte, and the like, so that the positive electrode active material 100 of one embodiment of the present invention sometimes has the O3′ type crystal structure even at a lower charge voltage, e.g., a charge voltage of higher than or equal to 4.5 V and lower than 4.6 V at 25° C.

Although a chance of the existence of lithium is the same in all lithium sites in O3′ in FIG. 4, one embodiment of the present invention is not limited thereto. Lithium may exist unevenly in only some of the lithium sites: for example, lithium may symmetrically exist as in the monoclinic O1 (Li_{0.5}CoO₂) shown in FIG. 5. Distribution of lithium can be analyzed by neutron diffraction, for example.

The O3′ type crystal structure can be regarded as a crystal structure that contains lithium between layers randomly but is similar to a CdCl₂ type crystal structure. The crystal structure similar to the CdCl₂ type crystal structure is close to a crystal structure of lithium nickel oxide that is charged to be Li_{0.06}NiO₂; however, pure lithium cobalt oxide or a layered rock-salt positive electrode active material containing a large amount of cobalt is known not to have the CdCl₂ type crystal structure in general.

The concentration gradient of the additive element A is preferably similar in a plurality of portions of the surface portion 100a of the positive electrode active material 100. In other words, it is preferable that the reinforcement derived from the additive element A uniformly occurs in the surface portion 100a. When the surface portion 100a partly has reinforcement, stress might be concentrated on parts that do not have reinforcement. The concentration of stress on part of the positive electrode active material 100 might cause defects such as cracks from that part, leading to breakage of the positive electrode active material and a decrease in discharge capacity.

Note that the additive elements A do not necessarily have similar concentration gradients throughout the surface portion 100a of the positive electrode active material 100.

Here, the portion near C-D has a layered rock-salt crystal structure belonging to R-3m and the surface of the portion has a (001) orientation. The distribution of the additive element A at the surface having a (001) orientation may be different from that at other surfaces. For example, the surface having a (001) orientation and the surface portion 100a thereof may have limited distribution of concentration peaks of one or two or more selected from the additive elements X and the additive elements Y, in a shallow portion from the surface as compared to the surface having an orientation other than a (001) orientation. Alternatively, the surface having a (001) orientation and the surface portion 100a thereof may have a lower concentration of one or two or more selected from the additive elements X and the additive elements Y than a surface having another orientation. Further alternatively, at the surface having a (001) orientation and the surface portion 100a thereof, one or two or more elements selected from the additive elements X and the additive element Y may be below the lower detection limit.

In a layered rock-salt crystal structure belonging to R-3m, cations are arranged parallel to the (001) plane. In other words, CoO₂ layers and lithium layers are alternately stacked parallel to the (001) plane. Accordingly, a diffusion path of lithium ions also exists parallel to a (001) plane.

The CoO₂ layer is relatively stable and thus, the surface of the positive electrode active material 100 is more stable when having a (001) orientation. A main diffusion path of lithium ions in charging and discharging is not exposed at the (001) plane.

By contrast, a diffusion path of lithium ions is exposed at a surface having an orientation other than a (001) orientation. Thus, the surface having an orientation other than a (001) orientation and the surface portion 100a thereof easily lose stability because they are regions where extraction of lithium ions starts as well as important regions for maintaining a diffusion path of lithium ions. It is thus extremely important to reinforce the surface having an orientation other than a (001) orientation and the surface portion 100a thereof so that the crystal structure of the whole positive electrode active material 100 is maintained.

Accordingly, in the positive electrode active material 100 of another embodiment of the present invention, it is important to distribute the additive element A in the surface having an orientation other than a (001) orientation and the surface portion 100a thereof as illustrated in FIG. 3A and FIG. 3C. By contrast, in the surface having a (001) orientation and the surface portion 100a thereof, the concentration of the additive element A may be low as described above or the additive element A may be absent.

In the formation method as described in the following embodiment, in which high-purity LiCoO₂ is formed, the additive element A is mixed afterwards, and heating is performed, the additive element A spreads mainly through a diffusion path of lithium ions. Thus, distribution of the additive element A at the plane other than (001) and the surface portion 100a thereof can easily fall within a preferred range.

### <Crystal Grain Boundary>

It is further preferable that the additive element A contained in the positive electrode active material 100 of one embodiment of the present invention have the above-described distribution and be at least partly unevenly distributed at the crystal grain boundary and the vicinity thereof.

Note that in this specification and the like, uneven distribution means that the concentration of an element in a certain region differs from those in other regions. This may be rephrased as segregation, precipitation, unevenness, deviation, or a mixture of a high-concentration portion and a low-concentration portion.

For example, the concentration of magnesium at the crystal grain boundary and the vicinity thereof in the positive electrode active material 100 is preferably higher than that in the other regions in the inner portion 100b. In addition, the concentration of fluorine at the crystal grain boundary and the vicinity thereof is preferably higher than that in the other regions in the inner portion 100b. The concentration of nickel at the crystal grain boundary and the vicinity thereof is preferably higher than that in the other regions in the inner portion 100b. The concentration of aluminum at the crystal grain boundary and the vicinity thereof is preferably higher than that in the other regions in the inner portion 100b.

The crystal grain boundary is a type of plane defect. Thus, the crystal grain boundary tends to be unstable and the crystal structure easily starts to change like the surface of the particle. Thus, the higher the concentration of the additive element A at the crystal grain boundary and its vicinity is, the more effectively the change in the crystal structure can be inhibited.

When the concentration of magnesium and the concentration of fluorine are high at the crystal grain boundary and the vicinity thereof, the concentration of magnesium and the concentration of fluorine in the vicinity of a surface generated by a crack are also high even when the crack is generated along the crystal grain boundary of the positive electrode active material 100 of one embodiment of the present invention. Thus, the positive electrode active material including a crack can also have an increased corrosion resistance to hydrofluoric acid.

### <Analysis Method>

Whether or not a given positive electrode active material is the positive electrode active material 100 of one embodiment of the present invention, which has the O3′ type crystal structure when x in LiₓCoO₂ is small, can be judged by analyzing a positive electrode including the positive electrode active material with small x in LiₓCoO₂ by XRD, electron diffraction, neutron diffraction, electron spin resonance (ESR), nuclear magnetic resonance (NMR), or the like.

XRD is particularly preferable because the symmetry of a transition metal such as cobalt in the positive electrode active material can be analyzed with high resolution, comparison of the degree of crystallinity and comparison of the crystal orientation can be performed, distortion of lattice periodicity and the crystallite size can be analyzed, and a positive electrode obtained only by disassembling a secondary battery can be measured with sufficient accuracy, for example. A diffraction peak reflecting the crystal structure of the inner portion 100b of the positive electrode active material 100, which accounts for the majority of the volume of the positive electrode active material 100, is obtained through XRD, in particular, powder XRD.

In the case where the crystallite size is analyzed by powder XRD, the measurement is preferably performed while the influence of orientation due to pressure or the like is preferably removed. For example, it is preferable that the positive electrode active material be taken out from a positive electrode obtained from a disassembled secondary battery, the positive electrode active material be made into a powder sample, and then the measurement be performed.

As described above, the positive electrode active material 100 of one embodiment of the present invention has a feature of a small change in the crystal structure between when x in LiₓCoO₂ is 1 and when x is less than or equal to 0.24. A material 50% or more of which has the crystal structure to be largely changed by high-voltage charge is not preferable because the material cannot withstand repetition of high-voltage charge and discharge.

It should be noted that the O3′ type crystal structure is not obtained in some cases only by addition of the additive element. For example, when x in LiₓCoO₂ is less than or equal to 0.24, lithium cobalt oxide containing magnesium and fluorine or lithium cobalt oxide containing magnesium and aluminum has the O3′ type crystal structure at 60% or more in some cases, and has the H1-3 type crystal structure at 50% or more in other cases, depending on the concentration and distribution of the additive element.

In addition, in the case where x is too small, e.g., 0.1 or less, or under the condition where the charge voltage is higher than 4.9 V, the positive electrode active material 100 of one embodiment of the present invention sometimes has the H1-3 type crystal structure or the trigonal O1 type crystal structure. Thus, determining whether or not a positive electrode active material is the positive electrode active material 100 of one embodiment of the present invention requires analysis of the crystal structure by XRD and other methods and data such as charge capacity or charge voltage.

Note that a positive electrode active material with small x sometimes causes a change in the crystal structure when exposed to the air. For example, the O3′ type crystal structure changes into the H1-3 type crystal structure in some cases. For that reason, all samples subjected to analysis of crystal structures are preferably handled in an inert atmosphere such as an argon atmosphere.

Whether the distribution of the additive element contained in a positive electrode active material is in the above-described state can be judged by, for example, analysis using XPS, energy dispersive X-ray spectroscopy (EDX), EPMA (electron probe microanalysis), or the like.

The crystal structure of the surface portion 100a, the crystal grain boundary, or the like can be analyzed by electron diffraction of a cross section of the positive electrode active material 100, for example.

### <<Charge Method>>

Charge for determining whether or not a composite oxide is the positive electrode active material 100 of one embodiment of the present invention can be performed on a coin cell (CR2032 type with a diameter of 20 mm and a height of 3.2 mm) with a lithium counter electrode, for example.

More specifically, a positive electrode can be formed by application of slurry in which the positive electrode active material, a conductive material, and a binder are mixed to a positive electrode current collector made of aluminum foil.

A lithium metal can be used for a counter electrode. Note that when the counter electrode is formed using a material other than the lithium metal, the potential of a secondary battery differs from the potential of the positive electrode. Unless otherwise specified, the voltage and the potential in this specification and the like refer to the potential of a positive electrode.

As an electrolyte contained in the electrolyte solution, 1 mol/L lithium hexafluorophosphate (LiPF₆) can be used. As the electrolyte solution, an electrolyte solution in which ethylene carbonate (EC) and diethyl carbonate (DEC) at EC:DEC=3:7 (volume ratio) and vinylene carbonate (VC) at 2 wt % are mixed can be used.

As a separator, a 25-μm-thick polypropylene porous film can be used.

Stainless steel (SUS) can be used for a positive electrode can and a negative electrode can.

The coin cell fabricated with the above conditions is charged with a given voltage (e.g., 4.5 V, 4.55 V, 4.6 V, 4.65 V, 4.7 V, 4.75 V, or 4.8 V). The charge method is not particularly limited as long as charge with a given voltage can be performed for sufficient time. In the case of CCCV charge, for example, CC charge can be performed with a current higher than or equal to 20 mA/g and lower than or equal to 100 mA/g. CV charge can be ended with a current higher than or equal to 2 mA/g and lower than or equal to 10 mA/g. To observe a phase change of the positive electrode active material, charge with such a small current value is preferably performed. The temperature is set to 25° C. or 45° C. After charge is performed in this manner, the coin cell is disassembled in a glove box with an argon atmosphere to take out the positive electrode, whereby the positive electrode active material with predetermined charge capacity can be obtained. In order to inhibit a reaction with components in the external environment, the positive electrode is preferably enclosed in an argon atmosphere in performing various analyses later. For example, XRD can be performed on the positive electrode enclosed in an airtight container with an argon atmosphere. At this time, the airtight container needs to be closed tightly, and the argon atmosphere needs to be maintained during the measurement. After charge is completed, the positive electrode is preferably taken out immediately and subjected to the analysis. Specifically, the positive electrode is preferably subjected to analysis within an hour, further preferably within 30 minutes after the completion of charge. Furthermore, it takes preferably five minutes or less, further preferably two minutes or less after extraction from the glove box with an argon atmosphere before start of XRD analysis.

In the case where the crystal structure in a charged state after charge and discharge are performed multiple times is analyzed, the conditions of the charge and discharge performed multiple times may be different from the above-described charge conditions. For example, as charge, constant current charge to a given voltage (e.g., 4.6 V, 4.65 V, 4.7 V, 4.75 V, or 4.8 V) at a current value higher than or equal to 20 mA/g and lower than or equal to 100 mA/g can be performed and then constant voltage charge can be performed until the current value becomes higher than or equal to 2 mA/g and lower than or equal to 10 mA/g, and as discharge, constant current discharge can be performed at 2.5 V at higher than or equal to 20 mA/g and lower than or equal to 100 mA/g.

Also in the case where the crystal structure in a discharged state after charge and discharge are performed multiple times is analyzed, constant current discharge can be performed at 2.5 V and a current value higher than or equal to 20 mA/g and lower than or equal to 100 mA/g, for example.

### <XRD>

The apparatus and conditions for the XRD measurement are not particularly limited.

The measurement can be performed with the apparatus and conditions as described below, for example.
XRD apparatus: D8 ADVANCE produced by Bruker AXS
X-ray source: CuKα₁ radiation
Output: 40 KV, 40 mA
Slit width: Div. Slit, 0.5°
Detector: LynxEye
Scanning method: 2θ/θ continuous scan
Measurement range (2θ): from 15° to 90° (100 minutes)
Step width (2θ): 0.01°
Counting time: 1 second/step
Rotation of sample stage: 15 rpm

In the case where the measurement sample is a powder, the sample can be set by, for example, being put in a glass sample holder or being sprinkled on a reflection-free silicon plate to which grease is applied. In the case where the measurement sample is a positive electrode, the positive electrode can be set by being attached to a substrate with a double-sided adhesive tape such that the position of the positive electrode active material layer can be adjusted to the measurement plane required by the apparatus.

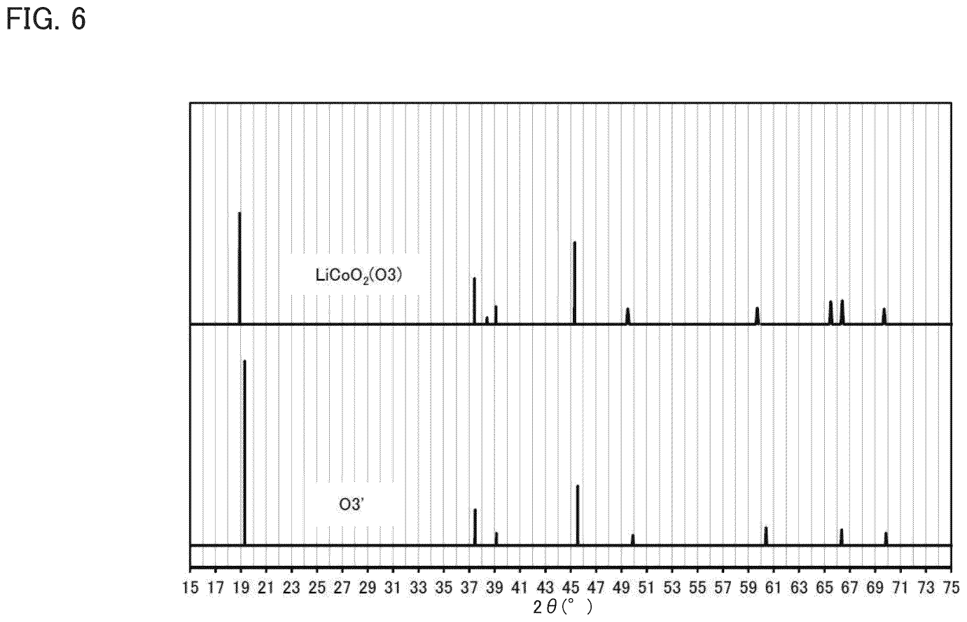

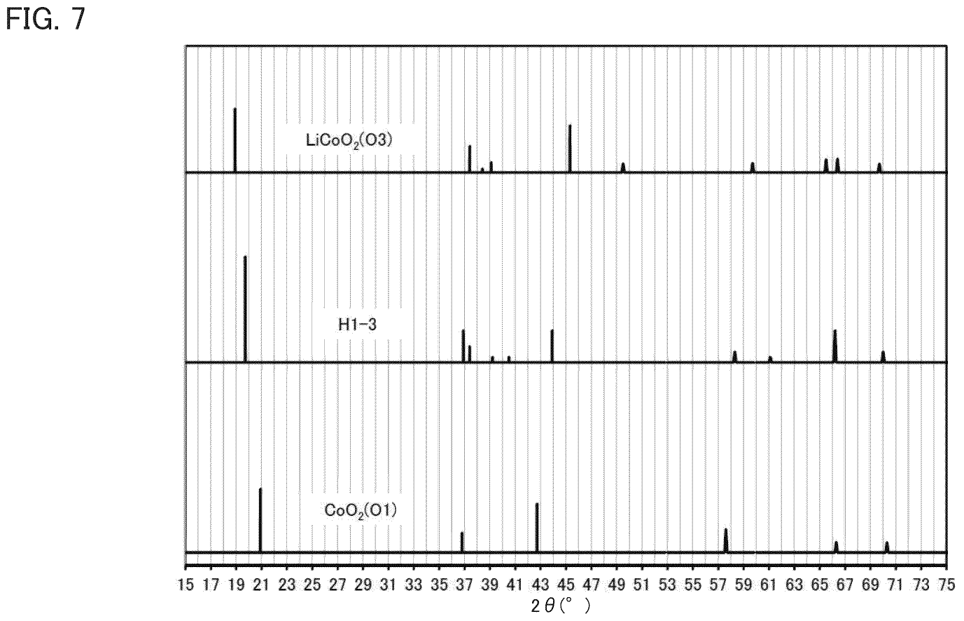

FIG. 6 and FIG. 7 show ideal powder XRD patterns with CuKα1 radiation that are calculated from models of the O3′ type crystal structure and the H1-3 type crystal structure. For comparison, ideal XRD patterns calculated from the crystal structure of LiCoO₂ O3 with x in LiₓCoO₂ of 1 and the crystal structure of the trigonal O1 with x of 0 are also shown. Note that the patterns of LiCoO₂ (O3) and CoO₂ (O1) are made from crystal structure data obtained from ICSD (Inorganic Crystal Structure Database) using Reflex Powder Diffraction, which is a module of Materials Studio (BIOVIA). The 2θ range is from 15° to 75°, the step size is 0.01, the wavelength λ1 is 1.540562×10⁻¹⁰ m, the wavelength λ2 is not set, and a single monochromator is used. XRD patterns of the H1-3 type crystal structure are made from crystal structure data of the H1-3 type crystal structure illustrated in FIG. 5 in a manner similar to the above-described method. The O3′ type crystal structure is estimated from the XRD pattern of the positive electrode active material of one embodiment of the present invention, the crystal structure is fitted with TOPAS Ver. 3 (crystal structure analysis software produced by Bruker Corporation), and the XRD pattern of the O3′ type crystal structure is made in a manner similar to that for other structures.

As shown in FIG. 6, the O3′ type crystal structure exhibits diffraction peaks at 2θ of 19.25±0.12° (greater than or equal to 19.13° and less than or equal to) 19.37° and 2θ of 45.47±0.10° (greater than or equal to 45.37° and less than or equal to 45.57°).

However, as shown in FIG. 7, the H1-3 type crystal structure and trigonal O1 do not exhibit peaks at these positions. Thus, the diffraction peaks at 2θ of 19.25±0.12° (greater than or equal to 19.13° and less than or equal to) 19.37° and 2θ of 45.47±0.10° (greater than or equal to 45.37° and less than or equal to) 45.57° in a state where x in LiₓCo₂ is small can be the features of the positive electrode active material 100 of one embodiment of the present invention.

It can be said that the positions of the XRD diffraction peaks exhibited by the crystal structure with x=1 and the crystal structure with x≤0.24 are close to each other. More specifically, it can be said that a difference in 2θ between the main diffraction peak exhibited by the crystal structure with x=1 and the main diffraction peak exhibited by the crystal structure with x≤0.24, which are exhibited at 2θ of greater than or equal to 42° and less than or equal to 46°, is 0.7° or less, preferably 0.5° or less.

Although the positive electrode active material 100 of one embodiment of the present invention has the O3′ type crystal structure when x in LiₓCoO₂ is small, not all of the positive electrode active material 100 necessarily has the O3′ type crystal structure. The positive electrode active material may include another crystal structure or may be partly amorphous. Note that when the XRD patterns are subjected to the Rietveld analysis, the O3′ type crystal structure preferably accounts for greater than or equal to 50%, further preferably greater than or equal to 60%, still further preferably greater than or equal to 66%. The positive electrode active material in which the O3′ type crystal structure accounts for greater than or equal to 50%, preferably greater than or equal to 60%, further preferably greater than or equal to 66% can have sufficiently good cycle performance.

Furthermore, even after 100 or more cycles of charge and discharge after the measurement starts, the O3′ type crystal structure preferably accounts for more than or equal to 35%, further preferably more than or equal to 40%, still further preferably more than or equal to 43% when the Rietveld analysis is performed.

Sharpness of a diffraction peak in an XRD pattern indicates the degree of crystallinity. It is thus preferable that the diffraction peaks after charging be sharp, in other words, have a small half width. Even peaks that are derived from the same crystal phase have different half widths depending on the XRD measurement conditions or the 2θ value. In the case of the above-described measurement conditions, the peak observed at 2θ of greater than or equal to 43° and less than or equal to 46° preferably has a half width of less than or equal to 0.2°, further preferably less than or equal to 0.15°, still further preferably less than or equal to 0.12°. Note that not all peaks need to fulfill the requirement. A crystal phase can be regarded as having high crystallinity when one or more peaks fulfill the requirement. Such high crystallinity contributes to stability of the crystal structure after sufficient charge.

The crystallite size of the O3′ type crystal structure in the positive electrode active material 100 does not decrease to less than approximately 1/20 that of LiCoO₂ (O3) in a discharged state. Thus, a clear peak of the O3′ type crystal structure can be observed when x in LiₓCoO₂ is small, even under the same XRD measurement conditions as those of a positive electrode before the charge and discharge. By contrast, conventional LiCoO₂ has a small crystallite size and a broad and small peak even when it can have a structure part of which is similar to the O3′ type crystal structure. The crystallite size can be calculated from the half width of the XRD peak.

### <XPS>

In an inorganic oxide, a region that is approximately 2 to 8 nm (usually, less than or equal to 5 nm) in depth from a surface can be analyzed by X-ray photoelectron spectroscopy (XPS) using monochromatic aluminum Kα radiation as an X-ray source: thus, the concentrations of elements in approximately half the depth of the surface portion 100a can be quantitatively analyzed. The bonding states of the elements can be analyzed by narrow scanning. Note that in many cases, the quantitative accuracy of XPS is approximately ±1 at %, and the lower detection limit is approximately 1 at % but depends on the element.

In the positive electrode active material 100 of one embodiment of the present invention, the concentration of one or more selected from the additive elements is preferably higher in the surface portion 100a than in the inner portion 100b. This means that the concentration of one or more selected from the additive elements in the surface portion 100a is preferably higher than the average concentration of the selected element(s) in the entire positive electrode active material 100. For this reason, for example, it is preferable that the concentration of one or more additive elements selected from the surface portion 100a, which is measured by XPS or the like, be higher than the average concentration of the additive element(s) in the entire positive electrode active material 100, which is measured by ICP-MS (inductively coupled plasma mass spectrometry), GD-MS (glow discharge mass spectrometry), or the like. For example, the concentration of magnesium in at least part of the surface portion 100a, which is measured by XPS or the like, is preferably higher than the concentration of magnesium in the entire positive electrode active material 100. The concentration of nickel in at least part of the surface portion 100a is preferably higher than the concentration of nickel in the entire positive electrode active material 100. The concentration of aluminum in at least part of the surface portion 100a is preferably higher than the concentration of aluminum in the entire positive electrode active material 100. The concentration of fluorine in at least part of the surface portion 100a is preferably higher than the concentration of fluorine in the entire positive electrode active material 100.

Note that the surface and the surface portion 100a of the positive electrode active material 100 of one embodiment of the present invention do not contain a carbonate, a hydroxy group, or the like that is chemically adsorbed after formation of the positive electrode active material 100. Furthermore, an electrolyte solution, a binder, a conductive material, and a compound originating from any of these that are attached to the surface of the positive electrode active material 100 are not contained either. Thus, in quantitative analysis of the elements contained in the positive electrode active material, correction may be performed to exclude carbon, hydrogen, excess oxygen, excess fluorine, and the like that might be detected in surface analysis such as XPS. For example, in XPS, the kinds of bonds can be identified by analysis, and a C—F bond originating from a binder may be excluded by correction.

Furthermore, before any of various kinds of analyses is performed, a sample of a positive electrode active material or a positive electrode active material layer or the like may be washed, for example, to eliminate an electrolyte solution, a binder, a conductive material, and a compound originating from any of these that are attached to the surface of the positive electrode active material. Although lithium might be dissolved into a solvent or the like used in the washing at this time, the additive element is not easily dissolved even in that case: thus, the atomic ratio of the additive element is not affected.

The concentration of the additive element may be compared using the ratio of the additive element to cobalt. The use of the ratio of the additive element to cobalt is preferable because it enables comparison while reducing the influence of a carbonate or the like that is chemically adsorbed after formation of the positive electrode active material. For example, the atomic ratio Mg/Co of magnesium to cobalt in the XPS analysis is preferably greater than or equal to 0.400, further preferably greater than or equal to 0.500, still further preferably greater than or equal to 0.600, yet still further preferably greater than or equal to 0.700, yet still further preferably greater than or equal to 0.800, yet still further preferably greater than or equal to 0.900, yet still further preferably greater than or equal to 1.000. Moreover, Mg/Co is preferably less than or equal to 2.000, further preferably less than or equal to 1.500, still further preferably less than or equal to 1.400, yet still further preferably less than or equal to 1.300, yet still further preferably less than or equal to 1.200.

For example, the atomic ratio Ni/Co of nickel to cobalt in the XPS analysis is preferably greater than or equal to 0.05, further preferably greater than or equal to 0.06, still further preferably greater than or equal to 0.07, yet still further preferably greater than or equal to 0.08, yet still further preferably greater than or equal to 0.09. Moreover, Ni/Co is preferably less than or equal to 0.200, further preferably less than or equal to 0.150, still further preferably less than or equal to 0.140, yet still further preferably less than or equal to 0.130, yet still further preferably less than or equal to 0.120, yet still further preferably less than or equal to 0.110.

For example, the atomic ratio F/Co of fluorine to cobalt in the XPS analysis is preferably greater than or equal to 0.100, further preferably greater than or equal to 0.200, still further preferably greater than or equal to 0.300, yet still further preferably greater than or equal to 0.400, yet still further preferably greater than or equal to 0.500, yet still further preferably greater than or equal to 0.600, yet still further preferably greater than or equal to 0.700. Moreover, F/Co is preferably less than or equal to 1.500, further preferably less than or equal to 1.200, still further preferably less than or equal to 1.100, yet still further preferably less than or equal to 1.000, yet still further preferably less than or equal to 0.900.

When the ratios are within the above ranges, it can be said that these additive elements are not attached to the surface of the positive electrode active material 100 in a narrow range but widely distributed at a preferable concentration in the surface portion 100a of the positive electrode active material 100. That is, when the ratios are within the above ranges in the XPS analysis results of the positive electrode active material 100, the crystal structure is less likely to be broken even when charge that makes x be 0.24 or less and discharge are repeated, so that excellent cycle performance can be achieved.

In the XPS analysis, monochromatic aluminum Kα radiation can be used as an X-ray source, for example. An extraction angle is, for example, 45°. For example, the measurement can be performed using the following apparatus and conditions.
Measurement apparatus: Quanterall produced by PHI, Inc.
X-ray source: monochromatic Al Kα (1486.6 eV)
Detection area: 100 μmϕ
Detection depth: approximately 4 to 5 nm (extraction angle) 45°
Measurement spectrum: wide scanning, narrow scanning of each detected element

In addition, when the positive electrode active material 100 of one embodiment of the present invention is analyzed by XPS, a peak indicating the bonding energy of fluorine with another element is preferably at greater than or equal to 682 eV and less than 685 eV, further preferably approximately 684.3 eV. The above value is different from 685 eV, which is the bonding energy of lithium fluoride, and 686 eV, which is the bonding energy of magnesium fluoride. That is, the positive electrode active material 100 of one embodiment of the present invention containing fluorine is preferably in the bonding state other than lithium fluoride and magnesium fluoride.

Furthermore, when the positive electrode active material 100 of one embodiment of the present invention is analyzed by XPS, a peak indicating the bonding energy of magnesium with another element is preferably at greater than or equal to 1302 eV and less than 1304 eV, further preferably at approximately 1303 eV. The above value is different from 1305 eV, which is the bonding energy of magnesium fluoride, and is close to a value of the bonding energy of magnesium oxide. That is, the positive electrode active material 100 of one embodiment of the present invention containing magnesium is preferably in the bonding state other than magnesium fluoride.

### <EDX>

One or two or more selected from the additive elements contained in the positive electrode active material 100 preferably have a concentration gradient. It is further preferable that the additive elements in the positive electrode active material 100 exhibit concentration peaks at different depths from the surface. The concentration gradient of the additive element can be evaluated, for example, by exposing a cross section of the positive electrode active material 100 using FIB (Focused Ion Beam) or the like and analyzing the cross section using energy dispersive X-ray spectroscopy (EDX), EPMA (electron probe microanalysis), or the like.

In the EDX measurement, to measure a region while scanning is performed and evaluate the region two-dimensionally is referred to as EDX area analysis. The measurement by line scan, which is performed to evaluate the atomic concentration distribution in a positive electrode active material, is referred to as EDX line analysis. Furthermore, extracting data of a linear region from EDX area analysis is referred to as EDX line analysis in some cases. Measurement of a region without scanning is referred to as EDX point analysis.

By EDX area analysis (e.g., element mapping), the concentrations of the additive element in the surface portion 100a, the inner portion 100b, the vicinity of a crystal grain boundary, and the like of the positive electrode active material 100 can be quantitatively analyzed. By EDX line analysis, the concentration distribution and the highest concentration of the additive element can be analyzed. An analysis method in which a thinned sample is used, such as STEM-EDX, is preferred because the method makes it possible to analyze the concentration distribution in the depth direction from the surface toward the center in a specific region of the positive electrode active material regardless of the distribution in the front-back direction.

Accordingly, EDX area analysis or EDX point analysis of the positive electrode active material 100 of one embodiment of the present invention preferably reveals that the concentration of each additive element, in particular, the additive element X in the surface portion 100a is higher than that in the inner portion 100b.

The surface of the positive electrode active material in STEM-EDX line analysis, for example, refers to a point where the characteristic X-ray derived from cobalt is equal to 50% of the sum of an average value M_{AVE} of the detected amount in the inner portion and an average value M_{BG} of the background amount or a point where the characteristic X-ray derived from oxygen is equal to 50% of the sum of an average value O_{AVE} of the detected amount in the inner portion and an average value O_{BG} of the background amount. Note that in the case where the positions of the points of 50% of the sum of the detected amount in the inner portion and the background amount differ between cobalt and oxygen, the difference is probably due to the influence of a carbonate, a metal oxide containing oxygen, or the like, which is attached to the surface. It is thus possible to employ the point of 50% of the sum of the average value M_{AVE} of the detected amount in the inner portion and the average value M_{BG} of the background amount of cobalt.

The average value M_{BG} of the amount of background cobalt can be calculated by averaging the amount in the range greater than or equal to 2 nm, preferably greater than or equal to 3 nm, which is outside a portion in the vicinity of the portion where the detected amount of cobalt begins to increase, for example. The average value M_{AVE} of the detected amount in the inner portion can be calculated by averaging the amount in the range greater than or equal to 2 nm, preferably greater than or equal to 3 nm in a region where the count numbers of cobalt and oxygen are saturated and stabilized, e.g., a portion that is greater than or equal to 30 nm, preferably greater than or equal to 50 nm in depth from a region where the detected amount of cobalt begins to increase, for example. The average value O_{BG} of the amount of background oxygen and the average value O_{AVE} of the detected amount of oxygen in the inner portion can be calculated in a similar manner.

The surface of the positive electrode active material 100 in, for example, a cross-sectional STEM (scanning transmission electron microscope) image is a boundary between a region where an image derived from the crystal structure of the positive electrode active material is observed and a region where the image is not observed, and is determined as the outermost surface of a region where an atomic column derived from an atomic nucleus of a metal element that has a greater atomic number than lithium among the metal elements constituting the positive electrode active material is confirmed. The surface in a STEM image or the like may be judged in combination with analysis with higher spatial resolution.

A peak in STEM-EDX line analysis refers to a local maximum value in a graph in which the vertical axis indicates the intensity of characteristic X-rays of elements and the horizontal axis indicates the analysis position, and can also represent the maximum value of the detection intensity or the characteristic X-ray of each element. As a noise in STEM-EDX line analysis, a measured value having a half width smaller than or equal to spatial resolution (R), for example, smaller than or equal to R/2 can be given.

For example, EDX area analysis or EDX point analysis of the positive electrode active material 100 containing magnesium as the additive element preferably reveals that the concentration of magnesium in the surface portion 100a is higher than that in the inner portion 100b. Moreover, in the EDX line analysis, a peak of the concentration of magnesium in the surface portion 100a is preferably observed in a region extending, toward the center of the positive electrode active material 100, from the surface thereof to a depth of 3 nm, further preferably 1 nm, still further preferably 0.5 nm. Alternatively, the peak is preferably observed within ±1 nm from the surface. In addition, the concentration of magnesium preferably attenuates, at a depth of 1 nm from the point where the concentration reaches the peak, to less than or equal to 60% of the peak concentration. In addition, the concentration of magnesium preferably attenuates, at a depth of 2 nm from the point where the concentration reaches the peak, to less than or equal to 30% of the peak concentration. Here, a “peak of concentration” refers to the local maximum value of concentration. Note that owing to the influence of spatial resolution in the EDX line analysis, the position where the peak of the magnesium concentration exists sometimes has a negative value as a depth from the surface toward the inner portion.

When the positive electrode active material 100 contains magnesium and fluorine as the additive elements, the distribution of fluorine preferably overlaps with the distribution of magnesium. For example, a difference in the depth direction between a peak of the concentration of fluorine and a peak of the concentration of magnesium is preferably within 10 nm, further preferably within 3 nm, still further preferably within 1 nm.

In the EDX line analysis, a peak of the concentration of fluorine in the surface portion 100a is preferably observed in a region extending, toward the center of the positive electrode active material 100, from the surface thereof to a depth of 3 nm, further preferably 1 nm, still further preferably 0.5 nm. Alternatively, the peak is preferably observed within ±1 nm from the surface. It is further preferable that a peak of the concentration of fluorine be exhibited slightly closer to the surface side than a peak of the concentration of magnesium is, which increases resistance to hydrofluoric acid. For example, it is preferable that a peak of the concentration of fluorine be exhibited slightly closer to the surface side than a peak of the concentration of magnesium is by 0.5 nm or more, further preferably 1.5 nm or more.

When the positive electrode active material 100 contains nickel as the additive element, a peak of the concentration of nickel in the surface portion 100a is preferably observed in a region extending, toward the center of the positive electrode active material 100, from the surface thereof to a depth of 3 nm, further preferably 1 nm, still further preferably 0.5 nm. Alternatively, the peak is preferably observed within ±1 nm from the surface. When the positive electrode active material 100 contains magnesium and nickel, the distribution of nickel preferably overlaps with the distribution of magnesium. For example, a difference in the depth direction between a peak of the concentration of nickel and a peak of the concentration of magnesium is preferably within 10 nm, further preferably within 3 nm, still further preferably within 1 nm.

In the case where the positive electrode active material 100 contains aluminum as the additive element, the peak of the concentration of magnesium, nickel, or fluorine is preferably closer to the surface than the peak of the concentration of aluminum is in the surface portion 100a in the EDX line analysis. For example, the peak of the concentration of aluminum is preferably located at a depth of greater than or equal to 0.5 nm and less than or equal to 50 nm, further preferably greater than or equal to 3 nm and less than or equal to 30 nm from the surface toward the center of the positive electrode active material 100.

EDX line, area, or point analysis of the positive electrode active material 100 preferably reveals that the atomic ratio of magnesium Mg to cobalt Co (Mg/Co) at a peak of the concentration of magnesium is preferably greater than or equal to 0.05 and less than or equal to 0.6, further preferably greater than or equal to 0.1 and less than or equal to 0.4. The atomic ratio of aluminum Al to cobalt Co (Al/Co) at a peak of the concentration of aluminum is preferably greater than or equal to 0.01 and less than or equal to 0.6, further preferably greater than or equal to 0.05 and less than or equal to 0.45. The atomic ratio of nickel Ni to cobalt Co (Ni/Co) at a peak of the concentration of nickel is preferably higher than or equal to 0) and lower than or equal to 0.2, further preferably higher than or equal to 0.01 and lower than or equal to 0.1, still further preferably higher than or equal to 0.05 and lower than or equal to 0.1. The atomic ratio of fluorine F to cobalt Co (F/Co) at a peak of the concentration of fluorine is preferably higher than or equal to (and lower than or equal to 1.6, further preferably higher than or equal to 0.1 and lower than or equal to 1.4.

The crystal grain boundary refers to, for example, a portion where particles of the positive electrode active material 100 adhere to each other or a portion where a crystal orientation changes inside the positive electrode active material 100, e.g., a portion where repetition of bright lines and dark lines is discontinuous in a STEM image or the like, a portion including a large number of crystal defects, a portion with a disordered crystal structure, or the like. A crystal defect refers to a defect that can be observed in a cross-sectional TEM (transmission electron microscope) image, a cross-sectional STEM image, or the like, i.e., a structure containing another atom between lattices, a hollow, or the like. The crystal grain boundary is one of plane defects. The vicinity of the crystal grain boundary refers to a region positioned within 10 nm from the crystal grain boundary.

When the line analysis or the area analysis is performed on the positive electrode active material 100, the atomic ratio of the additive element A to cobalt Co (A/Co) in the vicinity of the crystal grain boundary is preferably greater than or equal to 0.020 and less than or equal to 0.50. It is further preferably greater than or equal to 0.025 and less than or equal to 0.30. It is further preferably greater than or equal to 0.030 and less than or equal to 0.20. Alternatively, it is preferably greater than or equal to 0.020 and less than or equal to 0.30. Alternatively, it is preferably greater than or equal to 0.020 and less than or equal to 0.20. Alternatively, it is preferably greater than or equal to 0.025 and less than or equal to 0.50. Alternatively, it is preferably greater than or equal to 0.025 and less than or equal to 0.20. Alternatively, it is preferably greater than or equal to 0.030 and less than or equal to 0.50. Alternatively, it is preferably greater than or equal to 0.030 and less than or equal to 0.30.

When the line analysis or the area analysis is performed on the positive electrode active material 100 containing magnesium as the additive element, for example, the atomic ratio of magnesium to cobalt (Mg/Co) in the vicinity of the crystal grain boundary is preferably greater than or equal to 0.020 and less than or equal to 0.50. It is further preferably greater than or equal to 0.025 and less than or equal to 0.30. It is further preferably greater than or equal to 0.030 and less than or equal to 0.20. Alternatively, it is preferably greater than or equal to 0.020 and less than or equal to 0.30. Alternatively, it is preferably greater than or equal to 0.020 and less than or equal to 0.20. Alternatively, it is preferably greater than or equal to 0.025 and less than or equal to 0.50. Alternatively, it is preferably greater than or equal to 0.025 and less than or equal to 0.20. Alternatively, it is preferably greater than or equal to 0.030 and less than or equal to 0.50. Alternatively, it is preferably greater than or equal to 0.030 and less than or equal to 0.30. When the ratio is within the above range in a plurality of portions, e.g., three or more portions of the positive electrode active material 100, it can be said that the additive element is not attached to the surface of the positive electrode active material 100 in a narrow range but widely distributed at a preferable concentration in the surface portion 100a of the positive electrode active material 100.

### <Raman Spectroscopy>

As described above, at least part of the surface portion 100a of the positive electrode active material 100 of one embodiment of the present invention preferably has a rock-salt crystal structure. Thus, when the positive electrode active material 100 and a positive electrode including the positive electrode active material 100 are analyzed by Raman spectroscopy, a cubic crystal structure such as a rock-salt crystal structure is preferably observed in addition to a layered rock-salt crystal structure. In a STEM image and a nanobeam electron diffraction pattern described later, a bright spot cannot be detected when cobalt that is substituted at a lithium site, cobalt that is present at a site coordinated to four oxygen atoms, or the like does not appear with a certain frequency in the depth direction in observation. Meanwhile, Raman spectroscopy observes a vibrational mode of a bond such as a Co—O bond, so that even when the number of Co—O bonds is small, a peak of a wave number of a vibrational mode corresponding to the Co—O bond can be observed in some cases. Furthermore, since Raman spectroscopy can measure a range with a several square micrometers and a depth of approximately 1 μm of a surface portion, a Co—O bond only at the surface of a particle can be observed with high sensitivity.

For example, when the laser wavelength is 532 nm, peaks (vibrational modes: E_{g} and A_{1g}) of LiCoO₂ having a layered rock-salt crystal structure are observed in ranges from 470 cm⁻¹ to 490 cm⁻¹ and from 580 cm⁻¹ to 600 cm⁻¹. Meanwhile, a peak (vibrational mode: A_{1g}) of cubic CoOₓ (0<x<1) (Co_{1-y}O having a rock-salt crystal structure (0<y<1) or Co₃O₄ having a spinel crystal structure) is observed in a range from 665 cm⁻¹ to 685 cm⁻¹.

Accordingly, given that the integrated intensities of the peaks in the range from 470 cm⁻¹ to 490 cm⁻¹, in the range from 580 cm⁻¹ to 600 cm⁻¹, and in the range from 665 cm⁻¹ to 685 cm⁻¹ are represented by I1, I2, and I3, respectively, the value of I3/I2 is preferably greater than or equal to 1% and less than or equal to 10%, further preferably greater than or equal to 3% and less than or equal to 9%.

When a cubic crystal structure such as a rock-salt crystal structure is observed in the above-described range, it can be said that an appropriate range of the surface portion 100a of the positive electrode active material 100 has a rock-salt crystal structure.

### <Nanobeam Electron Diffraction Pattern>

As in Raman spectroscopy, features of both a layered rock-salt crystal structure and a rock-salt crystal structure are preferably observed in a nanobeam electron diffraction pattern. Note that in consideration of the above-described difference in sensitivity, in a STEM image and a nanobeam electron diffraction pattern, it is preferable that the features of a rock-salt crystal structure not be too significant at the surface portion 100a, in particular, the outermost surface (e.g., a region extending to a depth of 1 nm from the surface). This is because a diffusion path of lithium can be ensured and a function of stabilizing a crystal structure can be enhanced in the case where the additive element such as magnesium is present in the lithium layer while the outermost surface has a layered rock-salt crystal structure as compared with the case where the outermost surface is covered with a rock-salt crystal structure.

Therefore, for example, when a nanobeam electron diffraction pattern of a region within 1 nm in depth from the surface and a nanobeam electron diffraction pattern of a region at a depth from 3 nm to 10 nm inclusive are obtained, a difference between lattice constants calculated from the patterns is preferably small.

For example, a difference between the lattice constants calculated from the measured portion within 1 nm in depth from the surface and the measured portion at a depth from 3 nm to 10 nm inclusive is preferably less than or equal to 0.1 (×10⁻¹ nm) for the a-axis and less than or equal to 0.1 (×10⁻¹ nm) for the c-axis. It is further preferably less than or equal to 0.03 (×10⁻¹ nm) for the a-axis and less than or equal to 0.6 (×10⁻¹ nm) for the c-axis. It is still further preferably less than or equal to 0.04 (×10⁻¹ nm) for the a-axis and less than or equal to 0.3 (×10⁻¹ nm) for the c-axis.

### <Electrolyte>

As one mode of the electrolyte, an electrolyte solution containing a solvent and an electrolyte dissolved in the solvent can be used. As the solvent of the electrolyte solution, an aprotic organic solvent is preferably used. For example, one of ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), methyl formate, methyl acetate, ethyl acetate, methyl propionate, ethyl propionate, propyl propionate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used, or two or more of these solvents can be used in an appropriate combination at an appropriate ratio.

Alternatively, the use of one or more ionic liquids (room temperature molten salts) which have features of non-flammability and non-volatility as the solvent of the electrolyte solution can prevent a power storage device from exploding, catching fire, and the like even when the power storage device internally shorts out or the internal temperature increases owing to overcharge or the like. An ionic liquid contains a cation and an anion, specifically, an organic cation and an anion. Examples of the organic cation used for the electrolyte solution include aliphatic onium cations such as a quaternary ammonium cation, a tertiary sulfonium cation, and a quaternary phosphonium cation, and aromatic cations such as an imidazolium cation and a pyridinium cation. Examples of the anion used for the electrolyte solution include a monovalent amide-based anion, a monovalent methide-based anion, a fluorosulfonate anion, a perfluoroalkylsulfonate anion, a tetrafluoroborate anion, a perfluoroalkylborate anion, a hexafluorophosphate anion, and a perfluoroalkylphosphate anion.

As the electrolyte dissolved in the above-described solvent, one of lithium salts such as LiPF₆, LiClO₄, LiASF₆, LIBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂, LiN(C₄F₉SO₂)(CF₃SO₂), LiN(C₂F₅SO₂)₂, and lithium bis(oxalate)borate (Li(C₂O₄)₂, LiBOB) can be used, or two or more of these lithium salts can be used in an appropriate combination at an appropriate ratio.

Furthermore, an additive agent such as vinylene carbonate, propane sultone (PS), tert-butylbenzene (TBB), fluoroethylene carbonate (FEC), lithium bis(oxalate)borate (LiBOB), or a dinitrile compound such as succinonitrile or adiponitrile may be added to the electrolyte solution. The concentration of such an additive agent in the solvent in which the electrolyte is dissolved is, for example, higher than or equal to 0.1 wt % and lower than or equal to 5 wt %.

Alternatively, a polymer gel electrolyte obtained in such a manner that a polymer is swelled with an electrolyte solution may be used.

When a polymer gel electrolyte is used, safety against liquid leakage and the like is improved. Moreover, a secondary battery can be thinner and more lightweight.

As a polymer that undergoes gelation, a silicone gel, an acrylic gel, an acrylonitrile gel, a polyethylene oxide-based gel, a polypropylene oxide-based gel, a fluorine-based polymer gel, or the like can be used. For example, a polymer having a polyalkylene oxide structure, such as polyethylene oxide (PEO); PVDF; polyacrylonitrile; and a copolymer containing any of them can be used. For example, PVDF-HFP, which is a copolymer of PVDF and hexafluoropropylene (HFP), can be used. The formed polymer may be porous.

### Example 1 of Electrolyte

For the electrolyte used as one embodiment of the present invention, a material with high lithium ion conductivity even in charging and/or discharging (charge and discharge) in a low-temperature environment (e.g., 0° C., −10° C., −20° C., preferably −30° C., further preferably −40° C., still further preferably −50° C., most preferably −60° C.) can be used.

An example of an electrolyte is described below. Note that although the electrolyte described as an example in this embodiment is an organic solvent in which a lithium salt is dissolved and can be referred to as an electrolyte solution, the electrolyte is not limited to a liquid electrolyte (an electrolyte solution) that is liquid at room temperature and can be a solid electrolyte. Alternatively, an electrolyte including both a liquid electrolyte that is liquid at room temperature and a solid electrolyte that is a solid at room temperature (such an electrolyte is referred to as a semi-solid electrolyte) can also be used.

For example, an organic solvent described in this embodiment contains ethylene carbonate (EC), ethyl methyl carbonate (EMC), and dimethyl carbonate (DMC). Given that the total content of the ethylene carbonate, the ethyl methyl carbonate, and the dimethyl carbonate is 100 vol %, an organic solvent in which the volume ratio between the ethylene carbonate, the ethyl methyl carbonate, and the dimethyl carbonate is x:y:100-x-y (where 5≤x≤35 and 0<y<65) can be used. More specifically, an organic solvent containing EC, EMC, and DMC at EC:EMC:DMC=30:35:35 (volume ratio) can be used. Note that the volume ratio may be a volume ratio of the organic solvent before mixing, and the organic solvent may be mixed at room temperature (typically 25° C.). Note that the proportions of the compounds contained in the organic solvent can be analyzed by, for example, nuclear magnetic resonance (NMR), gas chromatography (GC/MS), high performance liquid chromatography (HPLC), or the like.

EC is a cyclic carbonate and has a high dielectric constant, and thus has an effect of promoting dissociation of a lithium salt. Meanwhile, EC has high viscosity and has a high freezing point (melting point) of 38° C.: thus, it is difficult to use in a low-temperature environment when EC is used alone as the organic solvent. Accordingly, the organic solvent specifically described in one embodiment of the present invention includes not only EC but also EMC and DMC. EMC is a chain-like carbonate, has an effect of decreasing the viscosity of the electrolyte solution, and has a freezing point of −54° C. DMC is also a chain-like carbonate, has an effect of decreasing the viscosity of the electrolyte solution, and has a freezing point of −43° C. An electrolyte formed using a mixed organic solvent in a volume ratio of x:y:100-x-y (where 5≤x≤ and 0<y<65) with a total content of these three organic solvents of EC, EMC, and DMC having such physical properties of 100 vol % has a characteristic in which the freezing point is lower than or equal to −40° C.

A general electrolyte used for a lithium ion battery is solidified at approximately −20° C.; thus, it is difficult to fabricate a battery that can be charged and discharged at −40° C. Since the electrolyte described as an example in this embodiment has a freezing point lower than or equal to −40° C., a lithium ion battery that can be charged and discharged even in an extremely low-temperature environment of −40° C. can be obtained.

As the electrolyte dissolved in the solvent, a lithium salt can be used. For example, one of lithium salts such as LiPF₆, LiClO₄, LiAsF₆, LIBF₄, LiAlCl₄, LiSCN, LiBr, LiI, Li₂SO₄, Li₂B₁₀Cl₁₀, Li₂B₁₂Cl₁₂, LiCF₃SO₃, LiCAF₉SO₃, LiC(CF₃SO₂)₃, LiC(C₂F₅SO₂)₃, LiN(CF₃SO₂)₂, LiN(C₄F₉SO₂)(CF₃SO₂), LiN(C₂F₅SO₂)₂, and lithium bis(oxalate)borate (LiBOB) can be used, or two or more of these lithium salts can be used in an appropriate combination with an appropriate ratio. The electrolyte dissolved in the solvent is preferably more than or equal to 0.5 mol/L and less than or equal to 1.5 mol/L, further preferably more than or equal to 0.7 mol/L and less than or equal to 1.3 mol/L, still further preferably more than or equal to 0.8 mol/L and less than or equal to 1.2 mol/L with respect to the volume of the solvent. As a specific usage example, LiPF₆ is preferably more than or equal to 0.5 mol/L and less than or equal to 1.5 mol/L, further preferably more than or equal to 0.7 mol/L and less than or equal to 1.3 mol/L, still further preferably more than or equal to 0.8 mol/L and less than or equal to 1.2 mol/L with respect to the volume of the solvent.

Preferably, the electrolyte solution is highly purified and contains a small amount of dust particles and elements other than the constituent elements of the electrolyte solution (hereinafter also simply referred to as “impurities”). Specifically, the weight ratio of impurities to the electrolyte solution is preferably less than or equal to 1%, further preferably less than or equal to 0.1%, still further preferably less than or equal to 0.01%.

In order to form a coating film (Solid Electrolyte Interphase Film) at the interface between an electrode (active material layer) and the electrolyte solution for the purpose of improvement of the safety and the like, an additive agent such as vinylene carbonate (VC), propane sultone (PS), tert-butylbenzene (TBB), fluoroethylene carbonate (FEC), lithium bis(oxalate)borate (LiBOB), or a dinitrile compound such as succinonitrile or adiponitrile may be added to the electrolyte solution. The concentration of such an additive agent in the solvent is, for example, higher than or equal to 0.1 wt % and lower than or equal to 5 wt %.

### Example 2 of Electrolyte

The organic solvent of the electrolyte of one embodiment of the present invention preferably contains two or more selected from fluorinated cyclic carbonates and fluorinated chain carbonates. For example, the organic solvent described in this embodiment preferably contains fluoroethylene carbonate (FEC) and 3,3,3-trifluoropropionate (MTFP). The reason is as follows.

### <FEC and MTFP>

FEC, which is a cyclic carbonate, has a high dielectric constant and thus has an effect of promoting dissociation of a lithium salt when used in an organic solvent. Moreover, because of including the substituent with an electron-withdrawing property, FEC is readily bonded to a lithium ion by the Coulomb force or the like. Specifically, FEC has a lower solvation energy than ethylene carbonate (abbreviated as “EC”), which does not include a substituent with an electron-withdrawing property: thus, it can be said that FEC easily solvates a lithium ion. Furthermore, FEC is presumed to have deep HOMO: when the HOMO is deep, oxidation is less likely to occur and the oxidation resistance is increased. On the other hand, FEC has a high viscosity and is difficult to use alone as an organic solvent at temperatures below freezing. Accordingly, the organic solvent specifically described as one embodiment of the present invention contains not only FEC but also MTFP. MTFP, which is a chain carbonate, has an effect of reducing or maintaining the viscosity of the electrolyte. Needless to say, MTFP also has a lower solvation energy than methyl propionate (abbreviated as “MP”), which does not include a substituent with an electron-withdrawing property, and thus may solvate a lithium ion.

FEC and MTFP having the above-described physical properties are preferably used as a mixture at a volume ratio of x:100-x (where 5≤x≤30, preferably 10≤x≤20) when the total content of these two organic solvents is 100 vol %. MTFP and FEC are preferably mixed such that the amount of MTFP is larger than that of FEC in the organic solvent. Note that the above volume ratio may be a volume ratio measured before mixing the organic solvents, and the organic solvent may be mixed at room temperature (typically 25° C.). The mixed organic solvent of FEC and MTFP is preferable because it exhibits a viscosity at which a lithium ion battery can operate and maintains an appropriate viscosity even at temperatures below freezing.

A general organic solvent used for a lithium ion battery solidifies at approximately −20° C.; thus, it is difficult to fabricate a lithium ion battery that can be charged and discharged at −40° C., preferably −50° C. Meanwhile, the organic solvent described as an example in this embodiment can have a freezing point lower than or equal to −40° C., preferably lower than or equal to −50° C., and enables a lithium ion battery to be charged and discharged even in an environment at temperatures below freezing. As a result, it is possible to obtain a lithium ion battery capable of being charged and discharged in a wide temperature range including at least temperatures below freezing.

Although FEC is described above as a typical example, it can be said that any of the organic compounds given as the fluorinated cyclic carbonate has an effect of promoting dissociation of a lithium salt, easily solvates a lithium ion owing to its low solvation energy, and is difficult to use alone at temperatures below freezing owing to its high viscosity. Although MTFP is described above as a typical example, it can be said that any of the organic compounds given as the fluorinated chain carbonate has an effect of reducing or maintaining the viscosity of the electrolyte of one embodiment of the present invention. Thus, when the organic solvent of one embodiment of the present invention contains the fluorinated cyclic carbonate and the fluorinated chain carbonate, a lithium ion battery capable of being charged and discharged in a wide temperature range including at least temperatures below freezing can be provided.

In Example 2 of electrolyte, the material described in Example 1 of electrolyte can be used for the lithium salt. Also for the additive agent, the material described in Example 1 of electrolyte can be used.

Although an example of the electrolyte that can be used for the lithium ion battery of one embodiment of the present invention is described above, the electrolyte that can be used for the lithium ion battery of one embodiment of the present invention should not be interpreted as being limited to the example. Another material can be used as long as it has high lithium ion conductivity even when charging and discharging are performed in a low-temperature environment.

The lithium ion battery of one embodiment of the present invention includes at least the above positive electrode active material and the above electrolyte, thereby achieving excellent discharge performance and/or excellent charge performance even in a low-temperature environment. More specifically, when serving as a test battery that includes at least the above positive electrode active material and the above electrolyte and uses a lithium metal for a negative electrode, the lithium ion battery can have discharge capacity at the time of performing charge and discharge at −40° C. of higher than or equal to 70% of the discharge capacity of the test battery at the time of performing charge and discharge at 20° C. The above discharge can be performed under the condition of, for example, a current rate being 0.1 C (note that 1 C=200 mA/g). In this specification and the like, when the discharge capacity at T° C. (T is given temperature (° C.)) can be higher than or equal to 50% of the discharge capacity in an environment of 20° C., it can be said that the lithium ion battery can operate at T° C.

The contents of this embodiment can be freely combined with the contents of the other embodiments.

### Embodiment 2

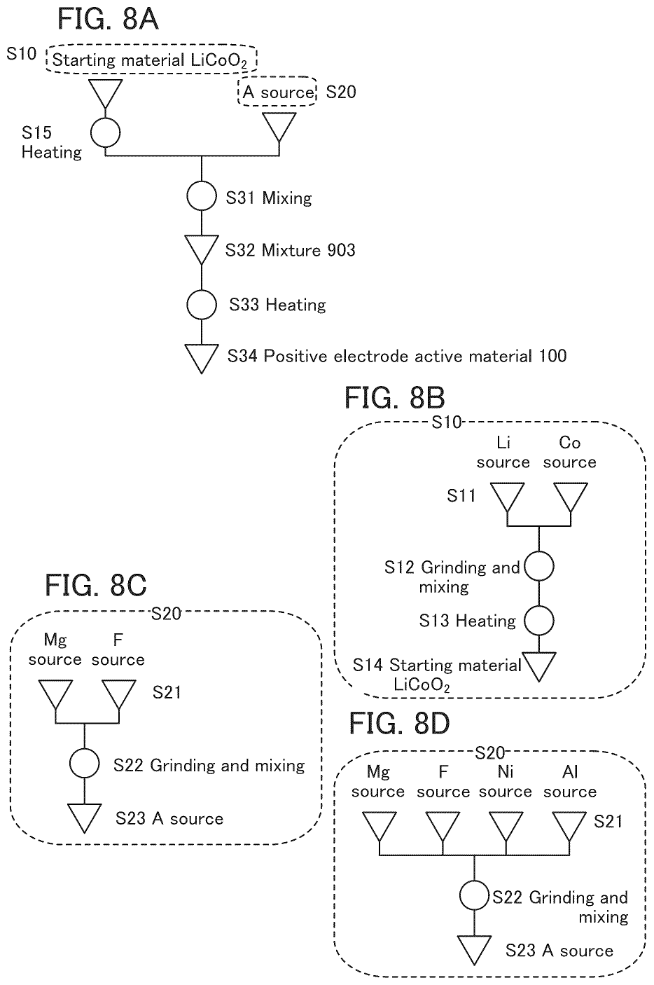

In this embodiment, a method for forming a positive electrode active material applicable to a lithium ion battery having excellent discharge performance even in a low-temperature environment will be described with reference to FIG. 8 to FIG. 10.

### Example 1 of Method for Forming Positive Electrode Active Material

An example of a method for forming the positive electrode active material that can be used as one embodiment of the present invention (Example 1 of method for forming positive electrode active material) will be described with reference to FIG. 8A to FIG. 8D. Note that in <Example 1 of method for forming positive electrode active material>, the additive elements described as the additive element X, the additive element Y, and the additive element Z in Embodiment 1 are collectively referred to as the additive element A.

First, lithium cobalt oxide is prepared as a starting material in Step S10. The particle diameter (strictly, median diameter (D50)) of the lithium cobalt oxide that is a starting material can be less than or equal to 10 μm (preferably less than or equal to 8 μm). Lithium cobalt oxide with a median diameter (D50) of less than or equal to 10 μm may be known or publicly usable (in short, commercially available) lithium cobalt oxide or lithium cobalt oxide formed through Step S11 to Step S14 shown FIG. 8B. A typical example of the commercially available lithium cobalt oxide with a median diameter (D50) of less than or equal to 10 μm is lithium cobalt oxide produced by NIPPON CHEMICAL INDUSTRIAL CO., LTD. (product name: CELLSEED C-5H). The lithium cobalt oxide produced by NIPPON CHEMICAL INDUSTRIAL CO., LTD. (product name: CELLSEED C-5H) has a median diameter (D50) of approximately 7 μm. A method for forming lithium cobalt oxide with a median diameter (D50) of less than or equal to 10 μm through Step S11 to Step S14 is described below:

### <Step S11>

In Step S11 shown in FIG. 8B, a lithium source (Li source) and a cobalt source (Co source) are prepared as materials for lithium and a transition metal that are starting materials.

As the lithium source, a lithium-containing compound is preferably used and for example, lithium carbonate, lithium hydroxide, lithium nitrate, lithium fluoride, or the like can be used. The lithium source preferably has a high purity and is preferably a material having a purity higher than or equal to 99.99%, for example.

As the cobalt source, a cobalt-containing compound is preferably used, and for example, tricobalt tetraoxide, cobalt hydroxide, or the like can be used. The cobalt source preferably has a high purity and is preferably a material having a purity of higher than or equal to 3N (99.9%), further preferably higher than or equal to 4N (99.99%), still further preferably higher than or equal to 4N5 (99.995%), yet further preferably higher than or equal to 5N (99.999%), for example. Impurities of the positive electrode active material can be controlled by using such a high-purity material. As a result, a secondary battery with an increased capacity and increased reliability can be obtained.

Furthermore, the cobalt source preferably has high crystallinity, and preferably includes single crystal particles, for example. To evaluate the crystallinity of the transition metal source, the crystallinity can be judged by a TEM (transmission electron microscope) image, a STEM (scanning transmission electron microscope) image, a HAADF-STEM (high-angle annular dark field scanning transmission electron microscope) image, an ABF-STEM (annular bright-field scanning transmission electron microscope) image, or the like, or can be judged by X-ray diffraction (XRD), electron diffraction, neutron diffraction, or the like. Note that the above methods for evaluating crystallinity can also be employed to evaluate the crystallinity of other materials in addition to the transition metal source.

### <Step S12>

Next, in Step S12 shown in FIG. 8B, the lithium source and the cobalt source are ground and mixed to form a mixed material. The grinding and mixing can be performed by a dry method or a wet method. To obtain lithium cobalt oxide with a median diameter (D50) of less than or equal to 10 μm as a starting material, the grinding and mixing by a wet method are preferred because a material can be crushed into a smaller size. When the grinding and mixing are performed by a wet method, a solvent is prepared. As the solvent, ketone such as acetone, alcohol such as ethanol or isopropanol, ether, dioxane, acetonitrile, N-methyl-2-pyrrolidone (NMP), or the like can be used. An aprotic solvent, which is unlikely to react with lithium, is preferably used. In this embodiment, dehydrated acetone with a purity higher than or equal to 99.5% is used. It is preferable that the lithium source and the transition metal source be mixed into dehydrated acetone whose moisture content is less than or equal to 10 ppm and which has a purity of higher than or equal to 99.5% in the grinding and mixing. With the use of dehydrated acetone with the above-described purity, impurities that might be mixed can be reduced.

A ball mill, a bead mill, or the like can be used as a means for the grinding and mixing, for example. When a ball mill is used, aluminum oxide balls or zirconium oxide balls are preferably used as a grinding medium. Zirconium oxide balls are preferable because they release fewer impurities. When a ball mill, a bead mill, or the like is used, the peripheral speed is preferably higher than or equal to 100 mm/s and lower than or equal to 2000 mm/s in order to inhibit contamination from the medium.

### <Step S13>

Next, the materials mixed in the above manner are heated in Step S13 shown in FIG. 8B. The heating temperature is preferably higher than or equal to 800° C. and lower than or equal to 1100° C., further preferably higher than or equal to 900° C. and lower than or equal to 1000° C., still further preferably approximately 950° C. and lower than or equal to 1000° C. An excessively low temperature might lead to insufficient decomposition and melting of the lithium source and the transition metal source. Meanwhile, an excessively high temperature might lead to a defect due to evaporation of lithium from the lithium source and/or excessive reduction of cobalt, for example. An oxygen vacancy or the like might be induced by a change of trivalent cobalt into divalent cobalt, for example.

When the heating time is too short, lithium cobalt oxide is not synthesized, but when the heating time is too long, the productivity is lowered. Accordingly, the heating time is preferably longer than or equal to 1 hour and shorter than or equal to 100 hours, further preferably longer than or equal to 2 hours and shorter than or equal to 20 hours, still further preferably longer than or equal to 2 hours and shorter than or equal to 10 hours.

The temperature rising rate is preferably higher than or equal to 80° C./h and lower than or equal to 250° C./h, although depending on the end-point temperature of the heating. For example, in the case of heating at 1000° C. for 10 hours, the temperature raising rate is preferably 200° C./h.

The heating is preferably performed in an atmosphere with little water, such as a dry-air atmosphere, and for example, the dew point of the atmosphere is preferably lower than or equal to −50° C., further preferably lower than or equal to −80° C. In this embodiment, the heating is performed in an atmosphere with a dew point of −93° C. To reduce impurities that might enter the material, the concentrations of impurities such as CH₄, CO, CO₂, and H₂ in the heating atmosphere are each preferably lower than or equal to 5 ppb (parts per billion).

The heating atmosphere is preferably an oxygen-containing atmosphere. For example, a method in which a dry air is continuously introduced into a reaction chamber is employed. The flow rate of a dry air in this case is preferably 10 L/min. Continuously introducing oxygen into a reaction chamber to make oxygen flow therein is referred to as flowing.

In the case where the heating atmosphere is an oxygen-containing atmosphere, flowing is not necessarily performed. For example, the following method may be employed: the pressure in the reaction chamber is reduced, then the reaction chamber is filled with oxygen, and the oxygen is prevented from entering or exiting from the reaction chamber. Such a method is referred to as purging. For example, the pressure in the reaction chamber may be reduced to −970 hPa, and then the reaction chamber may be filled with oxygen until the pressure becomes 50 hPa.

Cooling after the heating can be performed by natural cooling, and the time it takes for the temperature to decrease to room temperature from a predetermined temperature is preferably longer than or equal to 10 hours and shorter than or equal to 50 hours. Note that the temperature does not necessarily need to decrease to room temperature as long as it decreases to a temperature acceptable to the next step.

The heating in this step may be performed with a rotary kiln or a roller hearth kiln. Heating with stirring can be performed in either case of a sequential rotary kiln or a batch-type rotary kiln.

A container used at the time of the heating is preferably a crucible made of aluminum oxide or a sagger made of aluminum oxide. A crucible made of aluminum oxide has a material property that hardly allows the entry of impurities. In this embodiment, a sagger made of aluminum oxide with a purity of 99.9% is used. Note that the heating is preferably performed with the crucible or the sagger covered with a lid, in which case volatilization of a material can be prevented.

After the heating, the heated material is crushed as needed and then may be made to pass through a sieve. Before collection of the heated material, the material may be moved from the crucible to a mortar. As the mortar, a mortar made of zirconium oxide or agate is suitably used. Note that heating conditions equivalent to those in Step S13 can be employed in a later-described heating step other than Step S13.

### <Step S14>

Through the above steps, lithium cobalt oxide (LiCoO₂) can be synthesized as Step S14 in FIG. 8B. The lithium cobalt oxide (LiCoO₂) in Step S14 is an oxide containing a plurality of metal elements in its structure and thus can be referred to as a composite oxide. A “composite oxide” in this specification and the like refers to an oxide containing a plurality of kinds of metal elements in its structure. Note that the lithium cobalt oxide (LiCoO₂) in Step S14 may be obtained after particle size distribution is adjusted by performing a crushing step and a classification step after Step S13.

Although the example is described in which the composite oxide is formed by a solid phase method as in Step S11 to Step S14, the composite oxide may be formed by a coprecipitation method. Alternatively, the composite oxide may be formed by a hydrothermal method.

Through Step S11 to Step S14, it is possible to obtain lithium cobalt oxide that is a starting material for a positive electrode active material applicable to a lithium ion battery having excellent discharge performance even in a low-temperature environment. Specifically, as the lithium cobalt oxide that is a starting material, lithium cobalt oxide with a median diameter of less than or equal to 10 μm can be obtained.

### <Step S15>

Next, as Step S15 shown in FIG. 8A, the lithium cobalt oxide that is a starting material is heated. The heating in Step S15 is the first heating performed on the lithium cobalt oxide and thus is sometimes referred to as initial heating in this specification and the like. The heating is performed before Step S31 described below, and thus is sometimes referred to as preheating or pretreatment.

By the initial heating, a lithium compound or the like unintentionally remaining on a surface of lithium cobalt oxide is extracted. In addition, an effect of increasing the crystallinity of the inner portion can be expected. Although the lithium source and/or the cobalt source prepared in Step S11 and the like might contain impurities, impurities in the lithium cobalt oxide that is a starting material can be reduced by the initial heating. Note that the effect of increasing the crystallinity of the inner portion is, for example, an effect of reducing distortion, a shift, or the like derived from differential shrinkage or the like of the lithium cobalt oxide formed in Step S14.

Through the initial heating, an effect of smoothing the surface of the lithium cobalt oxide is obtained. Furthermore, through the initial heating, an effect of reducing a crack, a crystal defect, or the like included in the lithium cobalt oxide is obtained. In this specification and the like, a smooth surface refers to a state of having little unevenness, being rounded as a whole, and having a rounded corner portion. A smooth surface also refers to a surface to which few foreign matters are attached. Foreign matters are deemed to cause unevenness and are preferably not attached to a surface.

For the initial heating, a lithium compound source, an additive element source, or a material functioning as a fusing agent is not necessarily separately prepared.

When the heating time in this step is too short, a sufficient effect is not obtained, but when the heating time is too long, the productivity is lowered. For example, as an appropriate range of the heating time, any of the heating conditions described for Step S13 can be selected. The heating temperature in Step S15 is preferably lower than that in Step S13 so that the crystal structure of the composite oxide is maintained. The heating time in Step S15 is preferably shorter than that in Step S13 so that the crystal structure of the composite oxide is maintained. For example, the heating is preferably performed at higher than or equal to 700° C. and lower than or equal to 1000° C. (further preferably higher than or equal to 800° C. and lower than or equal to 900° C.) for longer than or equal to 1 hour and shorter than or equal to 20 hours (further preferably longer than or equal to 1 hour and shorter than or equal to 5 hours).

The heating in Step S13 might cause a temperature difference between the surface and an inner portion of the lithium cobalt oxide. The temperature difference sometimes induces differential shrinkage. It can also be deemed that the temperature difference leads to a fluidity difference between the surface and the inner portion, thereby causing differential shrinkage. The energy involved in differential shrinkage causes a difference in internal stress in the lithium cobalt oxide. The difference in internal stress is also called distortion, and the above energy is sometimes referred to as distortion energy. The internal stress is eliminated by the initial heating in Step S15: in other words, the distortion energy is probably equalized by the initial heating in Step S15. When the distortion energy is equalized, the distortion in the lithium cobalt oxide is relieved. Accordingly, the surface of the lithium cobalt oxide becomes smooth. This is also rephrased as modification of the surface. In other words, Step S15 can reduce the differential shrinkage caused in the lithium cobalt oxide and make the surface of the composite oxide smooth.

Such differential shrinkage might cause a micro shift in the lithium cobalt oxide, such as a shift in a crystal. To reduce this shift, Step S15 is preferably performed. Performing Step S15 can distribute a shift uniformly in the composite oxide (reduce the shift in a crystal or the like which is caused in the composite oxide or align crystal grains). As a result, the surface of the composite oxide becomes smooth.

In a secondary battery including lithium cobalt oxide with a smooth surface as a positive electrode active material, deterioration by charge and discharge is suppressed and breakage in the positive electrode active material can be prevented.

Note that pre-synthesized lithium cobalt oxide with a median diameter of less than or equal to 10 μm may be used in Step S10 as described above. In this case, Step S11 to Step S13 can be omitted. When Step S15 is performed on the pre-synthesized lithium cobalt oxide, lithium cobalt oxide with a smooth surface can be obtained.

Note that Step S15 is not essential in one embodiment of the present invention: thus, an embodiment in which Step S15 is skipped is also included in one embodiment of the present invention.

### <Step S20>

Next, details of Step S20 of preparing the additive element A as an A source are described with reference to FIG. 8C and FIG. 8D.

### <Step S21>

Step S20 shown in FIG. 8C includes Step S21 to Step S23. In Step S21, the additive element A is prepared. As specific examples of the additive element A, one or more selected from magnesium, fluorine, nickel, aluminum, titanium, zirconium, vanadium, iron, manganese, chromium, niobium, arsenic, zinc, silicon, sulfur, phosphorus, and boron can be used. Alternatively, one or more selected from bromine and beryllium can be used. FIG. 8C shows an example of the case where a magnesium source (Mg source) and a fluorine source (F source) are prepared. Note that in Step S21, a lithium source may be separately prepared in addition to the additive element A.

When magnesium is selected as the additive element A, the additive element A source can be referred to as a magnesium source. As the magnesium source, magnesium fluoride (MgF₂), magnesium oxide (MgO), magnesium hydroxide (Mg(OH)₂), magnesium carbonate (MgCO₃), or the like can be used. Two or more of these magnesium sources may be used.

When fluorine is selected as the additive element A, the additive element A source can be referred to as a fluorine source. As the fluorine source, it is possible to use, for example, lithium fluoride (LiF), magnesium fluoride (MgF₂), aluminum fluoride (AlF₃), titanium fluoride (TiF₄), cobalt fluoride (CoF₂ and CoF₃), nickel fluoride (NiF₂), zirconium fluoride (ZrF₄), vanadium fluoride (VF₅), manganese fluoride, iron fluoride, chromium fluoride, niobium fluoride, zinc fluoride (ZnF₂), calcium fluoride (CaF₂), sodium fluoride (NaF), potassium fluoride (KF), barium fluoride (BaF₂), cerium fluoride (CeF₃ and CeF₄), lanthanum fluoride (LaF₃), sodium aluminum hexafluoride (Na₃AlF₆), or the like. In particular, lithium fluoride is preferable because it is easily melted in a later-described heating step owing to its relatively low melting point of 848° C.

Magnesium fluoride can be used as both the fluorine source and the magnesium source. Lithium fluoride can also be used as the lithium source. Another example of the lithium source that can be used in Step S21 is lithium carbonate.

The fluorine source may be a gas: fluorine (F₂), carbon fluoride, sulfur fluoride, oxygen fluoride (OF₂, O₂F₂, O₃F₂, O₄F₂, O₅F₂, O₆F₂, and O₂F), or the like may be used and mixed in the atmosphere in the later-described heating step. Two or more of fluorine sources may be used.

In this embodiment, lithium fluoride (LiF) is prepared as the fluorine source, and magnesium fluoride (MgF₂) is prepared as the fluorine source and the magnesium source. When lithium fluoride and magnesium fluoride are mixed such that LiF:MgF₂ is approximately 65:35 (molar ratio), the effect of lowering the melting point is maximized. When the proportion of lithium fluoride is too high, cycle performance might deteriorate because of an excessive amount of lithium. Therefore, the molar ratio of lithium fluoride to magnesium fluoride is preferably LiF:MgF₂=x:1 (0≤x≤1.9), further preferably LiF:MgF₂=x:1 (0.1≤x≤0.5), still further preferably LiF:MgF₂=x:1 (x=0.33 or an approximate value thereof). Note that in this specification and the like, the expression “a given value or an approximate value thereof” means greater than 0.9 times and less than 1.1 times the given value, unless otherwise specified.

### <Step S22>

Next, in Step S22 shown in FIG. 8C, the magnesium source and the fluorine source are ground and mixed. Any of the conditions for grinding and mixing that are described for Step S12 can be selected to perform this step.

### <Step S23>

Subsequently, in Step S23 shown in FIG. 8C, the materials ground and mixed in the above step are collected to give the additive element A source (A source). Note that the additive element A source in Step S23 contains a plurality of starting materials and can be referred to as a mixture.

As for the particle diameter of the mixture, the median diameter (D50) is preferably greater than or equal to 100 nm and less than or equal to 10 μm, further preferably greater than or equal to 300 nm and less than or equal to 5 μm. Also when one kind of material is used as the additive element A source, the median diameter (D50) is preferably greater than or equal to 100 nm and less than or equal to 10 μm, further preferably greater than or equal to 300 nm and less than or equal to 5 μm.

A mixture pulverized in Step S22 (which may contain only one kind of the additive element) is easily attached to the surface of lithium cobalt oxide uniformly when mixed with the lithium cobalt oxide in a later step. The mixture is preferably attached uniformly to the surface of the lithium cobalt oxide, in which case the additive element is easily distributed or dispersed uniformly in the surface portion 100a of the composite oxide after heating.

### <Step 21>

A process different from that in FIG. 8C is described with reference to FIG. 8D. Step S20 shown in FIG. 8D includes Step S21 to Step S23.

In Step S21 shown in FIG. 8D, four kinds of additive element A sources to be added to the lithium cobalt oxide are prepared. In other words, FIG. 8D is different from FIG. 8C in the kinds of the additive element A sources. A lithium source may be separately prepared in addition to the additive element A sources.

As the four kinds of additive element A sources, a magnesium source (Mg source), a fluorine source (F source), a nickel source (Ni source), and an aluminum source (Al source) are prepared. The magnesium source and the fluorine source can be selected from the compounds and the like described with reference to FIG. 8C. As the nickel source, nickel oxide, nickel hydroxide, or the like can be used. As the aluminum source, aluminum oxide, aluminum hydroxide, or the like can be used.

### <Step S22> and <Step S23>

Next, Step S22 and Step S23 shown in FIG. 8D are similar to Step S22 and Step S23 shown in FIG. 8C.

### <Step S31>

Next, in Step S31 shown in FIG. 8A, the lithium cobalt oxide that has been subjected to Step S15 (initial heating) and the additive element A source (A source) are mixed. Here, the atomic ratio of cobalt Co in the lithium cobalt oxide that has been subjected to Step S15 to magnesium Mg contained in the additive element A is preferably Co:Mg=100:y (0.1≤y≤6), further preferably Co:Mg=100:y (0.3≤y≤3). When the additive element A is added to the lithium cobalt oxide that has been subjected to the initial heating, the additive element A can be uniformly added. Thus, the initial heating (Step S15) is preferably performed not after the addition of the additive element A but before the addition of the additive element A.

When nickel is selected as the additive element A, the mixing in Step S31 is preferably performed such that the number of nickel atoms in the nickel source is greater than or equal to 0.05% and less than or equal to 4% of the number of cobalt atoms in the lithium cobalt oxide that has been subjected to Step S15. When aluminum is selected as the additive element A, the mixing in Step S31 is preferably performed such that the number of aluminum atoms in the aluminum source is greater than or equal to 0.05% and less than or equal to 4% of the number of cobalt atoms in the lithium cobalt oxide that has been subjected to Step S15.

The conditions of the mixing in Step S31 are preferably milder than those of the grinding and mixing in Step S12 not to damage the lithium cobalt oxide shape. For example, conditions with a smaller number of rotations or a shorter time than that of the mixing in Step S12 are preferable. Moreover, a dry method is regarded as a milder condition than a wet method. For example, a ball mill or a bead mill can be used for the mixing. When a ball mill is used, zirconium oxide balls are preferably used as a medium, for example.

In this embodiment, the mixing is performed with a ball mill using zirconium oxide balls with a diameter of 1 mm by a dry method at 150 rpm for 1 hour. The mixing is performed in a dry room the dew point of which is higher than or equal to −100° C. and lower than or equal to −10° C.

### <Step S32>

Next, in Step S32 in FIG. 8A, the materials mixed in the above manner are collected, whereby a mixture 903 is obtained. At the time of the collection, the materials may be crushed as needed and then made to pass through a sieve.

### <Step S33>

Then, in Step S33 shown in FIG. 8A, the mixture 903 is heated. The heating in Step S33 is preferably performed at higher than or equal to 800° C. and lower than or equal to 1100° C., further preferably higher than or equal to 800° C. and lower than or equal to 950° C., still further preferably higher than or equal to 850° C. and lower than or equal to 900° C. The heating time in Step S33 is longer than or equal to 1 hour and shorter than or equal to 100 hours and is preferably longer than or equal to 1 hour and shorter than or equal to 10 hours. The lower limit of the heating temperature in Step S33 needs to be higher than or equal to the temperature at which a reaction between the lithium cobalt oxide and the additive element A source proceeds. The temperature at which the reaction proceeds is the temperature at which interdiffusion of the elements included in lithium cobalt oxide and the additive element A source occurs, and may be lower than the melting temperatures of these materials. In the case where an oxide is described as an example, solid phase diffusion occurs at the temperature of 0.757 times the melting temperature Tₘ (Tammann temperature Ta); thus, the heating temperature in Step S33 is higher than or equal to 500° C.

Note that the reaction proceeds more easily at a temperature higher than or equal to the temperature at which one or more selected from the materials contained in the mixture 903 are melted. For example, in the case where LiF and MgF₂ are included as the additive element A source, the lower limit of the heating temperature in Step S33 is preferably higher than or equal to 742° C. because the eutectic point of LiF and MgF₂ is around 742° C.

The mixture 903 obtained by mixing such that LiCoO₂:LiF:MgF₂=100:0.33:1 (molar ratio) exhibits an endothermic peak at around 830° C. in differential scanning calorimetry (DSC). Therefore, the lower limit of the heating temperature is further preferably higher than or equal to 830° C.

A higher heating temperature is preferable because it facilitates the reaction, shortens the heating time, and enables high productivity.

The upper limit of the heating temperature is lower than the decomposition temperature of the lithium cobalt oxide (1130° C.). At around the decomposition temperature, a slight amount of lithium cobalt oxide might be decomposed. Thus, the upper limit of the heating temperature is preferably lower than or equal to 1000° C., further preferably lower than or equal to 950° C., still further preferably lower than or equal to 900° C.

In addition, at the time of heating the mixture 903, the partial pressure of fluorine or a fluoride originating from the fluorine source or the like is preferably controlled to be within an appropriate range.

In the formation method described in this embodiment, some of the materials, e.g., LiF as the fluorine source, function as a fusing agent in some cases. Owing to this function, the heating temperature can be lower than the decomposition temperature of the lithium cobalt oxide, e.g., a temperature higher than or equal to 742° C. and lower than or equal to 950° C., which allows distribution of the additive element such as magnesium in the surface portion and formation of the positive electrode active material having favorable characteristics.

Since LiF in a gas phase has a specific gravity less than that of oxygen, heating might volatilize or sublimate LiF and in that case, LiF in the mixture 903 decreases. In this case, the function of a fusing agent deteriorates. Therefore, heating is preferably performed while volatilization of LiF is inhibited. Note that even when LiF is not used as the fluorine source or the like, Li at the surface of LiCoO₂ and F of the fluorine source might react to produce LiF, which might be volatilized. Thus, such inhibition of volatilization is needed also when a fluoride having a higher melting point than LiF is used.

In view of this, the mixture 903 is preferably heated in an atmosphere containing LiF, i.e., the mixture 903 is preferably heated in a state where the partial pressure of LiF in the heating furnace is high. Such heating can inhibit volatilization of LiF in the mixture 903.

The heating in this step is preferably performed such that the particles of the mixture 903 are not adhered to each other. Adhesion of the particles of the mixture 903 during the heating might decrease the area of contact with oxygen in the atmosphere and inhibit a path of diffusion of the additive element (e.g., fluorine), thereby hindering distribution of the additive elements (e.g., magnesium and fluorine) in the surface portion.

Uniform distribution of the additive element (e.g., fluorine) in the surface portion leads to a smooth positive electrode active material with little unevenness. Thus, it is preferable that the particles of the mixture 903 not be adhered to each other in order to allow the smooth surface obtained through the heating in Step S15 to be maintained or to be smoother in this step.

In the case of using a rotary kiln for the heating, the heating is preferably performed while the flow rate of an oxygen-containing atmosphere in the kiln is controlled. For example, the flow rate of an oxygen-containing atmosphere is preferably set low, or no flowing of an atmosphere is preferably performed after an atmosphere is purged first and an oxygen atmosphere is introduced into the kiln. Flowing of oxygen, which might cause evaporation of the fluorine source, is not preferable for maintaining the smoothness of the surface.

In the case of using a roller hearth kiln for the heating, the mixture 903 can be heated in an atmosphere containing LiF with the container containing the mixture 903 covered with a lid, for example.

### <Step S34>

Next, in Step S34 shown in FIG. 8A, the heated material is collected and then crushed as needed to obtain the positive electrode active material 100. Here, the collected positive electrode active material 100 is preferably made to pass through a sieve. Through the above process, the positive electrode active material 100 (composite oxide) with a median diameter of less than or equal to 12 μm (preferably less than or equal to 10.5 μm, further preferably less than or equal to 8 μm) can be formed. Note that the positive electrode active material 100 contains the additive element A.

### Example 2 of Method for Forming Positive Electrode Active Material

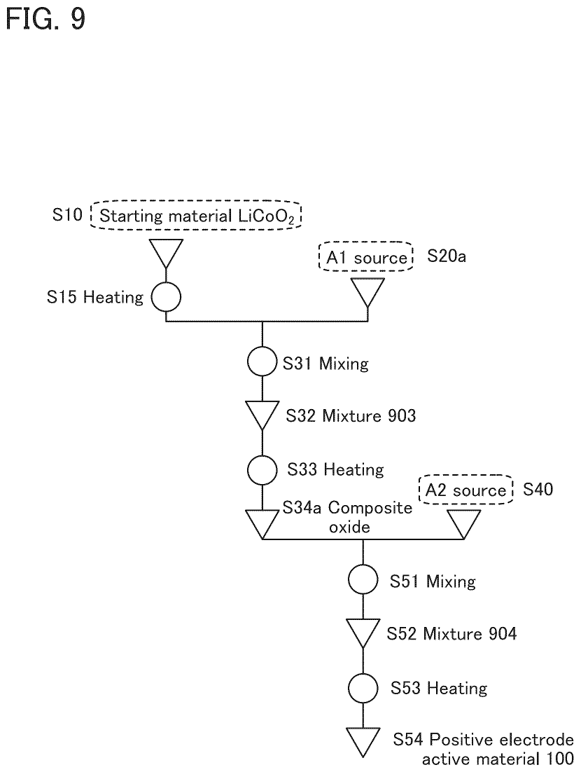

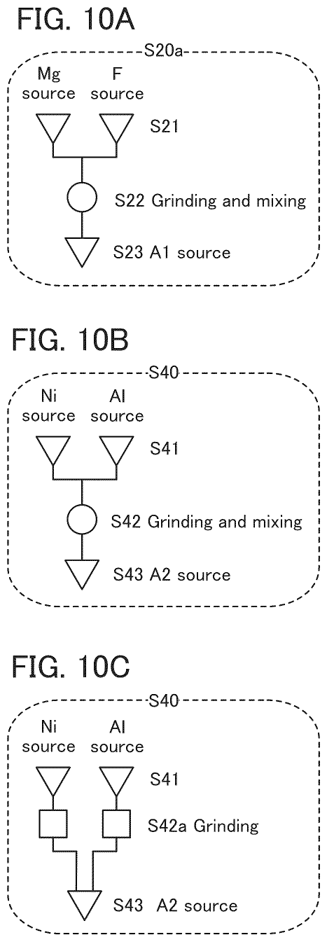

Another example of a method for forming the positive electrode active material that can be used as one embodiment of the present invention (Example 2 of method for forming positive electrode active material) will be described with reference to FIG. 9 and FIG. 10. Although Example 2 of method for forming positive electrode active material is different from Example 1 of method for forming positive electrode active material described above in the number of times of adding the additive element and a mixing method, the description of Example 1 of method for forming positive electrode active material can be referred to for the description except for the above. Note that in <Example 2 of method for forming positive electrode active material>, the additive element X described in Embodiment 1 is referred to as an additive element A1. In addition, the additive element Y and the additive element Z described in Embodiment 1 are collectively referred to as an additive element A2.

Step S10 and Step S15 in FIG. 9 are performed as in FIG. 8A to prepare lithium cobalt oxide that has been subjected to the initial heating. Note that Step S15 is not essential in one embodiment of the present invention: thus, an embodiment in which Step S15 is skipped is also included in one embodiment of the present invention.

### <Step S20a>

Next, as shown in Step S20a, a first additive element A1 source (A1 source) is prepared. Step S20a is described in detail with reference to FIG. 10A.

### <Step S21>

In Step S21 shown in FIG. 10A, the first additive element A1 source (A1 source) is prepared. The A1 source can be selected from the additive elements A described for Step S21 shown in FIG. 8C. For example, one or more selected from magnesium, fluorine, and calcium can be used as the additive element A1. FIG. 10A shows an example of the case where a magnesium source (Mg source) and a fluorine source (F source) are used as the additive element A1.

Step S21 to Step S23 shown in FIG. 10A can be performed under the same conditions as those in Step S21 to Step S23 shown in FIG. 8C. As a result, the additive element A1 source (A1 source) can be obtained in Step S23.

Steps S31 to S33 shown in FIG. 9 can be performed under the same conditions as those in Steps S31 to S33 shown in FIG. 8A.

### <Step S34a>

Next, the material heated in Step S33 is collected to obtain lithium cobalt oxide containing the additive element A1. Here, the composite oxide is also called a second composite oxide to be distinguished from the lithium cobalt oxide that has been subjected to Step S15 (first composite oxide).

### <Step S40>

In Step S40 shown in FIG. 9, a second additive element A2 source (A2 source) is prepared. Step S40 is described with reference to FIG. 10B and FIG. 10C.

### <Step S41>

In Step S40 shown in FIG. 10B, the second additive element A2 source (A2 source) is prepared. The A2 source can be selected from the additive elements A described for Step S20 shown in FIG. 8C. For example, one or more selected from nickel, titanium, boron, zirconium, and aluminum can be suitably used as the additive element A2. FIG. 10B shows an example of the case where a nickel source (Ni source) and an aluminum source (Al source) are used as the additive element A2.

Step S41 to Step S43 shown in FIG. 10B can be performed under the same conditions as those in Step S21 to Step S23 shown in FIG. 8C. As a result, the additive element A2 source (A2 source) can be obtained in Step S43.

FIG. 10C showing Step S41 to Step S43 is a variation example of FIG. 10B. A nickel source (Ni source) and an aluminum source (A1 source) are prepared in Step S41 shown in FIG. 10C and are separately ground in Step S42a. Accordingly, a plurality of the second additive element A2 sources (A2 sources) are prepared in Step S43. As described above, Step S40 in FIG. 10C is different from Step S40 in FIG. 10B in that the additive element sources are separately ground in Step S42a.

### <Step S51 to Step S53>

Next, Step S51 to Step S53 shown in FIG. 9 can be performed under conditions similar to those of Step S31 to Step S34 shown in FIG. 8A. The heating in Step S53 is preferably performed at a lower temperature and/or in a shorter time than the heating in Step S33 shown in FIG. 9. Specifically, the heating is preferably performed at higher than or equal to 800° C. and lower than or equal to 950° C., further preferably at higher than or equal to 820° C. and lower than or equal to 870° C., still further preferably at 850° C.±10° C. The heating time is preferably longer than or equal to 0.5 hours and shorter than or equal to 8 hours, further preferably longer than or equal to 1 hour and shorter than or equal to 5 hours.

When nickel is selected as the additive element A2, the mixing in Step S51 is preferably performed such that the number of nickel atoms in the nickel source is greater than or equal to 0.05% and less than or equal to 4% of the number of cobalt atoms in the lithium cobalt oxide that has been subjected to Step S15. When aluminum is selected as the additive element A2, the mixing in Step S51 is preferably performed such that the number of aluminum atoms in the aluminum source is greater than or equal to 0.05% and less than or equal to 4% of the number of cobalt atoms in the lithium cobalt oxide that has been subjected to Step S15.

### <Step S54>

Subsequently, the heated material is collected and then crushed as needed to obtain the positive electrode active material 100 in Step S54 shown in FIG. 9. Through the above process, the positive electrode active material 100 (composite oxide) with a median diameter of less than or equal to 12 μm (preferably less than or equal to 10.5 μm, further preferably less than or equal to 8 μm) can be formed. Alternatively, the positive electrode active material 100 applicable to a lithium ion battery having excellent discharge performance even in a low-temperature environment can be formed. Note that the positive electrode active material 100 contains the additive element A1 and the additive element A2.

In the example 2 of the formation method described above, introduction of the additive element to the lithium cobalt oxide is divided into introduction of the first additive element A1 and that of the second additive element A2 as shown in FIG. 9 and FIG. 10. When the additive elements are separately introduced, the distribution of the additive elements in the depth direction can vary. For example, the first additive element can be distributed such that its concentration is higher in the surface portion than in the inner portion, and the second additive element can be distributed such that its concentration is higher in the inner portion than in the surface portion. The positive electrode active material 100 formed through the steps in FIG. 8A and FIG. 8D has an advantage of being formed at low cost since a plurality of kinds of additive element A sources are added at the same time. Meanwhile, although the formation cost of the positive electrode active material 100 formed through the steps in FIG. 9 and FIG. 10 is relatively high since a plurality of kinds of additive element A sources are added in a plurality of steps, the distribution of each of the additive elements A in the depth direction can be more accurately controlled, which is preferable.

This embodiment can be used in combination with the other embodiments.

### Embodiment 3

In this embodiment, components included in a lithium ion battery will be described.

### [Positive Electrode]

A positive electrode includes a positive electrode active material layer and a positive electrode current collector. The positive electrode active material layer includes a positive electrode active material and may further contain at least one of a conductive material and a binder. As the positive electrode active material, any of the positive electrode active materials described in Embodiment 1 can be used.

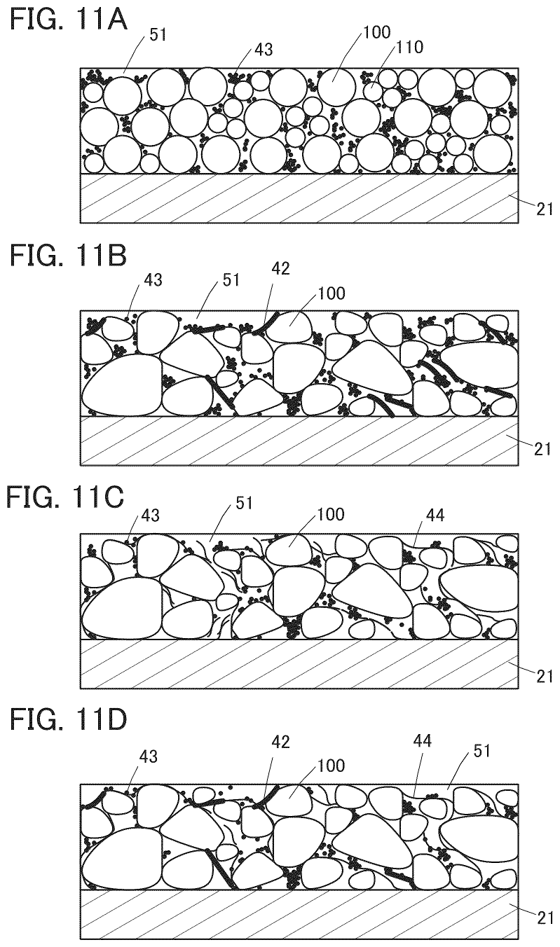

FIG. 11A shows an example of a schematic cross-sectional view of a positive electrode.

Metal foil can be used as a positive electrode current collector 21, for example. The positive electrode can be formed by applying slurry onto the metal foil and drying the slurry. Note that pressing may be performed after drying. The positive electrode is obtained by forming an active material layer over the positive electrode current collector 21.

Slurry refers to a material solution that is used to form an active material layer over the positive electrode current collector 21 and includes an active material, a binder, and a solvent, preferably also a conductive material mixed therewith. Slurry may also be referred to as slurry for an electrode or active material slurry: in some cases, slurry for forming a positive electrode active material layer is referred to as slurry for a positive electrode, and slurry for forming a negative electrode active material layer is referred to as slurry for a negative electrode.

The positive electrode active material 100 has functions of taking and releasing lithium ions in accordance with charge and discharge. For the positive electrode active material 100 used as one embodiment of the present invention, a material with little deterioration due to discharge and charge even at a high charge voltage can be used. In this specification and the like, unless otherwise specified, a charge voltage is shown with reference to the potential of lithium metal.

For the positive electrode active material 100 used as one embodiment of the present invention, any material can be used as long as it shows little deterioration due to discharge and charge even at a high charge voltage, and any of the materials described in Embodiment 1 or Embodiment 2 can be used. Note that for the positive electrode active material 100, two or more kinds of materials having different particle diameters can be used as long as the materials show little deterioration due to discharge and charge even at a high charge voltage.

FIG. 11A to FIG. 11D illustrate variation examples of the positive electrode active material layer illustrated in FIG. 1B.

FIG. 11A illustrates carbon black 43 that is an example of a conductive material and the electrolyte 51 included in a void portion positioned between the particles of the positive electrode active material 100, and shows an example in which a second positive electrode active material 110 is also included in addition to the positive electrode active material 100.

In the positive electrode of the secondary battery, a binder (a resin) may be mixed in order to fix the positive electrode current collector 21 such as metal foil and the active material. The binder is also referred to as a binding agent. Since the binder is a high molecular material, a large amount of the binder lowers the proportion of the active material in the positive electrode, thereby reducing the discharge capacity of the secondary battery. Therefore, the amount of the binder mixed is preferably reduced to a minimum.

Although FIG. 11A illustrates an example in which the positive electrode active material 100 has a spherical shape, there is no particular limitation. The cross-sectional shape of the positive electrode active material 100 may be an ellipse, a rectangle, a trapezoid, a triangle, a quadrilateral with rounded corners, or an asymmetrical shape, for example. For example, FIG. 11B illustrates an example in which the positive electrode active material 100 has a polygon shape with rounded corners.

In the positive electrode in FIG. 11B, graphene 42 is used as a carbon material used as the conductive material. In FIG. 11B, a positive electrode active material layer including the positive electrode active material 100, the graphene 42, and the carbon black 43 is formed over the positive electrode current collector 21.

In the step of mixing the graphene 42 and the carbon black 43 to obtain electrode slurry, the weight of mixed carbon black is preferably 1.5 times to 20 times, further preferably 2 times to 9.5 times the weight of graphene.

When the graphene 42 and the carbon black 43 are mixed in the above range, the carbon black 43 exhibits excellent dispersion stability and an aggregated portion is unlikely to be generated at the time of preparing slurry. Furthermore, when the graphene 42 and the carbon black 43 are mixed in the above range, the electrode density can be higher than that of a positive electrode using only the carbon black 43 as the conductive material. As the electrode density becomes higher, the capacity per unit weight can become higher. Specifically, the density of the positive electrode active material layer measured by gravimetry can be higher than or equal to 3.5 g/cc.

Although the electrode density is lower than that of a positive electrode using only graphene as the conductive material, mixing a first carbon material (graphene) and a second carbon material (acetylene black) in the above range enables a secondary battery to be fast-charged. Thus, the use of such a mixture of conductive materials for in-vehicle secondary batteries is particularly effective.

FIG. 11C illustrates an example of a positive electrode in which carbon fiber 44 is used instead of graphene. FIG. 11C shows an example different from that in FIG. 11B. With the use of the carbon fiber 44, aggregation of the carbon black 43 can be prevented and the dispersibility can be increased.

In FIG. 11C, a region not filled with the positive electrode active material 100, the carbon fiber 44, or the carbon black 43 indicates a space or the binder.

FIG. 11D illustrates another example of a positive electrode. FIG. 11C illustrates an example in which the carbon fiber 44 is used in addition to the graphene 42. With the use of both the graphene 42 and the carbon fiber 44, aggregation of carbon black such as the carbon black 43 can be prevented and the dispersibility can be further increased.

In FIG. 11D, a region not filled with the positive electrode active material 100, the carbon fiber 44, the graphene 42, or the carbon black 43 indicates a space or the binder.

The positive electrode in any one of FIG. 11A to FIG. 11D is used, and a stack in which a separator is provided over the positive electrode and a negative electrode is provided over the separator is set in a container (e.g., an exterior body or a metal can) and the container is filled with an electrolyte solution, whereby a secondary battery can be fabricated.

### <Binder>

As the binder, a rubber material such as styrene-butadiene rubber (SBR), styrene-isoprene-styrene rubber, acrylonitrile-butadiene rubber, butadiene rubber, or ethylene-propylene-diene copolymer is preferably used, for example. Fluororubber can also be used as the binder.

As the binder, for example, a water-soluble polymer is preferably used. As the water-soluble polymer, a polysaccharide can be used, for example. As the polysaccharide, a cellulose derivative such as carboxymethyl cellulose (CMC), methyl cellulose, ethyl cellulose, hydroxypropyl cellulose, diacetyl cellulose, or regenerated cellulose, starch, or the like can be used. It is further preferable that such a water-soluble polymer be used in combination with any of the above rubber materials.

Alternatively, as the binder, a material such as polystyrene, poly(methyl acrylate), poly(methyl methacry late) (PMMA), sodium polyacrylate, polyvinyl alcohol (PVA), polyethylene oxide (PEO), polypropylene oxide, polyimide, polyvinyl chloride, polytetrafluoroethylene, polyethylene, polypropylene, polyisobutylene, polyethylene terephthalate, nylon, polyvinylidene fluoride (PVDF), polyacrylonitrile (PAN), ethylene-propylene-diene polymer, polyvinyl acetate, or nitrocellulose is preferably used.

A plurality of the above-described materials may be used in combination for the binder.

For example, a material having a significant viscosity modifying effect and another material may be used in combination. For example, a rubber material or the like has high adhesion and high elasticity but may have difficulty in viscosity modification when mixed in a solvent. In such a case, a rubber material or the like is preferably mixed with a material having a significant viscosity modifying effect, for example. As a material having a significant viscosity modifying effect, for instance, a water-soluble polymer is preferably used. As a water-soluble polymer having a significant viscosity modifying effect, the above-mentioned polysaccharide, for instance, a cellulose derivative such as carboxymethyl cellulose (CMC), methyl cellulose, ethyl cellulose, hydroxypropyl cellulose, diacetyl cellulose, or regenerated cellulose, or starch can be used.

Note that a cellulose derivative such as carboxymethyl cellulose obtains a higher solubility when converted into a salt such as a sodium salt or an ammonium salt of carboxymethyl cellulose, and thus easily exerts an effect as a viscosity modifier. A high solubility can also increase the dispersibility of an active material or other components in the formation of slurry for an electrode. In this specification and the like, cellulose and a cellulose derivative used as a binder of an electrode include salts thereof.

A water-soluble polymer stabilizes the viscosity by being dissolved in water and allows stable dispersion of the active material and another material combined as a binder, such as styrene-butadiene rubber, in an aqueous solution. Furthermore, a water-soluble polymer is expected to be easily and stably adsorbed onto an active material surface because it has a functional group. Many cellulose derivatives, such as carboxymethyl cellulose, have a functional group such as a hydroxyl group or a carboxyl group. Because of functional groups, polymers are expected to interact with each other and cover an active material surface in a large area.

In the case where the binder that covers or is in contact with the active material surface forms a film, the film is expected to serve also as a passivation film to suppress the decomposition of an electrolyte solution. Here, a “passivation film” refers to a film without electric conductivity or a film with extremely low electric conductivity: for example, a passivation film formed on the active material surface can inhibit the decomposition of an electrolyte solution at a battery reaction potential. It is further desirable that the passivation film can conduct lithium ions while inhibiting electrical conduction.

### <Conductive Material>

A conductive material is also referred to as a conductivity-imparting agent or a conductive additive, and a carbon material is used. A conductive material is attached between a plurality of active materials, whereby the plurality of active materials are electrically connected to each other, and the conductivity increases. Note that the term “attach” refers not only to a state where an active material and a conductive material are physically in close contact with each other, and includes, for example, the following concepts: the case where covalent bonding occurs, the case where bonding with the Van der Waals force occurs, the case where a conductive material covers part of an active material surface, the case where a conductive material is embedded in projections and depressions of an active material surface, and the case where an active material and a conductive material are electrically connected to each other without being in contact with each other.

An active material layer such as a positive electrode active material layer or a negative electrode active material layer preferably includes a conductive material.

As the conductive material, for example, one kind or two or more kinds of carbon black such as acetylene black and furnace black, graphite such as artificial graphite and natural graphite, carbon fiber such as carbon nanofiber and carbon nanotube, and a graphene compound can be used.

As the carbon fiber, for example, carbon fiber such as mesophase pitch-based carbon fiber or isotropic pitch-based carbon fiber can be used. Carbon nanofiber, carbon nanotube, or the like can also be used as the carbon fiber. Carbon nanotube can be formed by, for example, a vapor deposition method.

A graphene compound in this specification and the like refers to graphene, multilayer graphene, multi graphene, graphene oxide, multilayer graphene oxide, multi graphene oxide, reduced graphene oxide, reduced multilayer graphene oxide, reduced multi graphene oxide, graphene quantum dots, and the like. A graphene compound contains carbon, has a plate-like shape, a sheet-like shape, or the like, and has a two-dimensional structure formed of a six-membered ring composed of carbon atoms. The two-dimensional structure formed of the six-membered ring composed of carbon atoms may be referred to as a carbon sheet. A graphene compound may include a functional group. The graphene compound is preferably curved. The graphene compound may be rounded like a carbon nanofiber.

The content of the conductive material to the total amount of the active material layer is preferably greater than or equal to 1 wt % and less than or equal to 10 wt %, further preferably greater than or equal to 1 wt % and less than or equal to 5 wt %.

Unlike a particulate conductive material such as carbon black, which makes point contact with an active material, a graphene compound is capable of making low-resistance surface contact; accordingly, the electrical conduction between the particulate active material and the graphene compound can be improved with a smaller amount of the graphene compound than that of a normal conductive material. This can increase the proportion of the active material in the active material layer. Thus, the discharge capacity of a battery can be increased.

A particulate carbon-containing compound such as carbon black or graphite and a fibrous carbon-containing compound such as carbon nanotube easily enter a microscopic space. A microscopic space means, for example, a region or the like between a plurality of active materials. When a carbon-containing compound that easily enters a microscopic space and a sheet-like carbon-containing compound, such as graphene, that can impart conductivity to a plurality of particles are used in combination, the density of the electrode is increased and an excellent conductive path can be formed. The battery obtained by the manufacturing method of one embodiment of the present invention can have high capacity density and stability, and is effective as an in-vehicle battery.

### <Positive Electrode Current Collector>

The positive electrode current collector can be formed using a material that has high conductivity, such as a metal like stainless steel, gold, platinum, aluminum, or titanium, or an alloy thereof. It is preferable that a material used for the positive electrode current collector not be eluted at the potential of the positive electrode. Alternatively, it is possible to use an aluminum alloy to which an element that improves heat resistance, such as silicon, titanium, neodymium, scandium, or molybdenum, is added. A metal element that forms silicide by reacting with silicon may be used. Examples of the metal element that forms silicide by reacting with silicon include zirconium, titanium, hafnium, vanadium, niobium, tantalum, chromium, molybdenum, tungsten, cobalt, and nickel. The current collector can have a foil-like shape, a plate-like shape, a sheet-like shape, a net-like shape, a punching-metal shape, an expanded-metal shape, or the like as appropriate. The current collector preferably has a thickness greater than or equal to 5 μm and less than or equal to 30 μm.

### [Negative Electrode]

A negative electrode includes a negative electrode active material layer and a negative electrode current collector. The negative electrode active material layer includes a negative electrode active material and may further include a conductive material and a binder.

### <Negative Electrode Active Material>

As a negative electrode active material, for example, an alloy-based material or a carbon material can be used.

As the negative electrode active material, an element that enables charge and discharge reactions by an alloying reaction and a dealloying reaction with lithium can be used. For example, a material containing at least one of silicon, tin, gallium, aluminum, germanium, lead, antimony, bismuth, silver, zinc, cadmium, indium, and the like can be used. Such elements have higher capacity than carbon. In particular, silicon has a high theoretical capacity of 4200 mAh/g. For this reason, silicon is preferably used as the negative electrode active material. Alternatively, a compound containing any of the above elements may be used. Examples of the compound include SiO, Mg₂Si, Mg₂Ge, SnO, SnO₂, Mg₂Sn, SnS₂, V₂Sn₃, FeSn₂, CoSn₂, NisSn₂, Cu₆Sn₅, Ag₃Sn, Ag₃Sb, Ni₂MnSb, CeSb₃, LaSn₃, La₃Co₂Sn₇, CoSb₃, InSb, and SbSn. Here, an element that enables charge and discharge reactions by allowing and dealloying reactions with lithium and a compound containing the element, for example, are referred to as alloy-based materials in some cases.

In this specification and the like, “SiO” refers to silicon monoxide, for example. SiO can alternatively be expressed as SiOₓ. Here, it is preferable that x be 1 or have an approximate value of 1. For example, x is preferably greater than or equal to 0.2 and less than or equal to 1.5, further preferably greater than or equal to 0.3 and less than or equal to 1.2.

As the carbon material, graphite, graphitizing carbon (soft carbon), non-graphitizing carbon (hard carbon), carbon fiber (carbon nanotube), graphene, carbon black, or the like is used.

Examples of graphite include artificial graphite and natural graphite. Examples of artificial graphite include mesocarbon microbeads (MCMB), coke-based artificial graphite, and pitch-based artificial graphite. As artificial graphite, spherical graphite having a spherical shape can be used. For example, MCMB is preferably used because it may have a spherical shape. Moreover, MCMB may preferably be used because it can relatively easily have a small surface area. Examples of natural graphite include flake graphite and spherical natural graphite.

Graphite has a low potential substantially equal to that of lithium metal (higher than or equal to 0.05 V and lower than or equal to 0.3 V vs. Li/Li⁺) when lithium ions are inserted into graphite (while a lithium-graphite intercalation compound is formed). For this reason, a lithium ion battery using graphite can have a high operating voltage. In addition, graphite is preferred because of its advantages such as relatively high capacity per unit volume, relatively small volume expansion, low cost, and a higher level of safety than that of lithium metal.

As the negative electrode active material, an oxide such as titanium dioxide (TiO₂), lithium titanium oxide (Li₄Ti₅O₁₂), a lithium-graphite intercalation compound (LiₓC₆), niobium pentoxide (Nb₂O₅), tungsten oxide (WO₂), or molybdenum oxide (MoO₂) can be used.

Alternatively, as the negative electrode active material, Li₃₋ₓMₓN (M=Co, Ni, or Cu) with a Li₃N structure, which is a composite nitride of lithium and a transition metal, can be used. For example, Li_{2.6}Co_{0.4}N₃ is preferable because of its high discharge capacity (900 mAh/g and 1890 mAh/cm³).

A composite nitride of lithium and a transition metal is preferably used, in which case lithium ions are contained in the negative electrode active material and thus the negative electrode active material can be used in combination with a positive electrode active material that does not contain lithium ions, such as V₂O₅ or Cr₃O₈. Note that in the case of using a material containing lithium ions as a positive electrode active material, the composite nitride of lithium and a transition metal can be used as the negative electrode active material by extracting the lithium ions contained in the positive electrode active material in advance.

A material that causes a conversion reaction can be used as the negative electrode active material. For example, a transition metal oxide that does not form an alloy with lithium, such as cobalt oxide (CoO), nickel oxide (NiO), or iron oxide (FeO), may be used as the negative electrode active material. Other examples of the material that causes a conversion reaction include oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorides such as FeF₃ and BiF₃.

As another mode of the negative electrode, a negative electrode that does not contain a negative electrode active material after completion of the fabrication of the battery may be used. The negative electrode that does not contain a negative electrode active material can be, for example, a negative electrode which includes only a negative electrode current collector after completion of the fabrication of the battery and in which lithium ions extracted from the positive electrode active material due to charging of the battery are deposited as a lithium metal over the negative electrode current collector and form the negative electrode active material layer. A battery including such a negative electrode is referred to as a negative electrode-free (anode-free) battery, a negative electrodeless (anodeless) battery, or the like in some cases.

In the case of using the negative electrode that does not contain a negative electrode active material, a film for making lithium deposition uniform may be provided over the negative electrode current collector. For the film for making lithium deposition uniform, for example, a solid electrolyte having lithium ion conductivity can be used. As the solid electrolyte, a sulfide-based solid electrolyte, an oxide-based solid electrolyte, a polymer-based solid electrolyte, or the like can be used. In particular, the polymer-based solid electrolyte can be uniformly formed as a film over the negative electrode current collector relatively easily, and thus is suitable for the film for making lithium deposition uniform. Moreover, as the film for making lithium deposition uniform, for example, a metal film that forms an alloy with lithium can be used. As the metal film that forms an alloy with lithium, for example, a magnesium metal film can be used. It is suitable for the film for making lithium deposition uniform because lithium and magnesium form a solid solution in a wide range of compositions.

In the case of using the negative electrode that does not contain a negative electrode active material, a negative electrode current collector having projections and depressions can be used. In the case of using the negative electrode current collector having projections and depressions, a depression of the negative electrode current collector becomes a cavity in which lithium contained in the negative electrode current collector is easily deposited, so that the lithium can be inhibited from having a dendrite-like shape when being deposited.

For the conductive material and the binder that can be included in the negative electrode active material layer, materials similar to those for the conductive material and the binder that can be included in the positive electrode active material layer can be used.

### <Negative Electrode Current Collector>

For the negative electrode current collector, copper or the like can be used in addition to a material similar to that of the positive electrode current collector. Note that a material that does not alloy with carrier ions of lithium or the like is preferably used for the negative electrode current collector.

### [Electrolyte]

As the electrolyte, any of the electrolytes described in Embodiment 1 can be used.

### [Separator]

When the electrolyte includes an electrolyte solution, a separator is positioned between the positive electrode and the negative electrode. The separator can be formed using, for example, a fiber containing cellulose, such as paper, nonwoven fabric, glass fiber, ceramics, or synthetic fiber containing nylon (polyamide), vinylon (polyvinyl alcohol-based fiber), polyester, acrylic, polyolefin, or polyurethane. The separator is preferably processed into a bag-like shape to wrap one of the positive electrode and the negative electrode.

The separator may have a multilayer structure. For example, an organic material film of polypropylene, polyethylene, or the like can be coated with a ceramic-based material, a fluorine-based material, a polyamide-based material, a mixture thereof, or the like. Examples of the ceramic-based material include aluminum oxide particles and silicon oxide particles. Examples of the fluorine-based material include PVDF and polytetrafluoroethylene. Examples of the polyamide-based material include nylon and aramid (meta-based aramid and para-based aramid).

When the separator is coated with the ceramic-based material, the oxidation resistance is improved: hence, deterioration of the separator in charge at high voltage can be inhibited and thus the reliability of the secondary battery can be increased. When the separator is coated with the fluorine-based material, the separator is easily brought into close contact with an electrode, resulting in high output characteristics. When the separator is coated with the polyamide-based material, in particular, aramid, the heat resistance is improved: thus, the safety of the secondary battery can be improved.

For example, both surfaces of a polypropylene film may be coated with a mixed material of aluminum oxide and aramid. Alternatively, a surface of a polypropylene film that is in contact with the positive electrode may be coated with a mixed material of aluminum oxide and aramid, and a surface of the polypropylene film that is in contact with the negative electrode may be coated with the fluorine-based material.

With the use of a separator having a multilayer structure, the capacity per volume of the secondary battery can be increased because the safety of the secondary battery can be maintained even when the total thickness of the separator is small.

### [Exterior Body]

For an exterior body included in the secondary battery, a metal material such as aluminum or a resin material can be used, for example. A film-like exterior body can also be used. As the film, it is possible to use, for example, a film having a three-layer structure in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided over the metal thin film as the outer surface of the exterior body.

This embodiment can be used in combination with the other embodiments.

### Embodiment 4

In this embodiment, examples of the shape of a secondary battery including the positive electrode formed by the formation method described in the above embodiment will be described.

### [Coin-Type Secondary Battery]

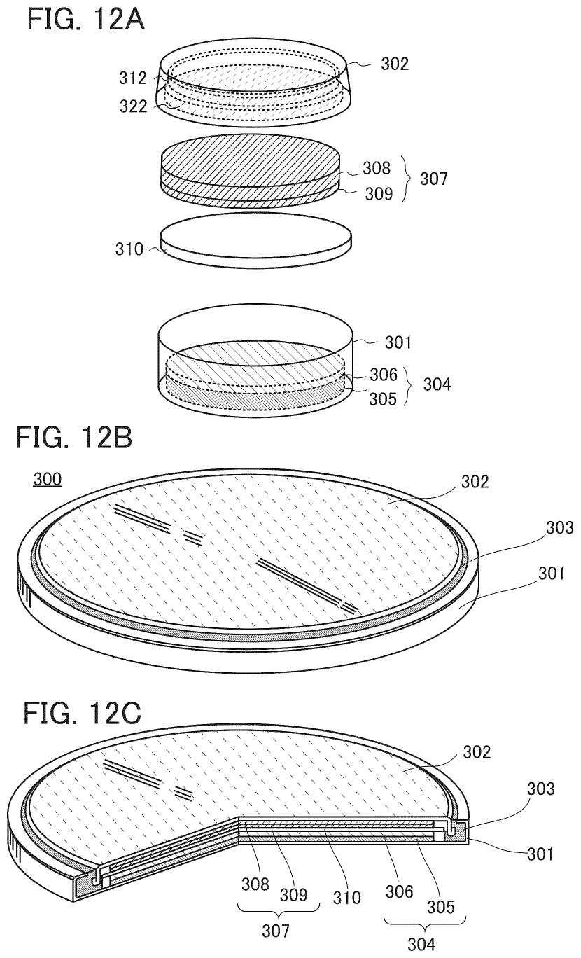

An example of a coin-type secondary battery is described. FIG. 12A is an exploded perspective view of a coin-type (single-layer flat type) secondary battery, FIG. 12B is an external view thereof, and FIG. 12C is a cross-sectional view thereof. Coin-type secondary batteries are mainly used in small electronic devices.

For easy understanding, FIG. 12A is a schematic view illustrating overlap (a vertical relation and a positional relation) between components. Thus, FIG. 12A and FIG. 12B do not completely correspond with each other.

In FIG. 12A, a positive electrode 304, a separator 310, a negative electrode 307, a spacer 322, and a washer 312 are overlaid. They are sealed with a negative electrode can 302, a positive electrode can 301, and a gasket. Note that the gasket for sealing is not illustrated in FIG. 12A. The spacer 322 and the washer 312 are used to protect the inside or fix the position inside the cans at the time when the positive electrode can 301 and the negative electrode can 302 are bonded with pressure. For the spacer 322 and the washer 312, stainless steel or an insulating material is used.

The positive electrode 304 has a stacked-layer structure in which a positive electrode active material layer 306 is formed over a positive electrode current collector 305.

FIG. 12B is a perspective view of a completed coin-type secondary battery.

In a coin-type secondary battery 300, the positive electrode can 301 doubling as a positive electrode terminal and the negative electrode can 302 doubling as a negative electrode terminal are insulated from each other and sealed by a gasket 303 made of polypropylene or the like. The positive electrode 304 includes the positive electrode current collector 305 and the positive electrode active material layer 306 provided in contact with the positive electrode current collector 305. The negative electrode 307 includes a negative electrode current collector 308 and a negative electrode active material layer 309 provided in contact with the negative electrode current collector 308. The negative electrode 307 is not limited to having a stacked-layer structure, and lithium metal foil or lithium-aluminum alloy foil may be used.

Note that only one surface of each of the positive electrode 304 and the negative electrode 307 used for the coin-type secondary battery 300 is provided with an active material layer.

For the positive electrode can 301 and the negative electrode can 302, a metal having corrosion resistance to an electrolyte solution, such as nickel, aluminum, or titanium, an alloy of such a metal, or an alloy of such a metal and another metal (e.g., stainless steel) can be used. The positive electrode can 301 and the negative electrode can 302 are preferably covered with nickel, aluminum, or the like in order to prevent corrosion due to the electrolyte solution or the like. The positive electrode can 301 and the negative electrode can 302 are electrically connected to the positive electrode 304 and the negative electrode 307, respectively.

The negative electrode 307, the positive electrode 304, and the separator 310 are immersed in the electrolyte solution. Then, as illustrated in FIG. 12C, the positive electrode 304, the separator 310, the negative electrode 307, and the negative electrode can 302 are stacked in this order with the positive electrode can 301 positioned at the bottom, and the positive electrode can 301 and the negative electrode can 302 are bonded with pressure with the gasket 303 therebetween. In this manner, the coin-type secondary battery 300 is fabricated.

With the above-described structure, the coin-type secondary battery 300 can have high discharge capacity and excellent cycle performance.

### [Cylindrical Secondary Battery]

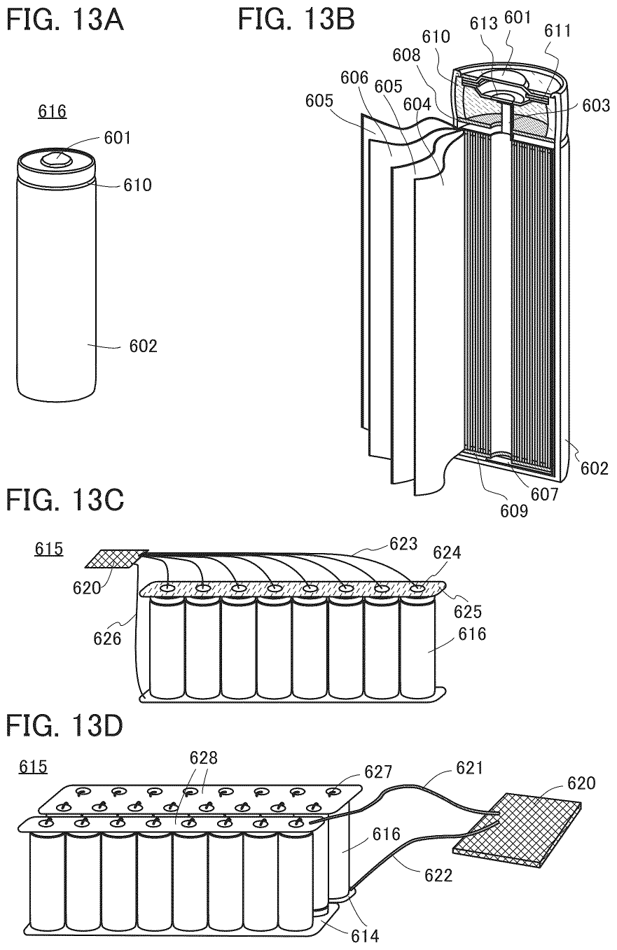

An example of a cylindrical secondary battery is described with reference to FIG. 13A. As illustrated in FIG. 13A, a cylindrical secondary battery 616 includes a positive electrode cap (battery cap) 601 on the top surface and a battery can (outer can) 602 on the side surface and bottom surface. The positive electrode cap 601 and the battery can (outer can) 602 are insulated from each other by a gasket (insulating gasket) 610.

FIG. 13B is a diagram schematically illustrating a cross section of a cylindrical secondary battery. The cylindrical secondary battery illustrated in FIG. 13B includes the positive electrode cap (battery cap) 601 on the top surface and the battery can (outer can) 602 on the side surface and bottom surface. The positive electrode cap and the battery can (outer can) 602 are insulated from each other by the gasket (insulating gasket) 610.

Inside the battery can 602 having a hollow cylindrical shape, a battery element in which a strip-like positive electrode 604 and a strip-like negative electrode 606 are wound with a separator 605 located therebetween is provided. Although not illustrated, the battery element is wound around a central axis. One end of the battery can 602 is closed and the other end thereof is opened. For the battery can 602, a metal having corrosion resistance to an electrolyte solution, such as nickel, aluminum, or titanium, an alloy of such a metal, and an alloy of such a metal and another metal (e.g., stainless steel) can be used. The battery can 602 is preferably covered with nickel, aluminum, and the like in order to prevent corrosion due to the electrolyte solution. Inside the battery can 602, the battery element in which the positive electrode, the negative electrode, and the separator are wound is provided between a pair of insulating plates 608 and 609 that face each other. Furthermore, a nonaqueous electrolyte solution (not illustrated) is injected inside the battery can 602 provided with the battery element. As the nonaqueous electrolyte solution, a nonaqueous electrolyte solution that is similar to that for the coin-type secondary battery can be used.

Since a positive electrode and a negative electrode that are used for a cylindrical storage battery are wound, active materials are preferably formed on both surfaces of a current collector.

The positive electrode active material 100 obtained in Embodiments 1, 2, and the like is used for the positive electrode 604, whereby the cylindrical secondary battery 616 can have high capacity, high discharge capacity, and excellent cycle performance.

A positive electrode terminal (positive electrode current collecting lead) 603 is connected to the positive electrode 604, and a negative electrode terminal (negative electrode current collecting lead) 607 is connected to the negative electrode 606. Both the positive electrode terminal 603 and the negative electrode terminal 607 can be formed using a metal material such as aluminum. The positive electrode terminal 603 and the negative electrode terminal 607 are resistance-welded to a safety valve mechanism 613 and the bottom of the battery can 602, respectively. The safety valve mechanism 613 is electrically connected to the positive electrode cap 601 through a PTC element (Positive Temperature Coefficient) 611. The safety valve mechanism 613 cuts off electrical connection between the positive electrode cap 601 and the positive electrode 604 when the internal pressure of the battery exceeds a predetermined threshold. The PTC element 611, which is a thermally sensitive resistor whose resistance increases as temperature rises, limits the amount of current by increasing the resistance, in order to prevent abnormal heat generation. Barium titanate (BaTiO₃)-based semiconductor ceramics or the like can be used for the PTC element.

FIG. 13C illustrates an example of a power storage system 615. The power storage system 615 includes a plurality of the secondary batteries 616. The positive electrodes of the secondary batteries are in contact with and electrically connected to conductors 624 isolated by an insulator 625. The conductors 624 are electrically connected to a control circuit 620 through wirings 623. The negative electrodes of the secondary batteries are electrically connected to the control circuit 620 through a wiring 626. As the control circuit 620, a charging and discharging control circuit for performing charging, discharging, and the like or a protection circuit for preventing overcharging and/or overdischarging can be used.

FIG. 13D illustrates an example of the power storage system 615. The power storage system 615 includes a plurality of the secondary batteries 616, and the plurality of secondary batteries 616 are sandwiched between a conductive plate 628 and a conductive plate 614. The plurality of secondary batteries 616 are electrically connected to the conductive plate 628 and the conductive plate 614 through a wiring 627. The plurality of secondary batteries 616 may be connected in parallel, connected in series, or connected in series after being connected in parallel. With the power storage system 615 including the plurality of secondary batteries 616, large electric power can be extracted.

The plurality of secondary batteries 616 may be connected in series after being connected in parallel.

A temperature control device may be provided between the plurality of secondary batteries 616. The secondary batteries 616 can be cooled with the temperature control device when overheated, whereas the secondary batteries 616 can be heated with the temperature control device when cooled too much. Thus, the performance of the power storage system 615 is less likely to be influenced by the outside temperature.

In FIG. 13D, the power storage system 615 is electrically connected to the control circuit 620 through a wiring 621 and a wiring 622. The wiring 621 is electrically connected to the positive electrodes of the plurality of secondary batteries 616 through the conductive plate 628, and the wiring 622 is electrically connected to the negative electrodes of the plurality of secondary batteries 616 through the conductive plate 614.

### [Other Structure Examples of Secondary Battery]

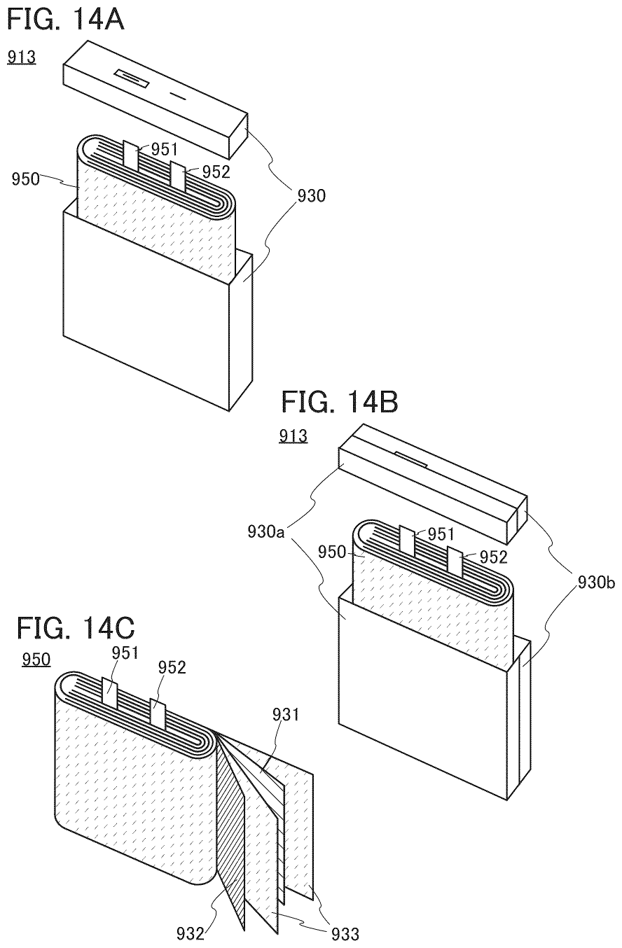

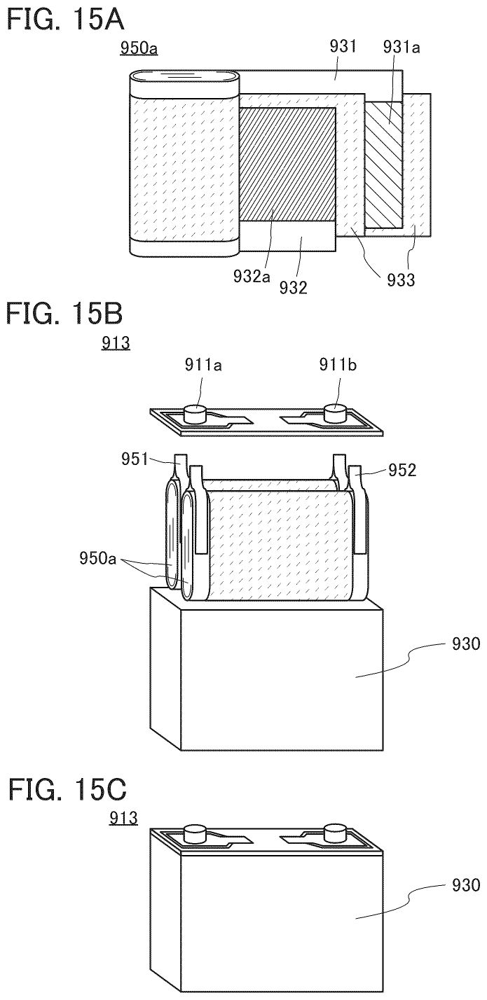

Structure examples of secondary batteries will be described with reference to FIG. 14 and FIG. 15.

A secondary battery 913 illustrated in FIG. 14A includes a wound body 950 provided with a terminal 951 and a terminal 952 inside a housing 930. The wound body 950 is immersed in an electrolyte solution inside the housing 930. The terminal 952 is in contact with the housing 930. The use of an insulator or the like inhibits contact between the terminal 951 and the housing 930. Note that in FIG. 14A, the housing 930 divided into pieces is illustrated for convenience; however, in the actual structure, the wound body 950 is covered with the housing 930, and the terminal 951 and the terminal 952 extend to the outside of the housing 930. For the housing 930, a metal material (e.g., aluminum) or a resin material can be used.

Note that as illustrated in FIG. 14B, the housing 930 illustrated in FIG. 14A may be formed using a plurality of materials. For example, in the secondary battery 913 illustrated in FIG. 14B, a housing 930a and a housing 930b are attached to each other, and the wound body 950 is provided in a region surrounded by the housing 930a and the housing 930b.

For the housing 930a, an insulating material such as an organic resin can be used. In particular, when a material such as an organic resin is used for the side on which an antenna is formed, blocking of an electric field by the secondary battery 913 can be inhibited. When an electric field is not significantly blocked by the housing 930a, an antenna may be provided inside the housing 930a. For the housing 930b, a metal material can be used, for example.

FIG. 14C illustrates the structure of the wound body 950. The wound body 950 includes a negative electrode 931, a positive electrode 932, and separators 933. The wound body 950 is obtained by winding a sheet of a stack in which the negative electrode 931 and the positive electrode 932 overlap with each other with the separator 933 therebetween. Note that a plurality of stacks each including the negative electrode 931, the positive electrode 932, and the separators 933 may be further stacked.

The secondary battery 913 may include a wound body 950a illustrated in FIG. 15. The wound body 950a illustrated in FIG. 15A includes the negative electrode 931, the positive electrode 932, and the separators 933. The negative electrode 931 includes a negative electrode active material layer 931a. The positive electrode 932 includes a positive electrode active material layer 932a.

The positive electrode active material 100 obtained in Embodiments 1, 2, and the like is used for the positive electrode 932, whereby the secondary battery 913 can have high capacity, high discharge capacity, and excellent cycle performance.

The separator 933 has a larger width than the negative electrode active material layer 931a and the positive electrode active material layer 932a, and is wound to overlap with the negative electrode active material layer 931a and the positive electrode active material layer 932a. In terms of safety, the width of the negative electrode active material layer 931a is preferably larger than that of the positive electrode active material layer 932a. The wound body 950a having such a shape is preferable because of its high level of safety and high productivity.

As illustrated in FIG. 15B, the negative electrode 931 is electrically connected to a terminal 951 by ultrasonic bonding, welding, or pressure bonding. The terminal 951 is electrically connected to a terminal 911a. The positive electrode 932 is electrically connected to a terminal 952 by ultrasonic bonding, welding, or pressure bonding. The terminal 952 is electrically connected to a terminal 911b.

As illustrated in FIG. 15C, the wound body 950a and an electrolyte solution are covered with the housing 930, whereby the secondary battery 913 is completed. The housing 930 is preferably provided with a safety valve, an overcurrent protection element, and the like. The safety valve is a valve to be released when the internal pressure of the housing 930 reaches a predetermined pressure, in order to prevent the battery from exploding.

As illustrated in FIG. 15B, the secondary battery 913 may include a plurality of the wound bodies 950a. The use of the plurality of wound bodies 950a enables the secondary battery 913 to have higher discharge capacity. The description of the secondary battery 913 illustrated in FIG. 14A to FIG. 14C can be referred to for the other components of the secondary battery 913 illustrated in FIG. 15A and FIG. 15B.

### <Laminated Secondary Battery>

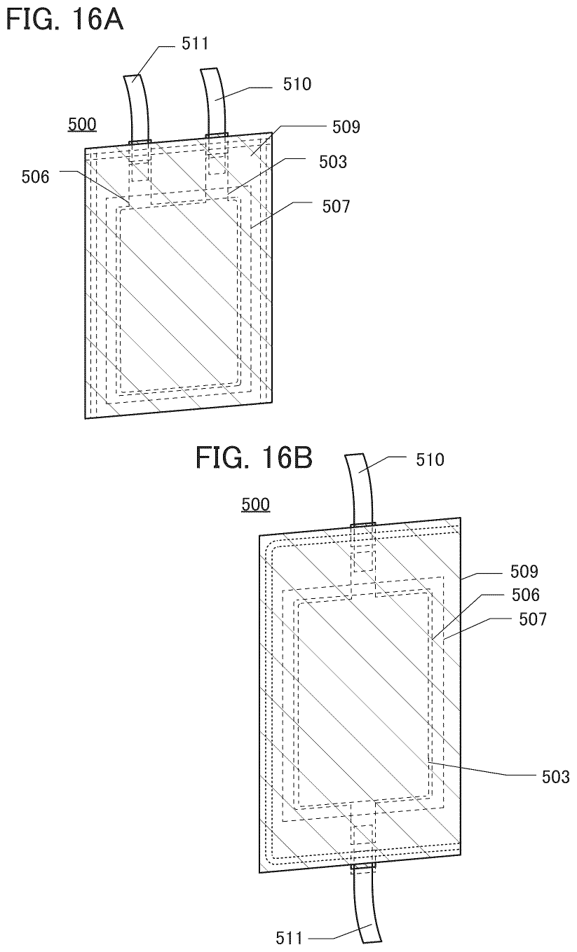

Next, examples of the appearance of a laminated secondary battery are illustrated in FIG. 16A and FIG. 16B. FIG. 16A and FIG. 16B each illustrate a positive electrode 503, a negative electrode 506, a separator 507, an exterior body 509, a positive electrode lead electrode 510, and a negative electrode lead electrode 511.

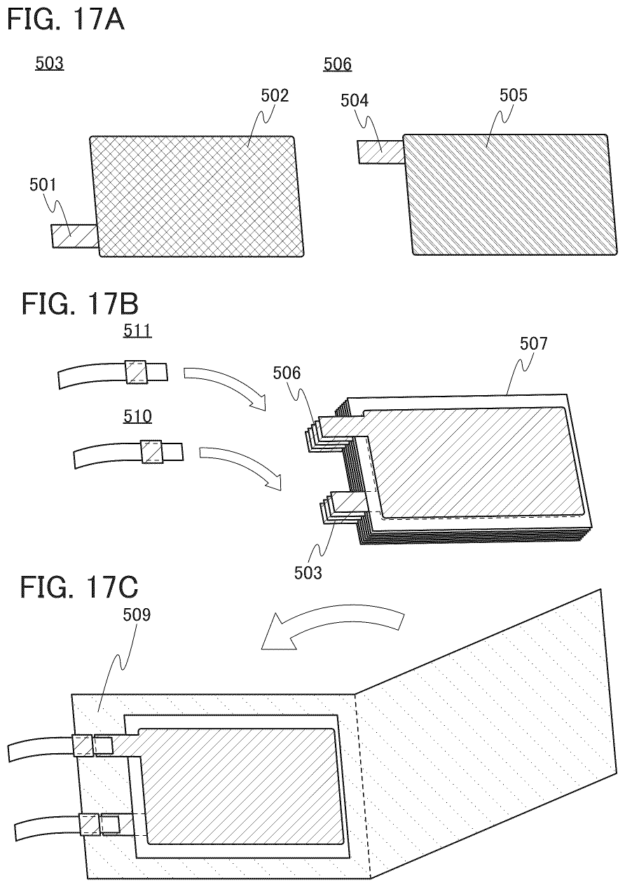

FIG. 17A illustrates the appearance of the positive electrode 503 and the negative electrode 506. The positive electrode 503 includes a positive electrode current collector 501, and a positive electrode active material layer 502 is formed on a surface of the positive electrode current collector 501. The positive electrode 503 also includes a region where the positive electrode current collector 501 is partly exposed (hereinafter referred to as a tab region). The negative electrode 506 includes a negative electrode current collector 504, and a negative electrode active material layer 505 is formed on a surface of the negative electrode current collector 504. The negative electrode 506 also includes a region where the negative electrode current collector 504 is partly exposed, that is, a tab region. Note that the areas or the shapes of the tab regions included in the positive electrode and the negative electrode are not limited to the examples shown in FIG. 17A.

### <Method for Fabricating Laminated Secondary Battery>

An example of a method for fabricating the laminated secondary battery having the appearance illustrated in FIG. 16A will be described with reference to FIG. 17B and FIG. 17C.

First, the negative electrode 506, the separator 507, and the positive electrode 503 are stacked. FIG. 17B illustrates the negative electrodes 506, the separators 507, and the positive electrodes 503 that are stacked. Here, an example in which five negative electrodes and four positive electrodes are used is shown. The component can also be referred to as a stack including the negative electrodes, the separators, and the positive electrodes. Next, the tab regions of the positive electrodes 503 are bonded to each other, and the positive electrode lead electrode 510 is bonded to the tab region of the positive electrode on the outermost surface. The bonding is performed by ultrasonic welding, for example. In a similar manner, the tab regions of the negative electrodes 506 are bonded to each other, and the negative electrode lead electrode 511 is bonded to the tab region of the negative electrode on the outermost surface.

Next, the negative electrodes 506, the separators 507, and the positive electrodes 503 are placed over the exterior body 509.

Subsequently, the exterior body 509 is folded along a portion shown by a dashed line, as illustrated in FIG. 17C. Then, the outer edges of the exterior body 509 are bonded to each other. The bonding is performed by thermocompression, for example. At this time, an unbonded region (hereinafter referred to as an inlet) is provided for part (or one side) of the exterior body 509 so that an electrolyte solution can be introduced later.

Next, the electrolyte solution is introduced into the exterior body 509 from the inlet of the exterior body 509. The electrolyte solution is preferably introduced in a reduced pressure atmosphere or in an inert atmosphere. Lastly, the inlet is sealed by bonding. In this manner, the laminated secondary battery 500 can be fabricated.

The positive electrode active material 100 obtained in Embodiments 1, 2, and the like is used for the positive electrode 503, whereby the secondary battery 500 can have high capacity, high discharge capacity, and excellent cycle performance.

### [Examples of Battery Pack]

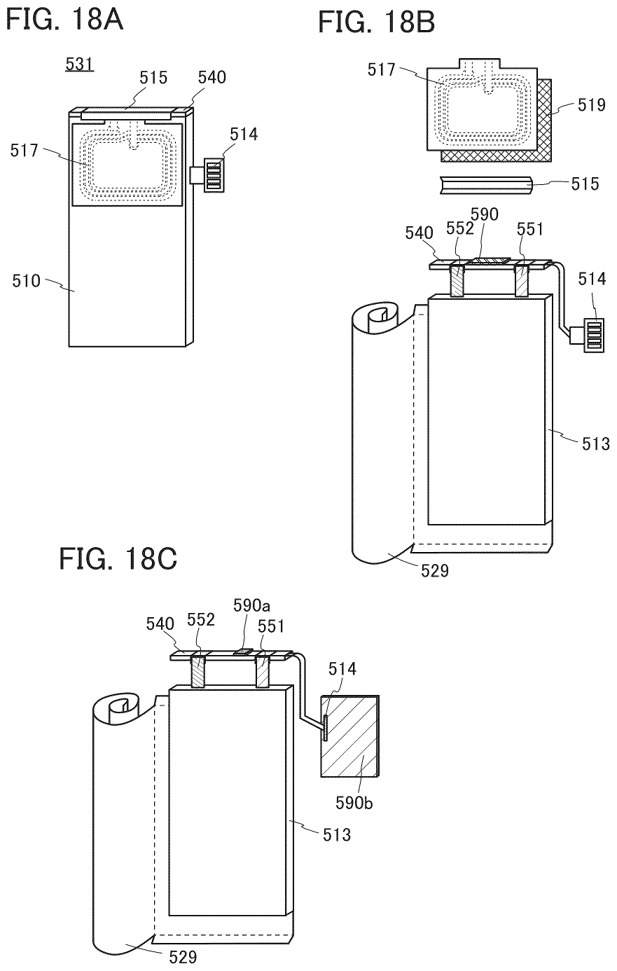

Examples of a secondary battery pack of one embodiment of the present invention that is capable of wireless charging using an antenna will be described with reference to FIG. 18.

FIG. 18A is a diagram illustrating the appearance of a secondary battery pack 531 that has a rectangular solid shape with a small thickness (also referred to as a flat plate shape with a certain thickness). FIG. 18B is a diagram illustrating a structure of the secondary battery pack 531. The secondary battery pack 531 includes a circuit board 540 and a secondary battery 513. A label 529 is attached to the secondary battery 513. The circuit board 540 is fixed by a sealant 515. The secondary battery pack 531 also includes an antenna 517.

A wound body or a stack may be included inside the secondary battery 513.

In the secondary battery pack 531, a control circuit 590 is provided over the circuit board 540 as illustrated in FIG. 18B, for example. The circuit board 540 is electrically connected to a terminal 514. The circuit board 540 is electrically connected to the antenna 517, one 551 of a positive electrode lead and a negative electrode lead of the secondary battery 513, and the other 552 of the positive electrode lead and the negative electrode lead.

Alternatively, as illustrated in FIG. 18C, a circuit system 590a provided over the circuit board 540 and a circuit system 590b electrically connected to the circuit board 540 through the terminal 514 may be included.

Note that the shape of the antenna 517 is not limited to a coil shape and may be a linear shape or a plate shape, for example. An antenna such as a planar antenna, an aperture antenna, a traveling-wave antenna, an EH antenna, a magnetic-field antenna, or a dielectric antenna may be used. Alternatively, the antenna 517 may be a flat-plate conductor. The flat-plate conductor can serve as one of conductors for electric field coupling. That is, the antenna 517 can function as one of two conductors of a capacitor. Thus, electric power can be transmitted and received not only by an electromagnetic field or a magnetic field but also by an electric field.

The secondary battery pack 531 includes a layer 519 between the antenna 517 and the secondary battery 513. The layer 519 has a function of blocking an electromagnetic field from the secondary battery 513, for example. For the layer 519, a magnetic material can be used, for example.

This embodiment can be used in combination with the other embodiments.

### Embodiment 5

In this embodiment, examples of vehicles each including the secondary battery of one embodiment of the present invention will be described.

A secondary battery can be used in vehicles, typically automobiles. Examples of automobiles include next-generation clean energy vehicles such as hybrid vehicles (HVs), electric vehicles (EVs), and plug-in hybrid vehicles (PHEVs or PHVs), and the secondary battery can be used as one of the power sources provided for the automobiles. Vehicles are not limited to automobiles. Other examples of vehicles include a train, a monorail train, a ship, a submarine (a deep-submergence vehicle and an unmanned submarine), a flying object (a helicopter, an unmanned aircraft (a drone), an airplane, a rocket, and artificial satellite), an electric bicycle, and an electric motorcycle, and the secondary battery of one embodiment of the present invention can be used for such vehicles.

An electric vehicle is provided with first batteries 1301a and 1301b as main secondary batteries for driving and a second battery 1311 that supplies electric power to an inverter 1312 for starting a motor 1304. The second battery 1311 is also referred to as a cranking battery (also referred to as a starter battery). The second battery 1311 only needs high output and high capacity is not so much needed: the capacity of the second battery 1311 is lower than that of the first batteries 1301a and 1301b.

The internal structure of the first battery 1301a may be the wound structure illustrated in FIG. 14C or FIG. 15A or the stacked-layer structure illustrated in FIG. 16A or FIG. 16B.

Although this embodiment describes an example in which the two first batteries 1301a and 1301b are connected in parallel, three or more batteries may be connected in parallel. In the case where the first battery 1301a can store sufficient electric power, the first battery 1301b may be omitted. By constituting a battery pack including a plurality of secondary batteries, large electric power can be extracted. The plurality of secondary batteries may be connected in parallel, connected in series, or connected in series after being connected in parallel. The plurality of secondary batteries are also referred to as an assembled battery.

In order to cut off electric power from the plurality of secondary batteries, the secondary batteries in the vehicle include a service plug or a circuit breaker that can cut off a high voltage without the use of equipment. The first battery 1301a is provided with such a service plug or a circuit breaker.

Electric power from the first batteries 1301a and 1301b is mainly used to rotate the motor 1304 and is supplied to in-vehicle parts for 42 V (e.g., an electric power steering 1307, a heater 1308, and a defogger 1309) through a DCDC circuit 1306. In the case where there is a rear motor 1317 for rear wheels, the first battery 1301a is used to rotate the rear motor 1317.

The second battery 1311 supplies electric power to in-vehicle parts for 14 V (e.g., a stereo 1313, a power window 1314, and lamps 1315) through a DCDC circuit 1310.

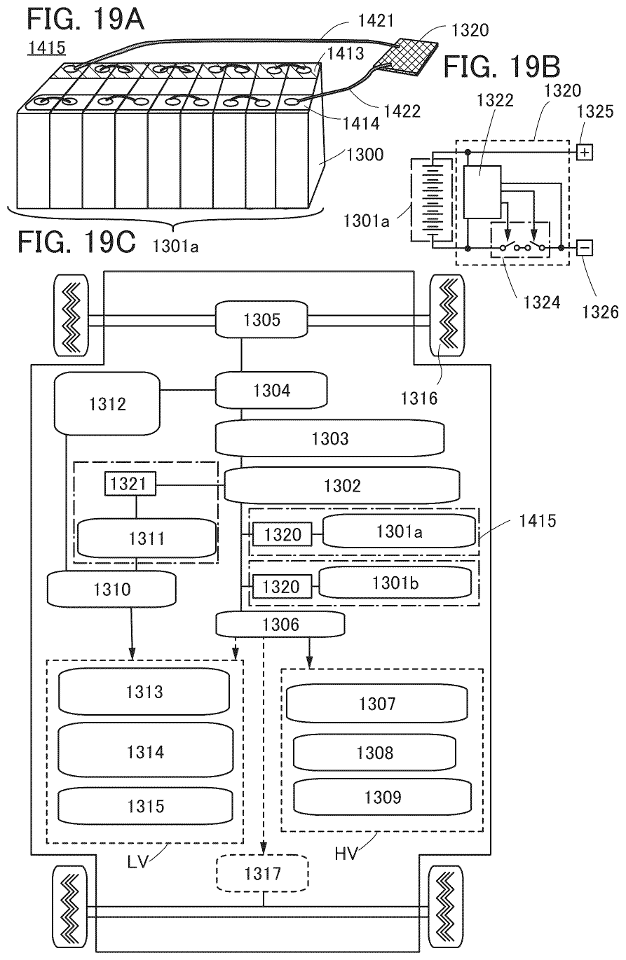

Next, the first battery 1301a is described with reference to FIG. 19A.

FIG. 19A illustrates an example in which nine rectangular secondary batteries 1300 form one battery pack 1415. The nine rectangular secondary batteries 1300 are connected in series; one electrode of each battery is fixed by a fixing portion 1413 made of an insulator, and the other electrode thereof is fixed by a fixing portion 1414 made of an insulator. Although this embodiment describes an example in which the lithium ion batteries are fixed by the fixing portions 1413 and 1414, they may be stored in a battery container box (also referred to as a housing). Since a vibration or a jolt is assumed to be given to the vehicle from the outside (e.g., a road surface), the plurality of secondary batteries are preferably fixed by the fixing portions 1413 and 1414 and a battery container box, for example. Furthermore, the one electrode is electrically connected to a control circuit portion 1320 through a wiring 1421. The other electrode is electrically connected to the control circuit portion 1320 through a wiring 1422.

The control circuit portion 1320 may include a memory circuit including a transistor using an oxide semiconductor. A charging control circuit or a battery control system that includes a memory circuit including a transistor using an oxide semiconductor is referred to as a BTOS (Battery operating system or Battery oxide semiconductor) in some cases.

A metal oxide functioning as an oxide semiconductor is preferably used. For example, as the metal oxide, a metal oxide such as an In-M-Zn oxide (the element M is one or more kinds selected from aluminum, gallium, yttrium, copper, vanadium, beryllium, boron, titanium, iron, nickel, germanium, zirconium, molybdenum, lanthanum, cerium, neodymium, hafnium, tantalum, tungsten, magnesium, and the like) is used. In particular, the In-M-Zn oxide that can be used as the metal oxide is preferably a CAAC-OS (C-Axis Aligned Crystal Oxide Semiconductor) or a CAC-OS (Cloud-Aligned Composite Oxide Semiconductor). An In—Ga oxide or an In—Zn oxide may be used as the metal oxide. The CAAC-OS is an oxide semiconductor that has a plurality of crystal regions each of which has c-axis alignment in a particular direction. Note that the particular direction refers to the film thickness direction of a CAAC-OS film, the normal direction of the surface where the CAAC-OS film is formed, or the normal direction of the surface of the CAAC-OS film. The crystal region refers to a region having a periodic atomic arrangement. Note that when an atomic arrangement is regarded as a lattice arrangement, the crystal region also refers to a region with a uniform lattice arrangement.

Note that the “CAC-OS” has a composition in which materials are separated into first regions and second regions to form a mosaic pattern, and the first regions are distributed in the film (this composition is hereinafter also referred to as a cloud-like composition). That is, the CAC-OS is a composite metal oxide having a composition in which the first regions and the second regions are mixed. Note that a clear boundary between the first region and the second region is not easily observed in some cases.

For example, energy dispersive X-ray spectroscopy (EDX) is used to obtain EDX mapping, and according to the EDX mapping, the CAC-OS in the In—Ga—Zn oxide can be found to have a structure in which the regions containing In as its main component (the first regions) and the regions containing Ga as its main component (the second regions) are unevenly distributed and mixed.

In the case where the CAC-OS is used for a transistor, a switching function (On/Off switching function) can be given to the CAC-OS owing to the complementary action of the conductivity derived from the first region and the insulating property derived from the second region. That is, the CAC-OS has a conducting function in part of the material and has an insulating function in another part of the material: as a whole, the CAC-OS has a function of a semiconductor. Separation of the conducting function and the insulating function can maximize each function. Accordingly, when the CAC-OS is used for a transistor, a high on-state current (Ion), high field-effect mobility (u), and favorable switching operation can be achieved.

Oxide semiconductors have various structures with different properties. Two or more kinds among an amorphous oxide semiconductor, a polycrystalline oxide semiconductor, an a-like OS, a CAC-OS, an nc-OS, and a CAAC-OS may be included in an oxide semiconductor of one embodiment of the present invention.

The control circuit portion 1320 preferably includes a transistor using an oxide semiconductor because it can be used in a high-temperature environment. For the process simplicity, the control circuit portion 1320 may be formed using transistors of the same conductivity type. A transistor using an oxide semiconductor in its semiconductor layer has an operating ambient temperature range of −40° C. to 150° C. inclusive, which is wider than that of a single crystal Si transistor, and thus shows a smaller change in characteristics than the single crystal Si transistor when the secondary battery is overheated. The off-state current of the transistor using an oxide semiconductor is lower than or equal to the lower measurement limit even at 150° C. independently of the temperature: meanwhile, the off-state current characteristics of the single crystal Si transistor largely depend on the temperature. For example, at 150° C., the off-state current of the single crystal Si transistor increases, and a sufficiently high current on/off ratio cannot be obtained. The control circuit portion 1320 can improve the safety. When the control circuit portion is used in combination with a secondary battery including a positive electrode using the positive electrode active material 100 obtained in Embodiments 1, 2, and the like, the synergy on safety can be obtained. The secondary battery whose positive electrode uses the positive electrode active material 100 obtained in Embodiments 1, 2, and the like and the control circuit portion 1320 can contribute greatly to elimination of accidents due to secondary batteries, such as fires.

The control circuit portion 1320 that includes a memory circuit including a transistor using an oxide semiconductor can also function as an automatic control device for the secondary battery to resolve causes of instability, such as a micro-short circuit. Examples of functions of resolving the causes of instability of a secondary battery include prevention of overcharging, prevention of overcurrent, control of overheating during charging, cell balance of an assembled battery, prevention of overdischarging, a battery indicator, automatic control of charge voltage and current amount according to temperature, control of the amount of charge current according to the degree of deterioration, abnormal behavior detection for a micro-short circuit, and anomaly prediction regarding a micro-short circuit: the control circuit portion 1320 has at least one of these functions. Furthermore, the automatic control device for the secondary battery can be extremely small in size.

A “micro-short circuit” refers to a minute short circuit caused in a secondary battery and refers not to a state where the positive electrode and the negative electrode of a secondary battery are short-circuited so that charging and discharging are impossible, but to a phenomenon in which a slight short-circuit current flows through a minute short-circuit portion. Since a large voltage change is caused even when a micro-short circuit occurs in a relatively short time in a minute area, the abnormal voltage value might adversely affect estimation to be performed subsequently.

One of the causes of a micro-short circuit is as follows: charging and discharging performed a plurality of times cause uneven distribution of positive electrode active materials, which leads to local concentration of current in part of the positive electrode and part of the negative electrode, whereby part of a separator stops functioning or a by-product is generated by a side reaction, which is thought to generate a micro short circuit.

It can be said that the control circuit portion 1320 not only detects a micro-short circuit but also senses the terminal voltage of the secondary battery and controls the charge and discharge state of the secondary battery. For example, to prevent overcharging, an output transistor of a charge circuit and an interruption switch can be turned off substantially at the same time.

FIG. 19B illustrates an example of a block diagram of the battery pack 1415 illustrated in FIG. 19A.

The control circuit portion 1320 includes a switch portion 1324 that includes at least a switch for preventing overcharging and a switch for preventing overdischarging, a control circuit 1322 for controlling the switch portion 1324, and a portion for measuring the voltage of the first battery 1301a. The control circuit portion 1320 is set to have the upper limit voltage and the lower limit voltage of the secondary battery used, and imposes the upper limit of current from the outside, the upper limit of output current to the outside, and the like. The range from the lower limit voltage to the upper limit voltage of the secondary battery falls within the recommended voltage range: when a voltage falls outside the range, the switch portion 1324 operates and functions as a protection circuit. The control circuit portion 1320 can also be referred to as a protection circuit because it controls the switch portion 1324 to prevent overdischarging and/or overcharging. For example, when the control circuit 1322 detects a voltage that is likely to cause overcharging, current is interrupted by turning off the switch in the switch portion 1324. Furthermore, a function of interrupting current in accordance with a temperature rise may be set by providing a PTC element in the charge and discharge path. The control circuit portion 1320 includes an external terminal 1325 (±IN) and an external terminal 1326 (−IN).

The switch portion 1324 can be formed by a combination of n-channel transistors or p-channel transistors. The switch portion 1324 is not limited to a switch including a Si transistor using single crystal silicon: the switch portion 1324 may be formed using, for example, a power transistor including Ge (germanium), SiGe (silicon germanium), GaAs (gallium arsenide), GaAlAs (gallium aluminum arsenide), InP (indium phosphide), SiC (silicon carbide), ZnSe (zinc selenide), GaN (gallium nitride), GaO. (gallium oxide, where x is a real number greater than 0)), or the like. A memory element using an OS transistor can be freely placed by being stacked over a circuit using a Si transistor, for example: hence, integration can be easy. Furthermore, an OS transistor can be manufactured with a manufacturing apparatus similar to that for a Si transistor and thus can be manufactured at low cost. That is, the control circuit portion 1320 using an OS transistor can be stacked over the switch portion 1324 so that they can be integrated into one chip. Since the volume occupied by the control circuit portion 1320 can be reduced, a reduction in size is possible.

The first batteries 1301a and 1301b mainly supply electric power to in-vehicle parts for 42 V (high-voltage systems HV), and the second battery 1311 supplies electric power to in-vehicle parts for 14 V (low-voltage systems LV). Lead storage batteries are usually used for the second battery 1311 due to cost advantage. Lead storage batteries have disadvantages compared with lithium ion batteries in that they have a larger amount of self-discharge and are more likely to deteriorate owing to a phenomenon called sulfation. There is an advantage that the second battery 1311 can be maintenance-free when a lithium ion battery is used: however, in the case of long-term use, for example three years or more, anomaly that is difficult to determine at the time of fabrication might occur. In particular, when the second battery 1311 that starts the inverter becomes inoperative, the motor cannot be started even when the first batteries 1301a and 1301b have remaining capacity: thus, in order to prevent this, in the case where the second battery 1311 is a lead storage battery, the second battery is supplied with electric power from the first battery to constantly maintain a fully-charged state.

In this embodiment, an example in which a lithium ion battery is used as both the first battery 1301a and the second battery 1311 is described (FIG. 19C). As the second battery 1311, a lead storage battery, an all-solid-state battery, or an electric double layer capacitor may be used.

Regenerative energy generated by rolling of tires 1316 is transmitted to the motor 1304 through a gear 1305, and is stored in the second battery 1311 from a motor controller 1303 or a battery controller 1302 through a control circuit portion 1321. Alternatively, the regenerative energy is stored in the first battery 1301a from the battery controller 1302 through the control circuit portion 1320. Alternatively, the regenerative energy is stored in the first battery 1301b from the battery controller 1302 through the control circuit portion 1320. For efficient charging with regenerative energy, the first batteries 1301a and 1301b are desirably capable of fast charging.

The battery controller 1302 can set the charge voltage, charge current, and the like of the first batteries 1301a and 1301b. The battery controller 1302 can set charge conditions in accordance with charge performance of a secondary battery used, so that fast charging can be performed.

Although not illustrated, in the case of connecting an electric vehicle to an external charger, a plug of the charger or a connection cable of the charger is electrically connected to the battery controller 1302. Electric power supplied from the external charger is stored in the first batteries 1301a and 1301b through the battery controller 1302. Some chargers are provided with a control circuit, in which case the function of the battery controller 1302 is not used: to prevent overcharging, the first batteries 1301a and 1301b are preferably charged through the control circuit portion 1320. The plug of the charger or the connection cable of the charger is sometimes provided with a control circuit. The control circuit portion 1320 is also referred to as an ECU (Electronic Control Unit). The ECU is connected to a CAN (Controller Area Network) provided in the electric vehicle. The CAN is a type of a serial communication standard used as an in-vehicle LAN. The ECU includes a microcomputer. Moreover, the ECU uses a CPU or a GPU.

External chargers installed at charging stations and the like have a 100 V outlet, a 200 V outlet, or a three-phase 200V outlet with 50 KW, for example. Furthermore, charging can be performed with electric power supplied from external charging equipment by a contactless power feeding method or the like.

For fast charging, secondary batteries that can withstand high-voltage charging have been desired to perform charging in a short time.

Moreover, it is possible to achieve a secondary battery in which graphene is used as a conductive material, an electrode layer is formed thick to increase the loading amount while suppressing a reduction in capacity, and the electrical characteristics are significantly improved in synergy with maintenance of high capacity. This secondary battery is particularly effectively used in a vehicle: it is possible to provide a vehicle that has a long cruising range, specifically one charge mileage of 500 km or greater, without increasing the proportion of the weight of the secondary battery to the weight of the entire vehicle.

Specifically, in the above secondary battery in this embodiment, using the positive electrode active material 100 described in Embodiments 1, 2, and the like can increase the operating voltage of the secondary battery, and the increase in charge voltage can increase the available capacity. Moreover, using the positive electrode active material 100 described in Embodiments 1, 2, and the like for the positive electrode can provide an automotive secondary battery having excellent cycle performance.

Next, examples in which the secondary battery of one embodiment of the present invention is mounted on a vehicle, typically a transport vehicle, will be described.

Mounting the secondary battery illustrated in any of FIG. 13D, FIG. 15C, and FIG. 19A on vehicles can achieve next-generation clean energy vehicles such as hybrid vehicles (HVs), electric vehicles (EVs), and plug-in hybrid vehicles (PHVs). The secondary battery can also be incorporated in agricultural machines, motorized bicycles including motor-assisted bicycles, motorcycles, electric wheelchairs, electric carts, boats and ships, submarines, aircraft, rockets, artificial satellites, space probes, planetary probes, or spacecraft. The secondary battery of one embodiment of the present invention can be a secondary battery with high capacity. Thus, the secondary battery of one embodiment of the present invention is suitable for reduction in size and reduction in weight and is preferably used in transport vehicles.

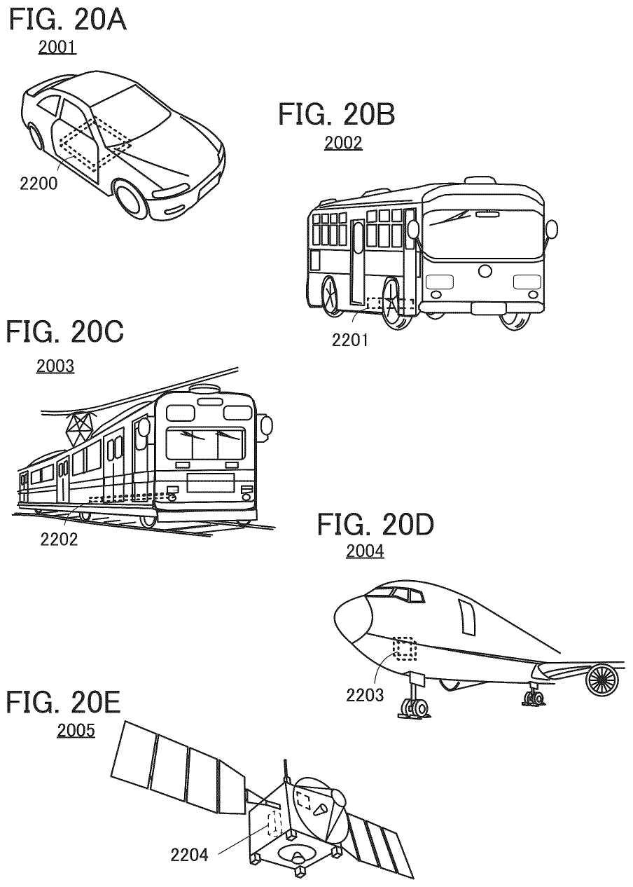

FIG. 20A to FIG. 20D illustrate examples of transport vehicles using one embodiment of the present invention. An automobile 2001 illustrated in FIG. 20A is an electric vehicle that runs using an electric motor as a driving power source. Alternatively, the automobile 2001 is a hybrid vehicle that can appropriately select an electric motor or an engine as a driving power source. In the case where the secondary battery is mounted on the vehicle, the secondary battery exemplified in Embodiment 4 is provided at one position or several positions. The automobile 2001 illustrated in FIG. 20A includes a battery pack 2200, and the battery pack includes a secondary battery module in which a plurality of secondary batteries are connected to each other. Moreover, the battery pack preferably includes a charging control device that is electrically connected to the secondary battery module.

The automobile 2001 can be charged when the secondary battery included in the automobile 2001 is supplied with electric power from external charging equipment by a plug-in system, a contactless power feeding system, or the like. In charging, a given method such as CHAdeMO (registered trademark) or Combined Charging System can be employed as a charge method, the standard of a connector, or the like as appropriate. A charge apparatus may be a charge station provided in a commerce facility or a household power source. For example, with the use of the plug-in system, the power storage device mounted on the automobile 2001 can be charged by being supplied with electric power from the outside. Charging can be performed by converting AC power into DC power through a converter such as an ACDC converter.

Although not illustrated, the vehicle may be provided with a power receiving device so that it can be charged by being supplied with electric power from an above-ground power transmitting device in a contactless manner. For the contactless power feeding system, by fitting a power transmitting device in a road or an exterior wall, charge can be performed not only when the vehicle stops but also when moves. In addition, the contactless power feeding system may be utilized to perform transmission and reception of electric power between two vehicles. Furthermore, a solar cell may be provided in the exterior of the vehicle to charge the secondary battery when the vehicle stops or moves. To supply electric power in such a contactless manner, an electromagnetic induction method or a magnetic resonance method can be used.

FIG. 20B illustrates a large transporter 2002 having a motor controlled by electricity, as an example of a transport vehicle. A secondary battery module of the transporter 2002 has a cell unit of four secondary batteries with a nominal voltage of 3.0 V or higher and 5.0 V or lower, and 48 cells are connected in series to have a maximum voltage of 170 V, for example. A battery pack 2201 has the same function as the battery pack in FIG. 20A except, for example, the number of secondary batteries configuring the secondary battery module: thus, the description is omitted.

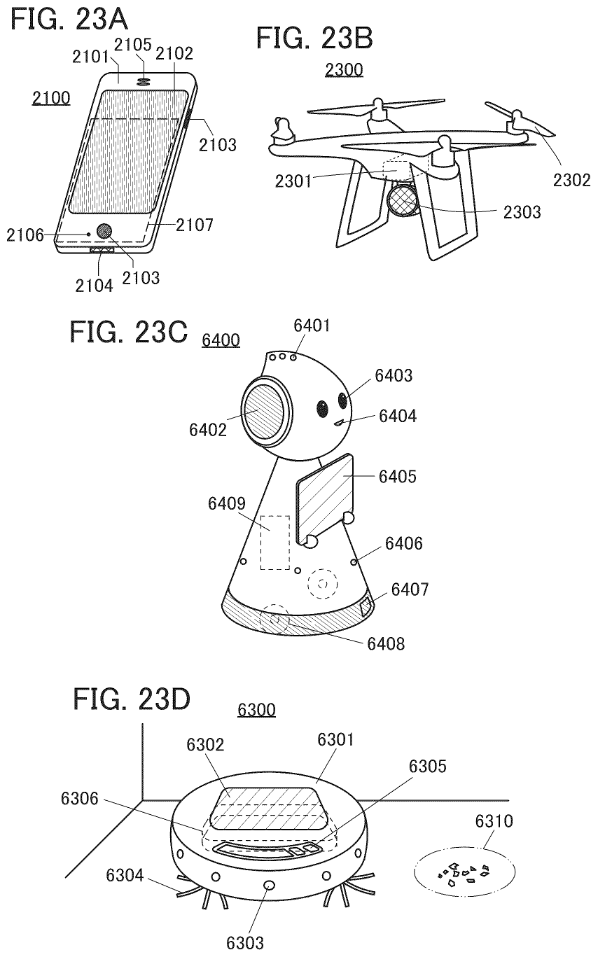

FIG. 20C illustrates a large transport vehicle 2003 having a motor controlled by electricity as an example. A secondary battery module of the transport vehicle 2003 has 100 or more secondary batteries with a nominal voltage of 3.0 V or higher and 5.0 V or lower connected in series, and has a maximum voltage of 600 V, for example. Thus, the secondary batteries are required to have a small variation in performance. By employing the positive electrode active material 100 described in Embodiments 1, 2, and the like for the positive electrode, a secondary battery having stable battery performance can be manufactured and mass production at low cost is possible in light of the yield. A battery pack 2202 has the same function as that in FIG. 23A except, for example, the number of secondary batteries configuring the secondary battery module; thus, the description is omitted.

FIG. 20D illustrates an aircraft 2004 having a combustion engine as an example. The aircraft 2004 illustrated in FIG. 20D can be regarded as a kind of transport vehicles since it is provided with wheels for takeoff and landing, and includes a battery pack 2203 that includes a charging control device and a secondary battery module configured by connecting a plurality of secondary batteries.

The secondary battery module of the aircraft 2004 has eight 4 V secondary batteries connected in series and has a maximum voltage of 32 V, for example. The battery pack 2203 has the same function as that in FIG. 20A except, for example, the number of secondary batteries configuring the secondary battery module: thus, the description is omitted.

FIG. 20E illustrates an artificial satellite 2005 including a secondary battery 2204 as an example. Because the artificial satellite 2005 is used in an ultra-low-temperature cosmic space, the secondary battery 2204 having excellent low-temperature resistance of one embodiment of the present invention is preferably provided. It is further preferable that the secondary battery 2204 be mounted inside the artificial satellite 2005 while being covered with a heat-retaining member.

This embodiment can be used in combination with the other embodiments.

### Embodiment 6

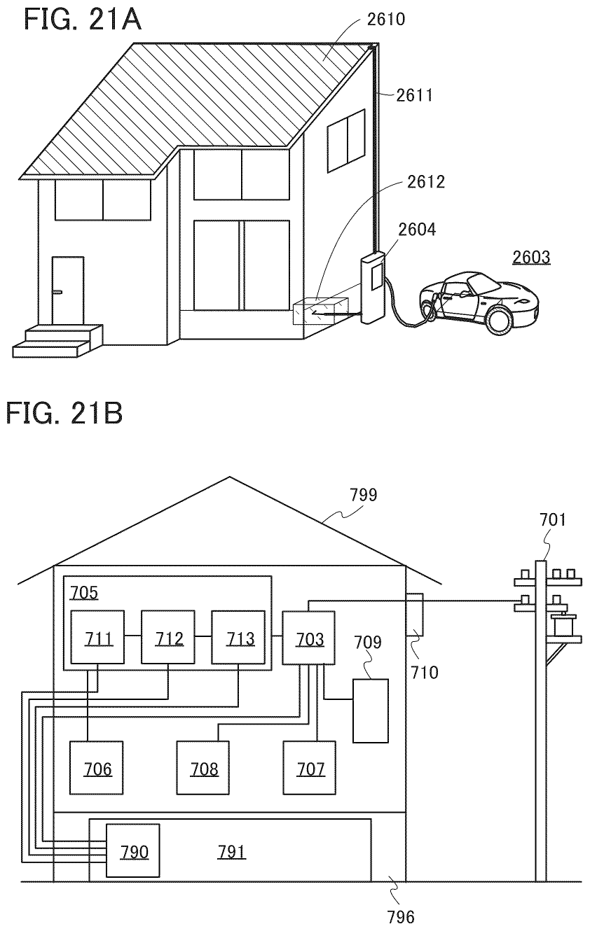

In this embodiment, examples in which the secondary battery of one embodiment of the present invention is mounted on a building will be described with reference to FIG. 21A and FIG. 21B.

A house illustrated in FIG. 21A includes a power storage device 2612 including the secondary battery of one embodiment of the present invention and a solar panel 2610. The power storage device 2612 is electrically connected to the solar panel 2610 through a wiring 2611 or the like. The power storage device 2612 may be electrically connected to ground-based charge equipment 2604. The power storage device 2612 can be charged with electric power generated by the solar panel 2610. A secondary battery included in a vehicle 2603 can be charged with the electric power stored in the power storage device 2612 through the charge equipment 2604. The power storage device 2612 is preferably provided in an underfloor space. When the power storage device 2612 is provided in the underfloor space, the space on the floor can be effectively used. Alternatively, the power storage device 2612 may be provided on the floor.

The electric power stored in the power storage device 2612 can also be supplied to other electronic devices in the house. Thus, with the use of the power storage device 2612 of one embodiment of the present invention as an uninterruptible power source, electronic devices can be used even when electric power cannot be supplied from a commercial power source owing to power failure or the like.

FIG. 21B illustrates an example of a power storage device of one embodiment of the present invention. As illustrated in FIG. 21B, a power storage device 791 of one embodiment of the present invention is provided in an underfloor space 796 of a building 799. The power storage device 791 may be provided with the control circuit described in Embodiment 5, and when a secondary battery including the positive electrode active material 100 obtained in Embodiments 1.2, and the like for a positive electrode is used for the power storage device 791, the synergy on safety can be obtained. The secondary battery including the control circuit described in Embodiment 5 and a positive electrode using the positive electrode active material 100 described in Embodiments 1, 2, and the like can contribute greatly to elimination of accidents due to the power storage device 791 including secondary batteries, such as fires.

The power storage device 791 is provided with a control device 790, and the control device 790 is electrically connected to a distribution board 703, a power storage controller 705 (also referred to as a control device), an indicator 706, and a router 709 through wirings.

Electric power is transmitted from a commercial power source 701 to the distribution board 703 through a service wire mounting portion 710. Moreover, electric power is transmitted to the distribution board 703 from the power storage device 791 and the commercial power source 701, and the distribution board 703 supplies the transmitted electric power to a general load 707 and a power storage load 708 through outlets (not illustrated).

The general load 707 is, for example, an electric device such as a TV or a personal computer. The power storage load 708 is, for example, an electric device such as a microwave oven, a refrigerator, or an air conditioner.

The power storage controller 705 includes a measuring portion 711, a predicting portion 712, and a planning portion 713. The measuring portion 711 has a function of measuring the amount of electric power consumed by the general load 707 and the power storage load 708 during a day (e.g., from midnight to midnight). The measuring portion 711 may have a function of measuring the amount of electric power of the power storage device 791 and the amount of electric power supplied from the commercial power source 701. The predicting portion 712 has a function of predicting, on the basis of the amount of electric power consumed by the general load 707 and the power storage load 708 during a given day, the demand for electric power to be consumed by the general load 707 and the power storage load 708 during the next day. The planning portion 713 has a function of making a charge and discharge plan of the power storage device 791 on the basis of the demand for electric power predicted by the predicting portion 712.

The amount of electric power consumed by the general load 707 and the power storage load 708 and measured by the measuring portion 711 can be checked with the indicator 706. It can also be checked with an electric device such as a TV or a personal computer through the router 709. Furthermore, it can be checked with a portable electronic terminal such as a smartphone or a tablet through the router 709. With the indicator 706, the electric device, or the portable electronic terminal, the demand for electric power depending on a time period (or per hour) that is predicted by the predicting portion 712 can be checked.

This embodiment can be used in combination with the other embodiments.

### Embodiment 7

In this embodiment, examples in which the lithium ion battery of one embodiment of the present invention is mounted on a motorcycle and a bicycle will be described as examples of mounting a secondary battery in a vehicle.

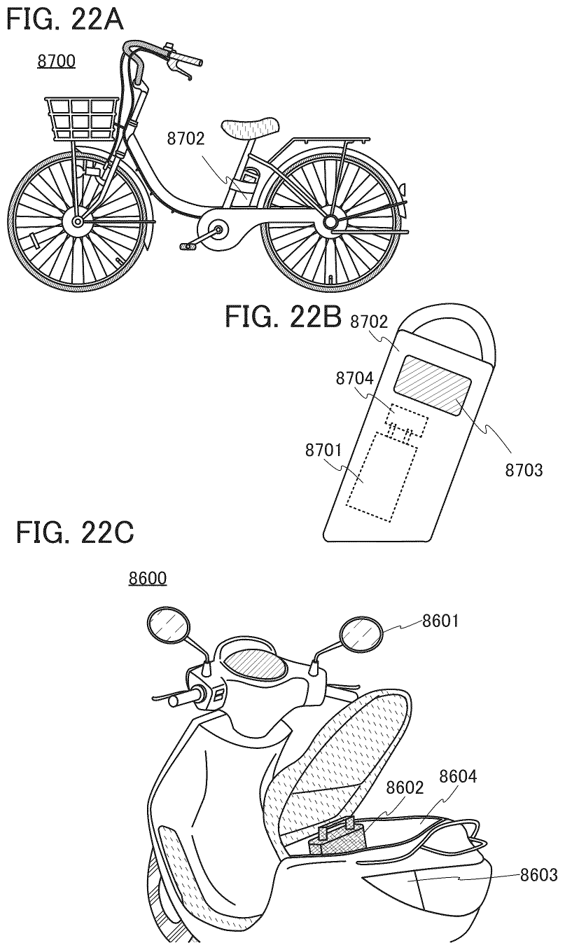

FIG. 22A illustrates an example of an electric bicycle using the power storage device of one embodiment of the present invention. The power storage device of one embodiment of the present invention can be used for an electric bicycle 8700 illustrated in FIG. 22A. The power storage device of one embodiment of the present invention includes a plurality of storage batteries and a protection circuit, for example.

The electric bicycle 8700 includes a power storage device 8702. The power storage device 8702 can supply electricity to a motor that assists a rider. The power storage device 8702 is portable, and FIG. 22B illustrates the state where the power storage device 8702 is detached from the bicycle. A plurality of storage batteries 8701 included in the power storage device of one embodiment of the present invention are incorporated in the power storage device 8702, and the remaining battery capacity and the like can be displayed on a display portion 8703. The power storage device 8702 includes a control circuit 8704 capable of charge control or anomaly detection for the secondary battery, which is exemplified in Embodiment 5. The control circuit 8704 is electrically connected to a positive electrode and a negative electrode of the storage battery 8701. When the control circuit 8704 is used in combination with a secondary battery including a positive electrode using the positive electrode active material 100 obtained in Embodiments 1, 2, and the like, the synergy on safety can be obtained. The secondary battery including a positive electrode using the positive electrode active material 100 obtained in Embodiments 1, 2, and the like and the control circuit 8704 can contribute greatly to elimination of accidents due to secondary batteries, such as fires.

FIG. 22C illustrates an example of a motorcycle using the power storage device of one embodiment of the present invention. A motor scooter 8600 illustrated in FIG. 22C includes a power storage device 8602, side mirrors 8601, and indicator lights 8603. The power storage device 8602 can supply electricity to the indicator lights 8603. The power storage device 8602 including a plurality of secondary batteries including a positive electrode using the positive electrode active material 100 obtained in Embodiments 1, 2, and the like can have high capacity and contribute to a reduction in size.

In the motor scooter 8600 illustrated in FIG. 22C, the power storage device 8602 can be stored in an under-seat storage unit 8604. The power storage device 8602 can be stored in the under-seat storage unit 8604 even when the under-seat storage unit 8604 is small.

This embodiment can be used in combination with the other embodiments.

### Embodiment 8

In this embodiment, examples of electronic devices each including the secondary battery of one embodiment of the present invention will be described. Examples of the electronic device including the secondary battery include a television device (also referred to as a television or a television receiver), a monitor of a computer and the like, a digital camera, a digital video camera, a digital photo frame, a mobile phone (also referred to as a cellular phone or a mobile phone device), a portable game machine, a portable information terminal, an audio reproducing device, and a large-sized game machine such as a pachinko machine. Examples of the portable information terminal include a laptop personal computer, a tablet terminal, an e-book reader, and a mobile phone.

FIG. 23A illustrates an example of a mobile phone. A mobile phone 2100 includes a display portion 2102 set in a housing 2101, operation buttons 2103, an external connection port 2104, a speaker 2105, a microphone 2106, and the like. The mobile phone 2100 includes a secondary battery 2107. The use of the secondary battery 2107 including a positive electrode using the positive electrode active material 100 described in Embodiments 1, 2, and the like achieves high capacity and a structure that accommodates space saving due to a reduction in size of the housing.

The mobile phone 2100 is capable of executing a variety of applications such as mobile phone calls, e-mailing, text viewing and editing, music reproduction, Internet communication, and a computer game.

With the operation buttons 2103, a variety of functions such as time setting, power on/off, on/off of wireless communication, setting and cancellation of a silent mode, and setting and cancellation of a power saving mode can be performed. For example, the functions of the operation buttons 2103 can be set freely by an operating system incorporated in the mobile phone 2100.

The mobile phone 2100 can execute near field communication conformable to a communication standard. For example, mutual communication between the mobile phone 2100 and a headset capable of wireless communication enables hands-free calling.

The mobile phone 2100 includes the external connection port 2104, and data can be directly transmitted to and received from another information terminal via a connector. In addition, charging can be performed via the external connection port 2104. Note that the charging operation may be performed by wireless power feeding without using the external connection port 2104.

The mobile phone 2100 preferably includes a sensor. As the sensor, for example, a human body sensor such as a fingerprint sensor, a pulse sensor, or a temperature sensor, a touch sensor, a pressure sensitive sensor, or an acceleration sensor is preferably mounted.

FIG. 23B illustrates an unmanned aircraft 2300 including a plurality of rotors 2302. The unmanned aircraft 2300 is sometimes also referred to as a drone. The unmanned aircraft 2300 includes a secondary battery 2301 of one embodiment of the present invention, a camera 2303, and an antenna (not illustrated). The unmanned aircraft 2300 can be remotely controlled through the antenna. A secondary battery including a positive electrode using the positive electrode active material 100 obtained in Embodiments 1, 2, and the like has high energy density and a high level of safety, and thus can be used safely for a long time over a long period of time and is preferable as the secondary battery included in the unmanned aircraft 2300.

FIG. 23C illustrates an example of a robot. A robot 6400 illustrated in FIG. 23C includes a secondary battery 6409, an illuminance sensor 6401, a microphone 6402, an upper camera 6403, a speaker 6404, a display portion 6405, a lower camera 6406, an obstacle sensor 6407, a moving mechanism 6408, an arithmetic device, and the like.

The microphone 6402 has a function of detecting a speaking voice of a user, an environmental sound, and the like. The speaker 6404 has a function of outputting sound. The robot 6400 can communicate with the user by using the microphone 6402 and the speaker 6404.

The display portion 6405 has a function of displaying various kinds of information. The robot 6400 can display information desired by the user on the display portion 6405. The display portion 6405 may be provided with a touch panel. Moreover, the display portion 6405 may be a detachable information terminal, in which case charging and data communication can be performed when the display portion 6405 is set at the home position of the robot 6400.

The upper camera 6403 and the lower camera 6406 each have a function of taking an image of the surroundings of the robot 6400. The obstacle sensor 6407 can detect the presence of an obstacle in the direction where the robot 6400 advances with the moving mechanism 6408. The robot 6400 can move safely by recognizing the surroundings with the upper camera 6403, the lower camera 6406, and the obstacle sensor 6407.

The robot 6400 includes, in its inner region, the secondary battery 6409 of one embodiment of the present invention and a semiconductor device or an electronic component. A secondary battery including a positive electrode using the positive electrode active material 100 obtained in Embodiments 1, 2, and the like has high energy density and a high level of safety, and thus can be used safely for a long time over a long period of time and is preferable as the secondary battery 6409 included in the robot 6400.

FIG. 23D illustrates an example of a cleaning robot. A cleaning robot 6300 includes a display portion 6302 placed on the top surface of a housing 6301, a plurality of cameras 6303 placed on a side surface of the housing 6301, a brush 6304, operation buttons 6305, a secondary battery 6306, a variety of sensors, and the like. Although not illustrated, the cleaning robot 6300 is provided with a tire, an inlet, and the like. The cleaning robot 6300 is self-propelled, detects dust 6310, and sucks up the dust through the inlet provided on the bottom surface.

The cleaning robot 6300 can determine whether there is an obstacle such as a wall, furniture, or a step by analyzing images taken by the cameras 6303. In the case where the cleaning robot 6300 detects an object that is likely to be caught in the brush 6304, such as a wire, by image analysis, the rotation of the brush 6304 can be stopped. The cleaning robot 6300 includes, in its inner region, the secondary battery 6306 of one embodiment of the present invention and a semiconductor device or an electronic component. A secondary battery including a positive electrode using the positive electrode active material 100 obtained in Embodiments 1, 2, and the like has high energy density and a high level of safety, and thus can be used safely for a long time over a long period of time and is preferable as the secondary battery 6306 included in the cleaning robot 6300.

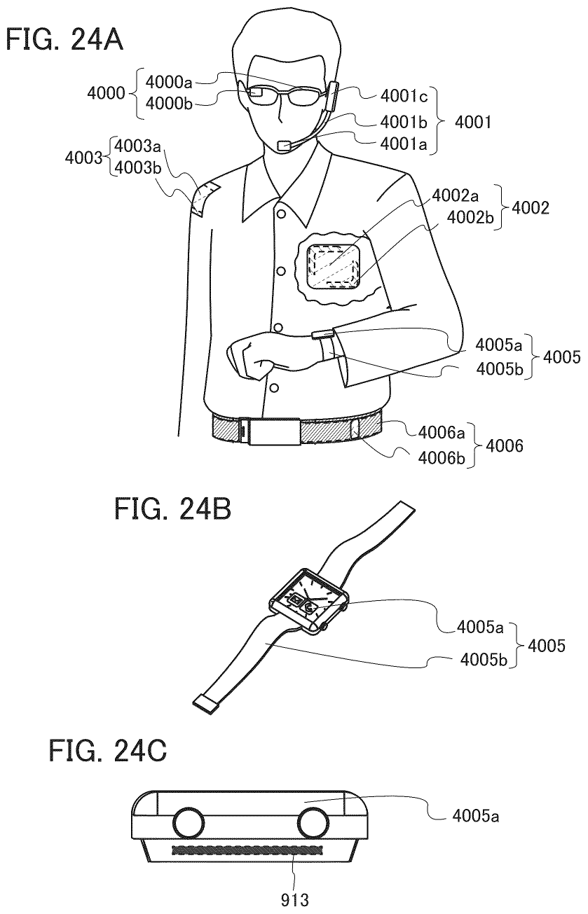

FIG. 24A illustrates examples of wearable devices. A secondary battery is used as a power source of a wearable device. To have improved splash resistance, water resistance, or dust resistance in daily use or outdoor use by a user, a wearable device is desirably capable of being charged wirelessly as well as being charged with a wire whose connector portion for connection is exposed.

For example, the secondary battery of one embodiment of the present invention can be provided in a glasses-type device 4000 illustrated in FIG. 24A. The glasses-type device 4000 includes a frame 4000a and a display portion 4000b. The secondary battery is provided in a temple portion of the frame 4000a having a curved shape, whereby the glasses-type device 4000 can be lightweight, have a well-balanced weight, and be used continuously for a long time. A secondary battery including a positive electrode using the positive electrode active material 100 obtained in Embodiments 1, 2, and the like has high energy density and achieves a structure that accommodates space saving due to a reduction in size of the housing.

The secondary battery of one embodiment of the present invention can be provided in a headset-type device 4001. The headset-type device 4001 includes at least a microphone portion 4001a, a flexible pipe 4001b, and an earphone portion 4001c. The secondary battery can be provided in the flexible pipe 4001b or the earphone portion 4001c. A secondary battery including a positive electrode using the positive electrode active material 100 obtained in Embodiments 1, 2, and the like has high energy density and achieves a structure that accommodates space saving due to a reduction in size of the housing.

The secondary battery of one embodiment of the present invention can be provided in a device 4002 that can be attached directly to a body. A secondary battery 4002b can be provided in a thin housing 4002a of the device 4002. A secondary battery including a positive electrode using the positive electrode active material 100 obtained in Embodiments 1, 2, and the like has high energy density and achieves a structure that accommodates space saving due to a reduction in size of the housing.

The secondary battery of one embodiment of the present invention can be provided in a device 4003 that can be attached to clothes. A secondary battery 4003b can be provided in a thin housing 4003a of the device 4003. A secondary battery including a positive electrode using the positive electrode active material 100 obtained in Embodiments 1, 2, and the like has high energy density and achieves a structure that accommodates space saving due to a reduction in size of the housing.

The secondary battery of one embodiment of the present invention can be provided in a belt-type device 4006. The belt-type device 4006 includes a belt portion 4006a and a wireless power feeding and receiving portion 4006b, and the secondary battery can be provided in the inner region of the belt portion 4006a. A secondary battery including a positive electrode using the positive electrode active material 100 obtained in Embodiments 1, 2, and the like has high energy density and achieves a structure that accommodates space saving due to a reduction in size of the housing.

The secondary battery of one embodiment of the present invention can be provided in a watch-type device 4005. The watch-type device 4005 includes a display portion 4005a and a belt portion 4005b, and the secondary battery can be provided in the display portion 4005a or the belt portion 4005b. A secondary battery including a positive electrode using the positive electrode active material 100 obtained in Embodiments 1, 2, and the like has high energy density and achieves a structure that accommodates space saving due to a reduction in size of the housing.

The display portion 4005a can display various kinds of information such as time and reception information of an e-mail or an incoming call.

The watch-type device 4005 is a wearable device that is wound around an arm directly; thus, a sensor that measures the pulse, the blood pressure, or the like of the user may be incorporated therein. Data on the exercise quantity and health of the user can be stored to be used for health maintenance.

FIG. 24B illustrates a perspective view of the watch-type device 4005 that is detached from an arm.

FIG. 24C illustrates a side view. FIG. 24C illustrates a state where the secondary battery 913 is incorporated in the inner region. The secondary battery 913 is the secondary battery described in Embodiment 4. The secondary battery 913 is provided at a position overlapping with the display portion 4005a, and the watch-type device 4005 can have high density and high capacity and is small and lightweight.

Since the secondary battery in the watch-type device 4005 is required to be small and lightweight, the use of the positive electrode active material 100 obtained in Embodiments 1, 2, and the like for the positive electrode of the secondary battery 913 enables the secondary battery 913 to have high energy density and a small size.

This embodiment can be used in combination with the other embodiments.

### Example 1

### <Method for Fabricating Sample 1>

This example will explain that the positive electrode active material 100 (Sample 1) with a median diameter of less than or equal to 12 μm can be obtained on the basis of the description in Embodiment 1, FIG. 9 to FIG. 10, and the like.

As lithium cobalt oxide (LiCoO₂) that was a starting material shown in Step S10 in FIG. 9, commercially available lithium cobalt oxide containing no additive element (CELLSEED C-5H produced by NIPPON CHEMICAL INDUSTRIAL CO., LTD.) was prepared. Hereinafter, in this specification and the like, the lithium cobalt oxide is simply referred to as “C-5H”. The median diameter of C-5H is approximately 7.0 μm, which satisfies the condition where the median diameter is less than or equal to 10 μm.

Next, the heating in Step S15 was performed on C-5H, which was put in a sagger (container) covered with a lid, in a muffle furnace at 850° C. for 2 hours. After the muffle furnace was filled with an oxygen atmosphere, no flowing was performed (O₂ purging). Note that C-5H was put in the sagger so that the powder had a height (also referred to as bulk) of less than or equal to 10 mm and was flat in the sagger.

Subsequently, in accordance with Step S20a shown in FIG. 10A, the additive element A1 source was formed. First, lithium fluoride (LiF) and magnesium fluoride (MgF₂) were prepared as the F source and the Mg source, respectively. LiF and MgF₂ were weighed such that LiF:MgF₂ was 1:3 (molar ratio). Then, LiF and MgF₂ were mixed in dehydrated acetone and the mixture was stirred at a rotating speed of 500 rpm for 20 hours. In the mixing, a ball mill was used and a grinding medium was zirconium oxide balls. The Mg source (MgF₂) and the F source (LiF) that weighed approximately 9 g in total were put in a 45-mL-capacity container of a mixing ball mill together with 20 mL of dehydrated acetone and 22 g of zirconium oxide balls (1 mmϕ) and mixed. Then, the mixture was made to pass through a sieve with an aperture of 300 μm, whereby the additive element A1 source was obtained.

Next, in accordance with Step S31 shown in FIG. 9, the lithium cobalt oxide (lithium cobalt oxide subjected to the initial heating) obtained by the heating in Step S15 and the additive element A1 source obtained in Step S20a were mixed. Specifically, the materials were weighed so that the number of magnesium atoms was 1 at % of the number of cobalt atoms included in the lithium cobalt oxide, and then the lithium cobalt oxide subjected to the initial heating and the additive element A1 source were mixed by a dry method. At this time, stirring was performed at a rotating speed of 150 rpm for 1 hour. After that, the mixture was made to pass through a sieve with an aperture of 300 μm, whereby the mixture 903 was obtained (Step S32).

Subsequently, as Step S33, the mixture 903 was heated. The heating conditions were 900° C. and 5 hours. During the heating, a lid was put on a sagger containing the mixture 903. The sagger was filled with an atmosphere containing oxygen, and entry and exit of the oxygen were blocked (purging). By the heating, a composite oxide containing Mg and F (lithium cobalt oxide containing Mg and F) was obtained (Step S34a).

Next, in accordance with Step S40 shown in FIG. 10C, the additive element A2 source was formed. First, nickel hydroxide (Ni(OH)₂) and aluminum hydroxide (Al(OH)₃) were prepared as the Ni source and the Al source, respectively. Next, the nickel hydroxide and the aluminum hydroxide were separately stirred in dehydrated acetone at a rotating speed of 500 rpm for 20 hours. In the mixing, a ball mill was used and a grinding medium was zirconium oxide balls. The nickel hydroxide and the aluminum hydroxide each weighing approximately 10 g were put in separate 45-mL-capacity containers of mixing ball mills, together with 20 ml of dehydrated acetone and 22 g of zirconium oxide balls (1 mmϕ) and stirred. Then, each of the nickel hydroxide and the aluminum hydroxide was made to pass through a sieve with an aperture of 300 μm, whereby the additive element A2 source was obtained.

Subsequently, as Step S51, the composite oxide containing Mg and F and the additive element A2 source were mixed by a dry method. Specifically, the mixing was performed by 1-hour stirring at a rotating speed of 150 rpm. The mixture ratio was set so that each of the nickel hydroxide and the aluminum hydroxide contained in the additive element A2 source was 0.5 at % of the number of cobalt atoms included in the lithium cobalt oxide. In the mixing, a ball mill was used and a grinding medium was zirconium oxide balls. The Ni source, the Al source, and the composite oxide (lithium cobalt oxide containing Mg and F) obtained in Step S34 that weighed approximately 7.5 g in total were put in a 45-mL-capacity container of the mixing ball mill together with 22 g of zirconium oxide balls (1 mmϕ) and mixed. Finally, the mixture was made to pass through a sieve with an aperture of 300 μm, whereby a mixture 904 was obtained (Step S52).

Next, as Step S53, the mixture 904 was heated. The heating conditions were 850° C. and 2 hours. The heating was performed in a muffle furnace with a lid put on a sagger containing the mixture 904. After the muffle furnace was filled with an oxygen atmosphere, no flowing was performed (O₂ purging). By the heating, lithium cobalt oxide containing Mg, F, Ni, and Al (a composite oxide) was obtained (Step S54). In this manner, Sample 1 of the positive electrode active material was obtained.

### <Method for Fabricating Sample 2>

Sample 2 was fabricated under conditions different from those of Sample 1. In the method for fabricating Sample 2, the heating conditions at the time of heating the mixture 903 in Step S33 were 900° C. and 20 hours, and the heating conditions at the time of heating the mixture 904 in Step S53 were 850° C. and 10 hours. Sample 2 was fabricated by the same method as Sample 1 except for the above-described heating temperatures. In this manner, Sample 2 of the positive electrode active material was obtained.

### <Comparative Sample 1>

As Comparative sample 1, commercially available lithium cobalt oxide containing no additive element (CELLSEED C-5H produced by NIPPON CHEMICAL INDUSTRIAL CO., LTD.) was prepared.

### <Particle Size Distribution Measurement>

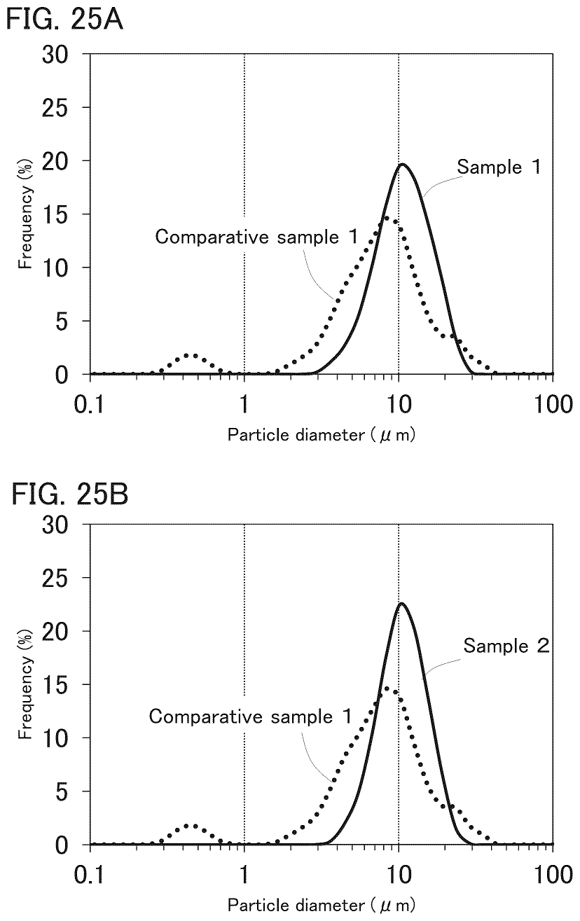

FIG. 25A shows the measurement results of particle size distribution of Sample 1, and FIG. 25B shows the measurement results of particle size distribution of Sample 2. In FIG. 25A and FIG. 25B, the measurement data of Sample 1 and Sample 2 are shown by solid lines, and the measurement data of Comparative sample 1 are shown by dotted lines.

The median diameter (D50) of Sample 1 was approximately 9.7 μm, and the median diameter (D50) of Sample 2 was approximately 9.5 μm. These results demonstrated that the median diameter of each of Sample 1 and Sample 2 was less than or equal to 12 μm (less than or equal to 10.5 μm). The median diameter (D50) of Comparative sample 1 was approximately 7.0 μm. Note that median diameter (D50) can be measured by observation using a SEM (scanning electron microscope) or a TEM or with a particle size distribution analyzer using a laser diffraction and scattering method, for example. In this example, a laser diffraction particle size analyzer SALD-2200 produced by Shimadzu Corporation was used for the measurement.

### <Ion Chromatography>

The elements contained in Sample 1 and Comparative Sample 1 were analyzed by ion chromatography. As an apparatus for ion chromatography, an ion chromatography system Dionex ICS-2100 produced by Thermo Fisher Scientific Inc. was used.

Pretreatment for the analysis is described. Two hundred and fifty milligrams of Sample 1 and 2 ml of a 0.05-M H₂SO₄ aqueous solution were prepared, and put into a glass container with a lid and mixed, whereby a first mixture solution was obtained. For the mixing, an ultrasonic wave was applied for 1 hour. After that, the container was left to stand at room temperature for 12 hours or longer. Then, 1 ml of a filtrate obtained by filtration of the first mixture solution and 9 ml of pure water were mixed, whereby a second mixture solution was obtained. In this manner, the pretreatment for Sample 1 was completed. Comparative sample 1 was subjected to pretreatment by the same method as Sample 1.

Next, ion chromatography was performed using the second mixture solution obtained in the above-described pretreatment. Anion analysis and cation analysis were performed in ion chromatography.

The anion analysis conditions are shown below. The anion analysis was performed at 35° C. with the use of a Dionex IonPac AG20 column (2×50 mm) and a Dionex IonPac AS20 column (2×250 mm). A KOH aqueous solution was used as the eluent, and the flow rate was 0.44 ml/min. Gradient measurement was performed such that the concentration of the KOH aqueous solution was gradually increased. A conductivity detector was used as the detector. A calibration curve was created using an anion mixed standard solution produced by Kanto Chemical Co., Inc.

The cation analysis conditions are shown below. The cation analysis was performed at 30° C. with the use of a Dionex IonPac CG16 column (3×50 mm) and a Dionex IonPac CS16 column (3×250 mm). The eluent was an aqueous methanesulfonic acid (MSA) solution, and the flow rate was 0.36 ml/min. Isocratic analysis was performed with the concentration of the aqueous MSA solution kept constant. A conductivity detector was used as the detector. A calibration curve was created using a cation mixed standard solution produced by Kanto Chemical Co., Inc.

Table 1 shows the results of ion chromatography. The numerical values shown in the table indicate weight ppm of each element with respect to the sample weight (Sample 1 or Comparative sample 1).

TABLE 1

| | Anion (weight ppm) | | Cation (weight ppm) | | | |
|---|---|---|---|---|---|---|
| Sample name | F | Cl | Li | Mg | Co | Ni |
| Sample 1 | 933.2 | 33.6 | 2997.6 | 632.0 | 9700.9 | 246.5 |
| Comparative | 2.2 | 4.2 | 3191.2 | 8.9 | 9487.6 | 0.0 |
| sample 1 | | | | | | |

### <Calculation of Projection>

To evaluate the smoothness of the particle surface of Sample 1 and Comparative Sample 1, the number of projections present on the particle surface was calculated. The details are described below.

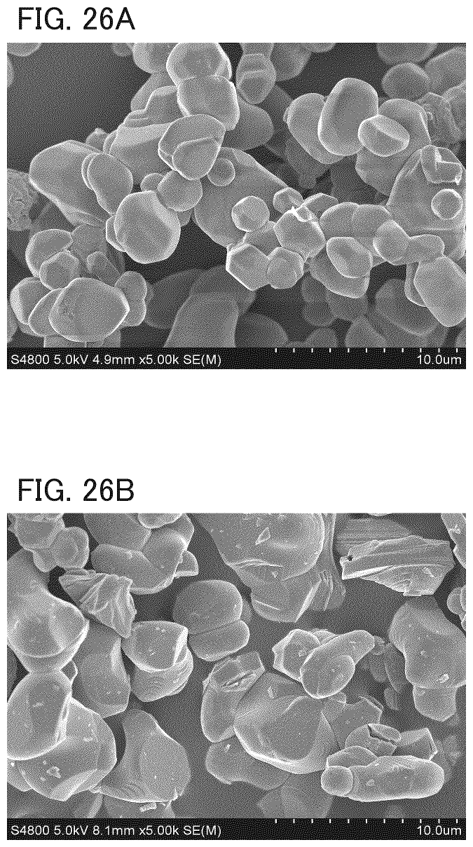

SEM observation of the particles of Sample 1 and Comparative Sample 1 was performed. Under the SEM observation conditions where the acceleration voltage was 5 kV and the magnification was 5000 times, a SEM image including the particle surface of each sample was obtained. FIG. 26A shows a surface SEM image of Sample 1, and FIG. 26B shows a surface SEM image of Sample 2. Comparison of the surface SEM images reveals that Sample 1 has higher smoothness than Sample 2.

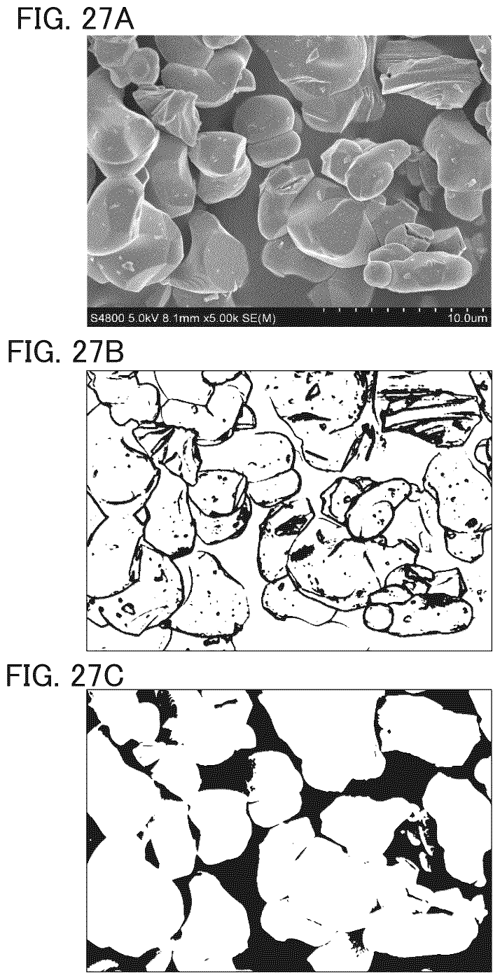

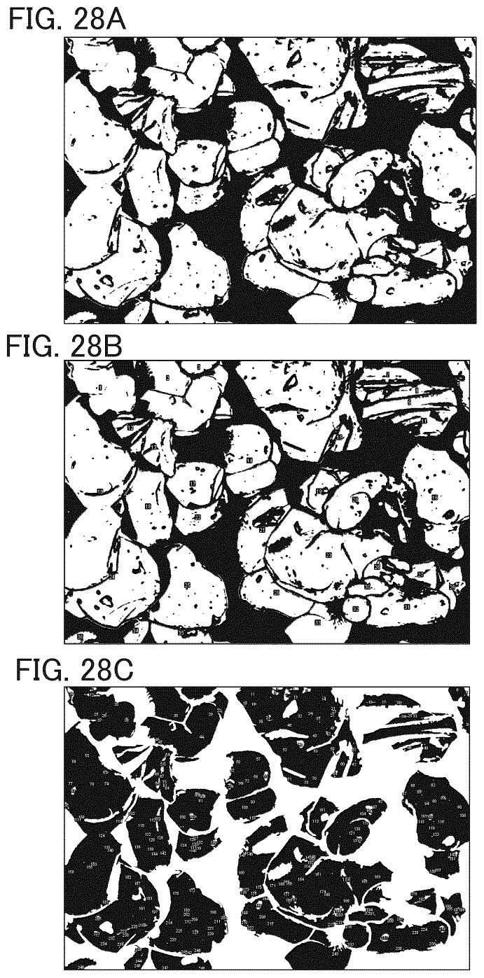

A method for calculating a projection is described with reference to FIG. 27 and FIG. 28. A given SEM image is shown in FIG. 27A. Then, a label portion that is not used for image analysis is trimmed from the SEM image. For trimming, well-known image processing software can be used, and for example, the product name “imageJ” is preferably used. Hereinafter, a procedure in which imageJ is used will be described.

In the case where a plurality of positive electrode active materials are aggregated as shown in FIG. 27A, i.e., a plurality of positive electrode active materials are adjacent to or in close contact with each other, boundaries of the positive electrode active materials are extracted. To extract the boundaries, it is preferable to extract a portion where a luminance change in the image by using the Find Edges function of imageJ, perform image noise processing by the Gaussian Blur function (sigma=2.0), and then perform binarization by the Threshold function (Otsu algorithm). FIG. 27B shows an image of extracted boundary portions.

In the case where the aggregated positive electrode active materials are observed as shown in FIG. 27A, boundaries of positive electrode active materials on the front side are preferably identified. For example, to identify positive electrode active materials on the front side, it is preferable to increase the contrast of the image by the Enhance Contrast (Saturated pixels=0.35%) function of imageJ, perform image noise processing by the Gaussian Blur function (sigma=2.0), and then perform binarization by the Threshold function (Minimum algorithm), thereby extracting the boundaries of the positive electrode active materials on the front side. FIG. 27C shows an image of extracted positive electrode active materials on the front side.

FIG. 27B obtained in the above procedure is made to have a transmittance of 50% by the Add Image function of ImageJ and superimposed on FIG. 27C. After that, binarization is performed by the Threshold function (Otsu algorithm) of imageJ, thereby obtaining an image such as shown in FIG. 28A in which the background and the interior of the particles are separated.

A particle having an area in FIG. 28A, i.e., an area in the image, of 0.8 μm² or larger is identified by the Analyze particle function with the use of ImageJ (FIG. 28B), and the number thereof is counted. The particle corresponds to a positive electrode active material. Selection of a particle area of 0.8 μm² or larger, which corresponds to a median diameter (D50) of 1 μm or greater, can be regarded as selection of the area consistent with the particle size distribution measurement.

Next, a fine particle of 0.25 μm² or smaller present on the surfaces of the identified particles, i.e., the positive electrode active materials, is identified by the Analyze particle function of ImageJ, and the number thereof is calculated. At this time, a particle with a size of 10 pixels or less in the image is excluded as noise. FIG. 28C shows an image from which noise has been removed. The fine particle corresponds to a projection.

By thus calculating the fine particles of 0.25 μm² or smaller present on the surface of the positive electrode active material, whether the positive electrode active material has a smooth region can be evaluated.

According to the above procedure, projections and the like were calculated in the surface SEM image of Sample 1, and 77 fine particles were obtained with respect to 43 positive electrode active materials. According to the same procedure, projections and the like were calculated in the surface SEM image of Comparative sample 1, and 248 fine particles were obtained with respect to 36 positive electrode active materials. Sample 1 of this example was found to have two or less fine particles per positive electrode active material and be a positive electrode active material including a smooth region.

### Example 2

In this example, coin-type half cells using Sample 1 and Sample 2, which were fabricated in Example 1, as positive electrode active materials were fabricated. Moreover, charge and discharge tests at varying temperatures and discharge capacity measurement with varying rates were performed using the fabricated half cells.

### <Half Cell Fabrication 1>

Sample 1, acetylene black (AB), and poly(vinylidene fluoride) (PVDF) were prepared as a positive electrode active material, a conductive material, and a binding agent, respectively. The PVDF prepared was one dissolved in N-methyl-2-pyrrolidone (NMP) with a weight ratio of 5%. Then, a slurry was formed by mixing the positive electrode active material, AB, and PVDF at a weight ratio of 95:3:2, and the slurry was applied to a positive electrode current collector of aluminum. As a solvent of the slurry, NMP was used.

Next, after the application of the slurry on the positive electrode current collector, the solvent was volatilized, whereby a positive electrode active material layer was formed over the positive electrode current collector.

After that, pressing treatment was performed with a roller press machine to increase the density of the positive electrode active material layer over the positive electrode current collector. The pressing treatment condition was a linear pressure of 210 kN/m. Note that the temperature of each of an upper roll and a lower roll of the roller press machine was 120° C.

Through the above process, a positive electrode was obtained. In the positive electrode, the loading amount of the active material was approximately 7 mg/cm².

The electrolyte solution used for the half cell contains an organic solvent. The organic solvent contains ethylene carbonate (EC), ethyl methyl carbonate (EMC), and dimethyl carbonate (DMC). Given that the total content of EC, EMC, and DMC was 100 vol %, an organic solvent in which the volume ratio of EC, EMC, and DMC was x:y:100-x-y (where 5≤x≤35 and 0<y<65) was used. More specifically, an organic solvent containing EC, EMC, and DMC at EC:EMC:DMC=30:35:35 in a volume ratio was prepared. A solution in which lithium hexafluorophosphate (LiPF₆) was dissolved in this organic solvent at a concentration of 1 mol/L was used as the electrolyte solution. Hereinafter, in this specification and the like, this electrolyte solution is referred to as an “electrolyte solution A”.

A general electrolyte solution used for a lithium ion battery is solidified at approximately −20° C.; thus, it is difficult to form a battery that can be charged and discharged at −40° C. The electrolyte solution used in this example has a freezing point at lower than or equal to −40° C., which is one of the conditions to achieve a lithium ion battery that can be charged and discharged even in an extremely low-temperature environment of −40° C.

As a separator, a polypropylene porous film was used. For a negative electrode (counter electrode), a lithium metal was used.

With the use of these components, Half cell 1 including Sample 1 as the positive electrode active material was fabricated.

Moreover, Half cell 2 including Sample 2 as the positive electrode active material was fabricated by the same fabrication method as Half cell 1.

Note that in order to perform a plurality of kinds of measurements, a plurality of half cells fabricated under the same conditions were prepared as Half cells 1 and Half cells 2.

### <Aging of Half Cells>

As aging of Half cells 1 and Half cells 2, charge and discharge were repeated three times at 25° C. Charge was performed in the following manner: constant current charge was performed at a charge current of 0.1 C (where 1 C=200 mA/g) until the voltage reached 4.60 V, and constant voltage charge was successively performed at 4.60 V until the charge current became lower than or equal to 0.01 C. As the discharge condition, constant current discharge was performed at a discharge rate of 0.1 C until the voltage reached 2.5 V (cutoff voltage). Note that the current of 0.1 C can be referred to as a current of 20 mA/g per positive electrode active material weight, and the current of 0.01 C can be referred to as a current of 2 mA/g per positive electrode active material weight.

### <Charge and Discharge Test 1 at Varying Temperatures>

With the use of Half cell 1 and Half cell 2 on which the aging treatment was performed, charge capacity and discharge capacity were measured in low-temperature environments as Charge and discharge test 1 at varying temperatures. As the measurement, charge and discharge performance was measured in varying temperature environments in the following order: charge and discharge in an environment of 0° C., charge and discharge in an environment of 25° C., charge and discharge in an environment of −20° C., charge and discharge in an environment of 25° C., charge and discharge in an environment of −40° C., charge and discharge in an environment of 25° C.

As the discharge condition for each temperature condition, charge was performed in the following manner: constant current charge was performed at a charge current of 0.1 C until the voltage reached 4.60 V, and constant voltage charge was successively performed at 4.60 V until the charge current became lower than or equal to 0.01 C. As the discharge condition, constant current discharge was performed at a discharge rate of 0.1 C until the voltage reached 2.5 V (cutoff voltage).

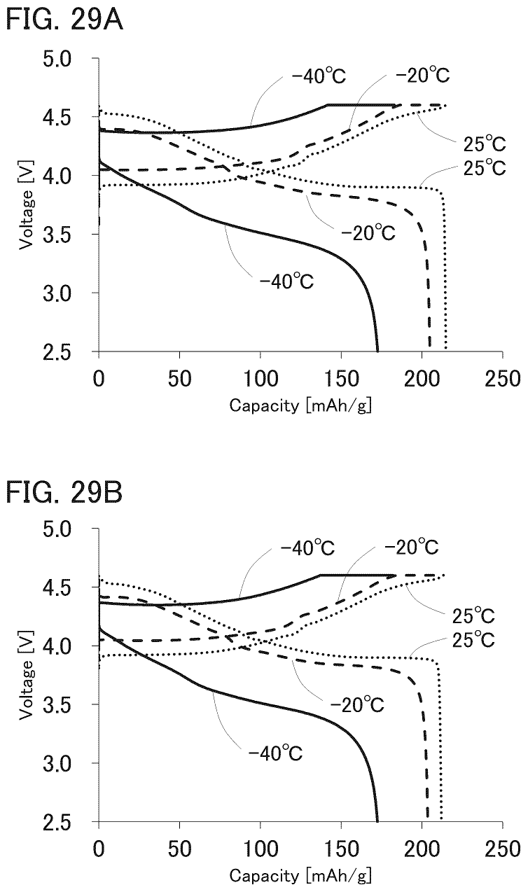

FIG. 29A is a graph showing charge and discharge performance of Half cell 1, and FIG. 29B is a graph showing charge and discharge performance of Half cell 2.

As for the charge and discharge curves under each temperature condition shown in FIG. 29A and FIG. 29B, the dotted line represents the result when the temperature at the time of charge and discharge was 25° C., the dashed line represents the result when the temperature at the time of charge and discharge was −20° C., and the solid line represents the result when the temperature at the time of charge and discharge was −40° C.

Regarding the charge and discharge performance of Half cell 1 and Half cell 2 shown in FIG. 29A and FIG. 29B, Table 2 shows the discharge capacity under each temperature condition. Note that in FIG. 29A and FIG. 29B, charge and discharge curves in an environment of 0° C. are not shown for easy viewing of the graphs. In Table 2, the numerical values shown in the third column and the fifth column are numerical values normalized with the discharge capacity in an environment of 25° C. regarded as 100%.

TABLE 2

| | | Sample 1 | | Sample 2 | |
|---|---|---|---|---|---|
| | | Discharge | Discharge | Discharge | Discharge |
| | | capacity | capacity rate | capacity | capacity rate |
| Temperature | | [mAh/g] | [%] | [mAh/g] | [%] |
| 25° | C. | 214.8 | 100.0 | 212.1 | 100.0 |
| 0° | C. | 211.3 | 98.4 | 209.0 | 98.6 |
| −20° | C. | 205.0 | 95.4 | 203.7 | 96.0 |
| −40° | C. | 172.6 | 80.3 | 172.5 | 81.3 |

The results in FIG. 29A, FIG. 29B, and Table 2 revealed that Half cell 1 and Half cell 2, i.e., the lithium ion batteries including the positive electrode active material obtained by the formation method described in Embodiment 1 and the like, were able to perform charge operation and discharge operation at least in a temperature range from −40° C. to 25° C. inclusive.

As shown in FIG. 29A, FIG. 29B, and Table 2, Sample 1 and Sample 2 exhibited extremely high discharge capacity, which was greater than or equal to 170 mAh/g even at a charge temperature and a discharge temperature of −40° C. From another viewpoint, an excellent result was obtained in which the discharge capacity at the time of charge and discharge at −40° C. was greater than or equal to 80% of the discharge capacity at the time of charge and discharge at 25° C. Accordingly, the following results were obtained: the discharge capacity of the case where the charge temperature and the discharge temperature were −40° C. was greater than or equal to 170 mAh/g and the discharge capacity at the time of discharge at −40° C. was higher than or equal to 80% of the discharge capacity at the time of discharge at 25° C.

### <Charge and Discharge Test 2 at Varying Temperatures>

As Charge and discharge test 2 at varying temperatures, charge capacity and discharge capacity in low-temperature environments were more specifically measured with the use of Half cell 1 subjected to the above aging treatment (a half cell different from the one used in Charge and discharge test 1 at varying temperatures). As the measurement, charge capacity and discharge capacity were measured in varying temperature environments in the following order: charge and discharge in an environment of 20° C.; charge and discharge in an environment of −40° C.; charge and discharge in an environment of −30° C.; charge and discharge in an environment of −20° C.; charge and discharge in an environment of −10° C.; and charge and discharge at 0° C.

In varying temperature environments, charge was performed in the following manner: constant current charge was performed at a charge current of 0.1 C until the voltage reached 4.60 V, and constant voltage charge was successively performed at 4.60 V until the charge current became lower than or equal to 0.01 C. As the discharge condition, constant current discharge was performed at a discharge rate of 0.1 C until the voltage reached 2.5 V (cutoff voltage). Note that the current of 0.1 C can be referred to as a current of 20 mA/g per positive electrode active material weight, and the current of 0.01 C can be referred to as a current of 2 mA/g per positive electrode active material weight.

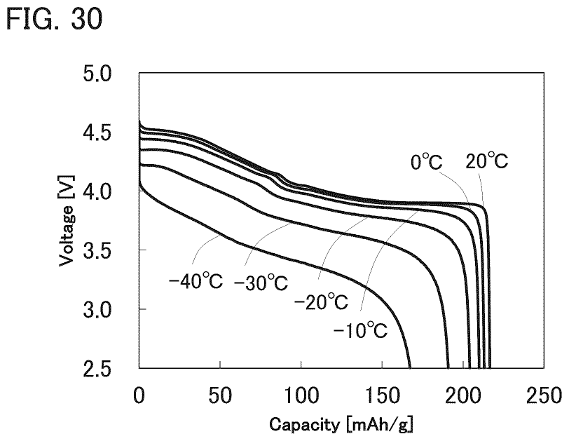

The measurement results are shown in Table 3. In Table 3, the first column represents temperature conditions, the second column represents charge capacity per positive electrode active material weight, the third column represents discharge capacity per positive electrode active material weight, and the fourth column represents discharge capacity of Half cell 1. In the fifth column, discharge capacity in varying temperature environments is shown as a discharge capacity rate (%) when the discharge capacity at 20° C. is 100%. FIG. 30 shows discharge curves in varying temperature environments.

TABLE 3

| | | Charge | Discharge | Discharge | Discharge |
|---|---|---|---|---|---|
| | | capacity | capacity | capacity | capacity rate |
| Temperature | | [mAh/g] | [mAh/g] | [mAh] | [%] |
| 20° | C. | 219.0 | 216.6 | 1.75 | 100.0 |
| −40° | C. | 181.3 | 167.3 | 1.35 | 77.2 |
| −30° | C. | 185.3 | 190.9 | 1.54 | 88.1 |
| −0° | C. | 201.7 | 204.1 | 1.65 | 94.2 |
| −10° | C. | 209.3 | 210.0 | 1.69 | 96.9 |
| 0° | C. | 213.3 | 213.1 | 1.72 | 98.4 |

According to the measurement results of charge and discharge in low-temperature environments, the following favorable results of Half cell 1 that is the secondary battery of one embodiment of the present invention were obtained when the discharge capacity value measured in charge and discharge in an environment of 20° C. was 100%. The discharge capacity value measured in charge and discharge in an environment of −40° C. was 77.2%, which is a favorable result of exceeding 75%. The discharge capacity value measured in charge and discharge in an environment of −30° C. was 88.1%, which is a favorable result of exceeding 85%. The discharge capacity value measured in charge and discharge in an environment of −20° C. was 94.2%, which is a favorable result of exceeding 90%. The discharge capacity value measured in charge and discharge in an environment of −10° C. was 96.9%, which is a favorable result of exceeding 95%. The discharge capacity value measured in charge and discharge in an environment of 0° C. was 98.1%, which is a favorable result of exceeding 98%.

<Discharge Capacity Measurement with Varying Rates>

With the use of Half cell 1 subjected to the above aging treatment (a half cell different from the ones used in Charge and discharge tests 1 and 2 at varying temperatures), charge capacity and discharge capacity were measured in an environment of −40° C. as discharge capacity measurement with varying rates (also referred to as at each discharge current value, at each discharge speed, or the like) under six kinds of discharge conditions. The discharge current value varies under the six kinds of discharge conditions, and the measurement was performed at 0.02 C, 0.1 C, 0.2 C, 0.3 C, 0.5 C, and 1 C in this order. Before the discharge under each of the discharge conditions, charge was performed under the common charge condition. Note that the current of 0.02 C can be referred to as a current of 4 mA/g per positive electrode active material weight, the current of 0.1 C can be referred to as a current of 20 mA/g per positive electrode active material weight, the current of 0.2 C can be referred to as a current of 40 mA/g per positive electrode active material weight, the current of 0.3 C can be referred to as a current of 60 mA/g per positive electrode active material weight, the current of 0.5 C can be referred to as a current of 100 mA/g per positive electrode active material weight, and the current of 1 C can be referred to as a current of 200 mA/g per positive electrode active material weight.

Charge was performed in the following manner: constant current charge was performed at a discharge current of 0.1 C until the voltage reached 4.60 V, and constant voltage charge was successively performed at 4.60 V until the charge current became lower than or equal to 0.01 C. As the discharge condition, constant current discharge was performed under the six kinds of conditions until the voltage reached 2.5 V (cutoff voltage).

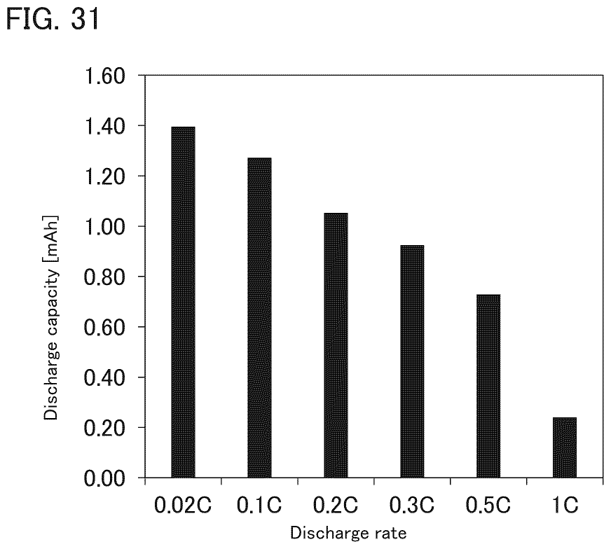

The measurement results are shown in Table 4. In Table 4, the first column represents discharge current conditions, the second column represents charge capacity per positive electrode active material weight, the third column represents discharge capacity per positive electrode active material weight, and the fourth column represents discharge capacity of Half cell 1. In the fifth column, discharge capacity under each discharge current condition is shown as a discharge capacity rate (%) when discharge capacity of 0.1 C is 100%. FIG. 31 is a graph showing discharge capacity at each discharge rate.

TABLE 4

| | Charge | Discharge | Discharge | Discharge |
|---|---|---|---|---|
| Discharge | capacity | capacity | capacity | capacity rate |
| rate [C] | [mAh/g] | [mAh/g] | [mAh] | [%] |
| 0.02 | 173.2 | 167.6 | 1.40 | 109.7 |
| 0.1 | 170.5 | 152.7 | 1.27 | 100.0 |
| 0.2 | 150.4 | 126.4 | 1.05 | 82.7 |
| 0.3 | 125.2 | 111.0 | 0.92 | 72.7 |
| 0.5 | 111.2 | 87.5 | 0.73 | 57.3 |
| 1 | 88.2 | 28.8 | 0.24 | 18.8 |

According to the measurement results of charge and discharge in an environment of −40° C., the following favorable results of Half cell 1 that is the secondary battery of one embodiment of the present invention were obtained when the discharge capacity value measured at a discharge current of 0.1 C was 100%. The discharge capacity value measured at discharge current of 0.2 C was 82.7%, which is a favorable result of exceeding 80%. The discharge capacity value measured at discharge current of 0.3 C was 72.7%, which is a favorable result of exceeding 70%. The discharge capacity value measured at discharge current of 0.5 C was 57.3%, which is a favorable result of exceeding 50%. Note that Half cell 1 can be discharged even at discharge current of 1 C, and the discharge capacity value was 18.8%. That is, it can be said that the secondary battery of one embodiment of the present invention has high discharge performance at −40° C.

The charge and discharge measurement in an environment of −40° C. revealed that the charge and discharge efficiency (proportion of discharge capacity to charge capacity) was high at discharge current of 0.02 C.

As has been described above in this example, it was revealed that the lithium ion battery including the positive electrode active material obtained by the formation method described in Embodiment 2 and the like enables charge operation and discharge operation at least in a temperature range from −40° C. to 20° C. inclusive. It was also found that the lithium ion battery also including the electrolyte described in Embodiment 1 enables outstanding charge operation and discharge operation in a temperature range from −40° C. to 20° C. inclusive.

### Example 3

In this example, coin-type half cells using Sample 1, Sample 2, and Comparative sample 1, which were fabricated in Example 1, as positive electrode active materials were fabricated. Moreover, a charge and discharge cycle test was performed using the fabricated half cells.

### <Half Cell Fabrication 2>

As a half cell to be subjected to the charge and discharge cycle test, Half cell 1B was fabricated using Sample 1 as a positive electrode active material. As an electrolyte solution, a solution that is obtained by adding vinylene carbonate (VC) at 2 wt % as an additive to a mixture of ethylene carbonate (EC) and diethyl carbonate (DEC) at EC:DEC=3:7 (volume ratio) was used instead of the electrolyte solution A used in Example 1. As an electrolyte contained in the electrolyte solution, 1 mol/L lithium hexafluorophosphate (LiPF₆) was used. Hereinafter, in this specification and the like, this electrolyte solution is referred to as an “electrolyte solution B”. The method for fabricating the half cell other than the electrolyte solution was the same as the method described in <Half cell fabrication 1> in Example 1.

Half cell 2B including Sample 2 as the positive electrode active material was fabricated by the same fabrication method as Half cell 1B.

Comparative cell including Comparative Sample 1 as the positive electrode active material was fabricated by same fabrication method as Half cell 1B.

Note that in order to perform a plurality of kinds of measurements, a plurality of half cells fabricated under the same conditions were prepared as Half cells 1B, Half cells 2B, and Comparative cells.

### <Charge and Discharge Cycle Performance>

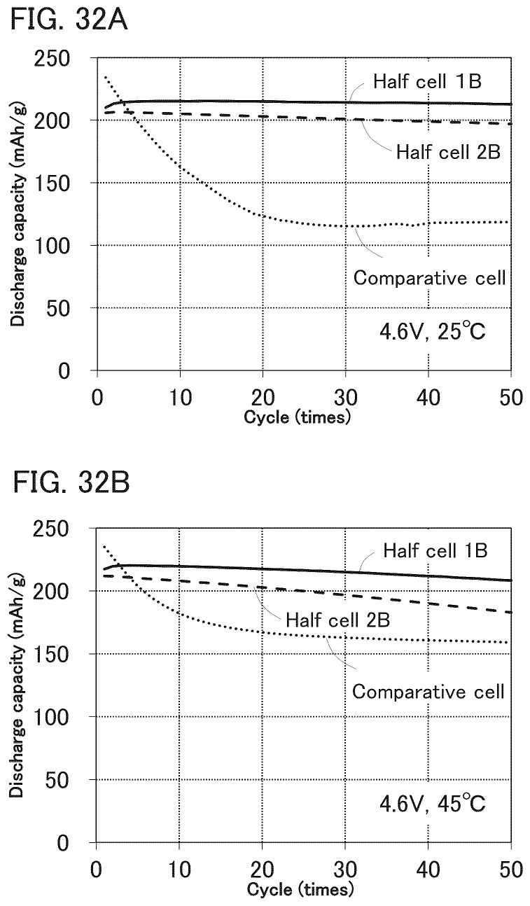

FIG. 32A and FIG. 32B show charge and discharge cycle performance of Half cell 1B, Half cell 2B, and Comparative cell. As charge, constant current charge was performed at 0.5 C until the voltage reached 4.60 V, and then constant voltage charge was performed until the current value reached 0.05 C. As discharge, constant current discharge was performed at 0.5 C until the voltage reached 2.5 V. Note that here, 1 C was set to 200 mA/g. Two conditions were set to the temperature: 25° C. and 45° C. In the above manner, charge and discharge were repeated 50 times. FIG. 32A shows the results of the charge and discharge cycle test in an environment of 25° C., and FIG. 32B shows the results of the charge and discharge cycle test in an environment of 45° C.

As shown in FIG. 32A and FIG. 32B, it was demonstrated that Half cell 1B including Sample 1 and Half cell 2B including Sample 2 each exhibited favorable charge and discharge cycle performance under a high voltage condition of 4.6 V at 25° C. and 45° C. In particular, Half cell 1B including Sample 1 exhibited excellent charge and discharge cycle performance under any of the conditions.

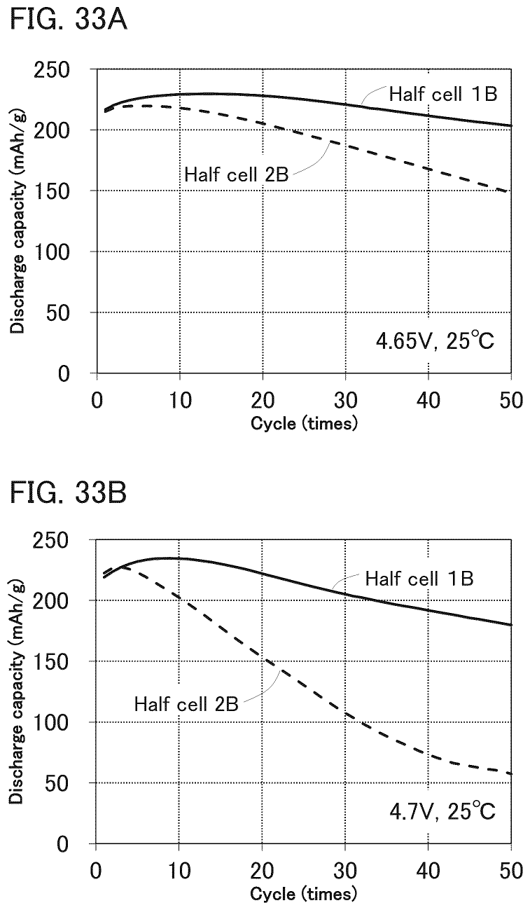

FIG. 33A and FIG. 33B show charge and discharge cycle performance of Half cell 1B and Half cell 2B at a higher voltage. As charge, constant current charge was performed at 0.5 C until the voltage reached 4.65 V or 4.70 V, and then constant voltage charge was performed until the current value reached 0.05 C. As discharge, constant current discharge was performed at 0.5 C until the voltage reached 2.5 V. Note that here, 1 C was set to 200 mA/g. The temperature was set to 25° C. In the above manner, charge and discharge were repeated 50 times. FIG. 33A shows the results of the charge and discharge cycle test under the condition where charge to 4.65 V was performed, and FIG. 33B shows the results of the charge and discharge cycle test under the condition where charge to 4.70 V was performed.

As shown in FIG. 33A and FIG. 33B, Half cell 1B including Sample 1 exhibited charge and discharge cycle performance superior to Half cell 2B including Sample 2.

In the 4.60-V condition shown in FIG. 32A, both Half cell 1B including Sample 1 and Half cell 2B including Sample 2 had excellent charge and discharge cycle performance. Meanwhile, in the 4.65-V condition shown in FIG. 33A and the 4.70-V condition shown in FIG. 33B, Half cell 1B including Sample 1 and Half cell 2B including Sample 2 had different charge and discharge cycle performances, demonstrating that Sample 1 was superior to Sample 2.

### Example 4

In this example, XPS analysis, XRD analysis in a high-voltage charged state, and STEM-EDX analysis were performed to examine the factors of the excellent charge and discharge cycle performance of Sample 1 and Sample 2, particularly the excellent charge and discharge cycle performance of Sample 1.

### <XRD Analysis in High-Voltage Charged State>

An experiment for examining a crystal structure of Sample 1 in a high-voltage charged state was conducted.

First, charge and discharge were performed using Half cell 1B fabricated in Example 3 (a half cell different from the one subjected to the charge and discharge cycle test). As charge, constant current charge was performed at 0.2 C up to 4.50 V, and then constant voltage charge was performed until the current value reached 0.05 C. As discharge, constant current discharge was performed at 0.2 C up to 3.0 V. Note that 1 C was set to 200 mA/g as in the other tests.

Next, charge before the XRD analysis in a high-voltage charged state was performed. As charge, constant current charge was performed at 0.2 C up to 4.60 V, and then constant voltage charge was performed until the current value reached 0.02 C.

After that, Half cell 1B was disassembled within one hour after the above charge was terminated. An insulating tool was used in the disassembly to extract the positive electrode including Sample 1 while the positive electrode was kept in a high-voltage charged state, and disassembly was performed carefully so as not to cause a short circuit. For the disassembly, a glove box in which the dew point and oxygen concentration were controlled and which was filled with argon was used. Note that the dew point of the glove box is preferably lower than or equal to −70° C., and the oxygen concentration is preferably lower than or equal to 5 ppm. The crystal structure of the positive electrode active material might be changed by self-discharge after a long time passed since the above charge; hence, it is preferable to perform disassembly and analysis as early as possible.

The above-described Sample 1 obtained by disassembling Half cell 1B was set on an XRD measurement stage capable of being hermetically sealed in the glove box, thereby obtaining Sample 1 that was hermetically sealed in the XRD measurement stage together with argon.

Then, the XRD measurement started within 15 minutes. The XRD apparatus and conditions are as follows.
XRD apparatus: D8 ADVANCE produced by Bruker AXS
X-ray source: CuKα₁ radiation
Output: 40 KV, 40 mA
Angle of divergence: Div. Slit, 0.5° Detector: LynxEye
Scanning method: 2θ/θ continuous scan
Measurement range (2θ): from 15° to 75° (100 minutes)
Step width (2θ): 0.01°
Counting time: 1 second/step
Rotation of sample stage: 15 rpm

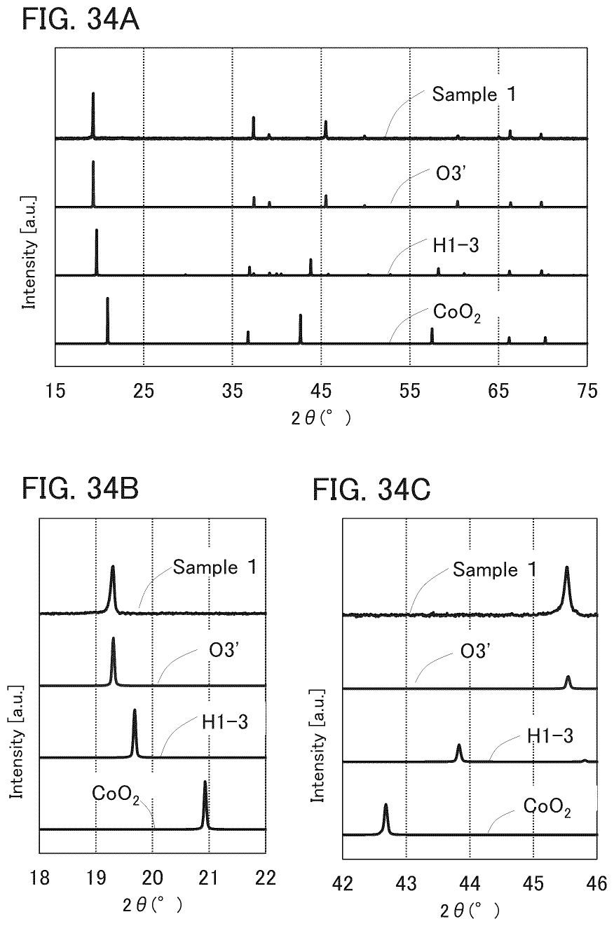

FIG. 34A to FIG. 34C show XRD measurement data of Sample 1 in a high-voltage charged state. FIG. 34A to FIG. 34C also show O3′ structure reference data (O3′), H1-3 structure reference data (H1-3), and CoO₂ reference data (CoO₂).

FIG. 34A shows the range where 2θ is greater than or equal to 15° and less than or equal to 75° C. in the XRD measurement. In FIG. 34B and FIG. 34C, part of FIG. 34A is enlarged, and the magnification of the vertical axis for the measurement data of Sample 1 is partly changed.

As a result of the XRD analysis in a high-voltage charged state shown in FIG. 34A to FIG. 34C, Sample 1 charged under a high voltage condition of 4.6 V (the above description is referred to for the other charge conditions) has a diffraction peak at 2θ=19.30°, which falls within the range of 2θ=19.25±0.12° (from 19.13° to) 19.37° and a diffraction peak at 2θ=45.52°, which falls within the range of 2θ=45.47±0.10° (from 45.37° to) 45.57°. That is, Sample 1 was demonstrated to have the O3′ structure. Thus, Sample 1 in a high-voltage charged state having the O3′ structure can be considered to be a major factor of favorable cycle performance at 4.60 V, favorable cycle performance at 4.65 V, and favorable cycle performance at 4.70 V of Half cell 1B including Sample 1.

### <XPS Analysis>

Next, XPS analysis was performed on Sample 1, Sample 2, and Comparative sample 1.

The XPS measurement conditions are shown below.
Measurement apparatus: Quanterall produced by PHI, Inc.
X-ray source: monochromatic Al Kα (1486.6 eV)
Detection area: 100 μmϕ
Detection depth: approximately 4 to 5 nm (extraction angle) 45°
Measurement spectrum: wide scanning, narrow scanning of each detected element

The XPS measurement results were analyzed, whereby XPS analysis results shown in Table 5 were obtained. Table 5 shows the number of atoms of each element as a percentage when the total number of atoms of Li, Co, Ni, Al, O, Mg, F, C, Ca, Na, S, Cl, and Ti is 100% in each sample. Although the total amount presented in Table 5 is 100.1% or 99.9% in some cases because numerical values after the analysis are rounded off to be shown in the table, the total number of atoms is calculated as 100.0% in the XPS analysis.

TABLE 5

| | Li | Co | Ni | Al | O | Mg | F |
|---|---|---|---|---|---|---|---|
| Sample 1 | 9.3 | 13.1 | 1.3 | 0.5 | 44.2 | 14.3 | 10.4 |
| Sample 2 | 11.1 | 18.7 | 0.9 | 0 | 54 | 7.4 | 0.4 |
| Comparative sample 1 | 16.9 | 20.5 | 0 | 0 | 50.9 | 0 | 0.3 |
| | C | Ca | Na | S | Cl | Ti | Total |
| Sample 1 | 3.2 | 0.5 | 1.9 | 1 | 0.4 | 0 | 100.0 |
| Sample 2 | 5.3 | 1.3 | 0.6 | 0 | 0 | 0.2 | 100.1 |
| Comparative sample 1 | 9.6 | 0.4 | 1.4 | 0 | 0 | 0 | 99.9 |

When Sample 1 and Sample 2 are compared to Comparative sample 1, larger amounts of Mg and Ni and smaller amounts of Li and Co are detected in Sample 1 and Sample 2 than in Comparative sample 1. This result probably suggests that the surface portion 100a described in Embodiment 1 is formed in Sample 1 and Sample 2.

When Sample 1 is compared to Sample 2, larger amounts of Ni, Mg, and F and smaller amount of Li and Co are detected in Sample 1 than in Sample 2.

The difference between the fabrication conditions of Sample 1 and Sample 2 is that the heating time after mixing of the A1 source and the heating time after mixing of the A2 source are longer in Sample 2. Here, regarding F in Table 5, the number of F atoms is significantly larger in Sample 1 than in Sample 2. In other words, the number of F atoms detected at the surface of Sample 2 is significantly smaller than the number of F atoms detected at the surface of Sample 1.

The assumption is that in the case where lithium cobalt oxide with a median diameter (D50) of less than or equal to 12 μm (preferably less than or equal to 10.5 μm, further preferably less than or equal to 8 μm) endures a long heating time after mixing of the A1 source and a long heating time after mixing of the A2 source in the fabrication conditions of Sample 2, F decreases from the surface portion of the fabricated positive electrode active material. It is probable that when the number of F atoms in the surface portion decreases, the effect of fixing Ni and Mg in the surface portion is reduced and Ni and Mg are diffused into the inner portion from the surface portion of the positive electrode active material.

The number of Ni atoms with respect to the number of Co atoms (Ni/Co), the number of Mg atoms with respect to the number of Co atoms (Mg/Co), and the number of F atoms with respect to the number of Co atoms (F/Co) were calculated on the basis of the XPS analysis results shown in Table 5, whereby the results shown in Table 6 were obtained.

TABLE 6

| | Ni/Co | Mg/Co | F/Co |
|---|---|---|---|
| Sample 1 | 0.099 | 1.092 | 0.794 |
| Sample 2 | 0.048 | 0.396 | 0.021 |
| Comparative sample 1 | 0.000 | 0.000 | 0.015 |

In Sample 1, the number of Ni atoms with respect to the number of Co atoms (Ni/Co) was 0.099, the number of Mg atoms with respect to the number of Co atoms (Mg/Co) was 1.092, and the number of F atoms with respect to the number of Co atoms (F/Co) was 0.794. In Sample 2, the number of Ni atoms with respect to the number of Co atoms (Ni/Co) was 0.048, the number of Mg atoms with respect to the number of Co atoms (Mg/Co) was 0.396, and the number of F atoms with respect to the number of Co atoms (F/Co) was 0.021.

That is, in the XPS analysis of Sample 1, the number of Ni atoms with respect to the number of Co atoms (Ni/Co) was greater than or equal to 0.090, the number of Mg atoms with respect to the number of Co atoms (Mg/Co) was greater than or equal to 1.000, and the number of F atoms with respect to the number of Co atoms (F/Co) was greater than or equal to 0.700. Note that the rechargeable and dischargeable capacity of the positive electrode active material is probably reduced in the case where the amount of Ni, Mg, and F is excessive, e.g., is greater than approximately twice the above-described amount detected in Sample 1.

From the above results, it can be said that in the XPS analysis of lithium cobalt oxide with a median diameter (D50) of less than or equal to 12 μm (preferably less than or equal to 10.5 μm, further preferably less than or equal to 8 μm), the number of Ni atoms with respect to the number of Co atoms (Ni/Co) is preferably greater than or equal to 0.05, further preferably greater than or equal to 0.06, still further preferably greater than or equal to 0.07, greater than or equal to 0.08, yet still further preferably greater than or equal to 0.09. It can also be said that Ni/Co is preferably less than or equal to 0.200, preferably less than or equal to 0.150, preferably less than or equal to 0.140, preferably less than or equal to 0.130, preferably less than or equal to 0.120, or preferably less than or equal to 0.110.

It can be said that in the XPS analysis of lithium cobalt oxide with a median diameter (D50) of less than or equal to 12 μm (preferably less than or equal to 10.5 μm, further preferably less than or equal to 8 μm), the number of Mg atoms with respect to the number of Co atoms (Mg/Co) is preferably greater than or equal to 0.400, further preferably greater than or equal to 0.500, still further preferably greater than or equal to 0.600, yet still further preferably greater than or equal to 0.700, yet still further preferably greater than or equal to 0.800, yet still further preferably greater than or equal to 0.900, yet still further preferably greater than or equal to 1.000. It can also be said that Mg/Co is preferably less than or equal to 2.000, preferably less than or equal to 1.500, preferably less than or equal to 1.400, preferably less than or equal to 1.300, or preferably less than or equal to 1.200.

It can be said that in the XPS analysis of lithium cobalt oxide with a median diameter (D50) of less than or equal to 12 μm (preferably less than or equal to 10.5 μm, further preferably less than or equal to 8 μm), the number of F atoms with respect to the number of Co atoms (F/Co) is preferably greater than or equal to 0.100, further preferably greater than or equal to 0.200, still further preferably greater than or equal to 0.300, yet still further preferably greater than or equal to 0.400, yet still further preferably greater than or equal to 0.500, yet still further preferably greater than or equal to 0.600, yet still further preferably greater than or equal to 0.700. It can also be said that F/Co is preferably less than or equal to 1.500, preferably less than or equal to 1.200, preferably less than or equal to 1.100, preferably less than or equal to 1.000, or preferably less than or equal to 0.900.

It is probable that owing to the above-described features, Sample 1 exhibited particularly outstanding battery performance, which is little degradation due to repeated charge and discharge even in a middle temperature environment of 25° C. and 45° C., as well as being capable of being charged with high voltage and having excellent charge and discharge performance in an environment of −40° C.

### <STEM-EDX Analysis>

Next, STEM-EDX line analysis was performed on Sample 1.

As pretreatment before the analysis, Sample 1 was sliced by an FIB method (u-sampling method).

For STEM and EDX, the following apparatuses and conditions were employed.

### <<STEM Observation>>

Scanning transmission electron microscope: HD-2700 produced by Hitachi High-Tech Corporation
Observation condition Acceleration voltage: 200 KV
Magnification accuracy: ±3%<

### <EDX>

Analysis method: energy dispersive X-ray spectroscopy (EDX)
Scanning transmission electron microscope: HD-2700 produced by Hitachi High-Tech Corporation
Acceleration voltage: 200 kV
Beam diameter: approximately 0.2 nmϕ
Element analysis apparatus: equipped with two (dual) Octane T Ultra W detectors
X-ray detector: Si drift detector
Energy resolution: approximately 130 eV
X-ray extraction angle: 25°
Solid angle: 2 sr
Number of captured pixels: 512×400

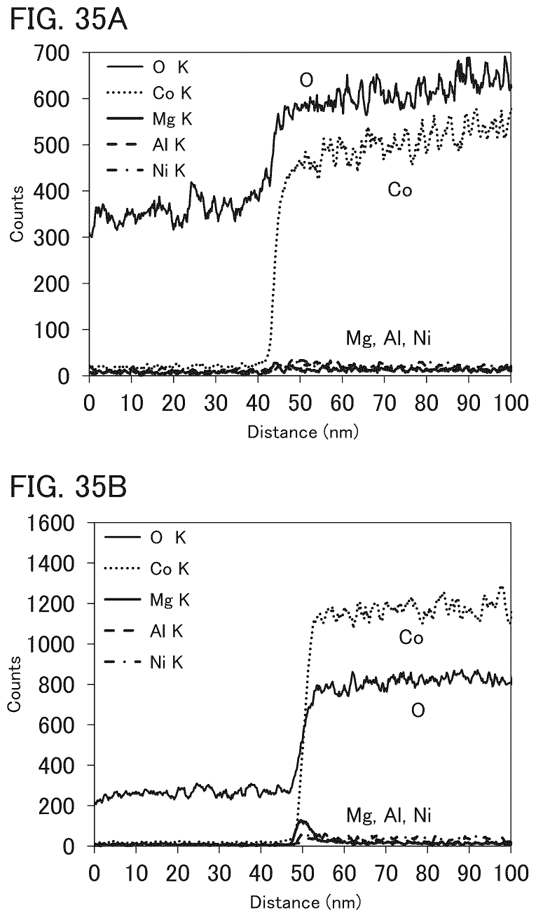

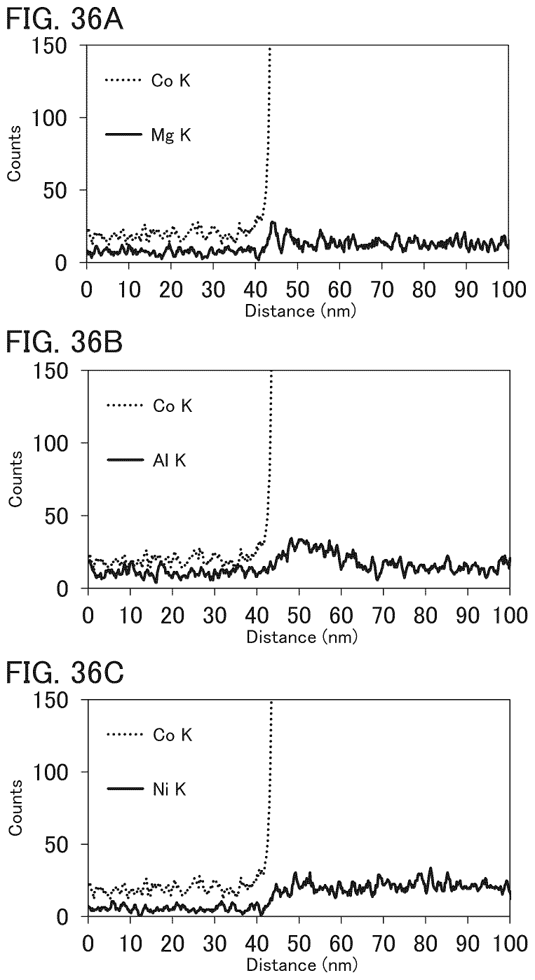

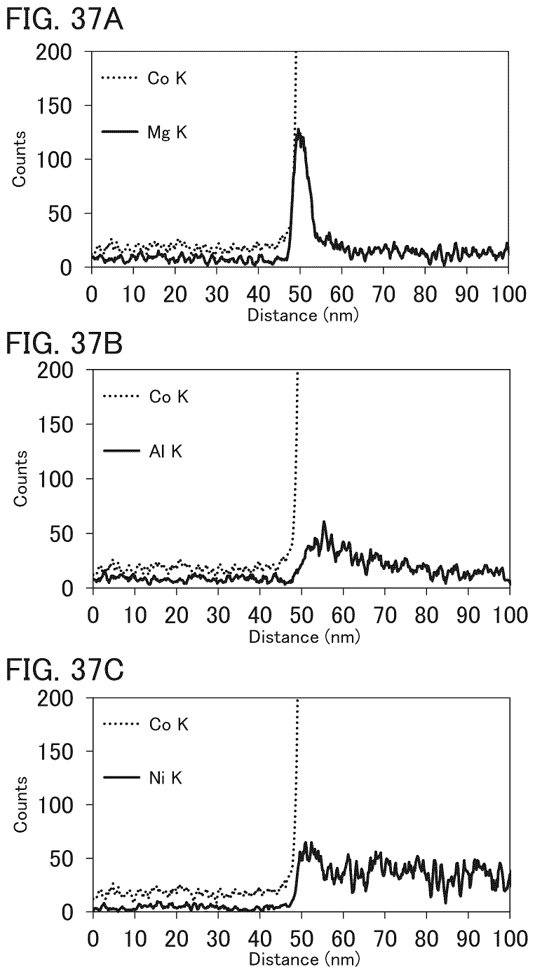

FIG. 35A, FIG. 36A, FIG. 36B, and FIG. 36C show graphs of the characteristic X-ray detection intensity obtained by STEM-EDX line analysis in a basal region (a surface having the (001) orientation) of Sample 1. FIG. 35B, FIG. 37A, FIG. 37B, and FIG. 37C show graphs of the characteristic X-ray detection intensity obtained by STEM-EDX line analysis in an edge region (a surface without (001) orientation) of Sample 1. The data of each measurement point in the graphs of the characteristic X-ray detection intensity shown in FIG. 35A to FIG. 37C was subjected to smoothing so as to be the average value of five points including four adjacent points. Note that the distance between measurement points is approximately 0.2 nm; thus, it can be said that the five-point average is an average value in a region of approximately 0.8 nm.

FIG. 36A, FIG. 36B, and FIG. 36C are graphs in which the vertical axis in FIG. 35A is enlarged. FIG. 36A shows a graph of the characteristic X-ray detection intensity of cobalt and magnesium, FIG. 36B shows a graph of the characteristic X-ray detection intensity of cobalt and aluminum, and FIG. 36C shows a graph of the characteristic X-ray detection intensity of cobalt and nickel. A peak derived from the characteristic X-ray of nickel was not observed in the energy spectrum of Sample I in the basal region. In other words, nickel is substantially absent in the basal region of Sample 1. Thus, the plot indicating nickel shown in FIG. 36C is probably derived not from the characteristic X-ray of nickel but from the characteristic X-ray of cobalt, which is close to nickel in the energy spectrum.

From the graph in FIG. 35A, the surface was assumed as a point with a distance of 44.3 nm. Specifically, a region avoiding the vicinity where the detected amount of cobalt began to increase was defined as a distance of 10 to 20 nm in FIG. 35A. Moreover, a region where the count of cobalt was stable was defined as a distance of 94 to 98 nm. From the graph of the characteristic X-ray detection intensity of cobalt, the point of 50% of the sum of M_{AVE} and M_{BG} was calculated to be 276.8 Counts, and the surface was estimated at 44.3 nm from a calculated regression line.

In FIG. 36A, FIG. 36B, and FIG. 36C, with the direction towards the particle inner portion as the positive direction with reference to the position of the surface estimated above, the peak positions of the additive elements were −0.3 nm for Mg and 3.9 nm for Al. The ratios of the detection intensity of the additive element at the peak position to the average value of the detection intensity of cobalt in the region where the count of cobalt was stable were Mg/Co=0.05 and Al/Co=0.06 in the basal region (the surface having the (001) orientation). The half width of the distribution of magnesium was 2.6 nm.

FIG. 37A, FIG. 37B, and FIG. 37C are graphs in which the vertical axis in FIG. 35B is enlarged. FIG. 37A shows a graph of the characteristic X-ray detection intensity of cobalt and magnesium, FIG. 37B shows a graph of the characteristic X-ray detection intensity of cobalt and aluminum, and FIG. 37C shows a graph of the characteristic X-ray detection intensity of cobalt and nickel. Note that a peak derived from the characteristic X-ray of nickel was clearly observed in the energy spectrum of Sample I in the edge region.

From the graph of the characteristic X-ray detection intensity in FIG. 35B, the surface was assumed as a point with a distance of 50.5 nm. Specifically, a region avoiding the vicinity where the detected amount of cobalt began to increase was defined as a distance of 10 to 20 nm in FIG. 35B. Moreover, a region where the count of cobalt was stable was defined as a distance of 97 to 100 nm. From the graph of the characteristic X-ray detection intensity of cobalt, the point of 50% of the sum of M_{AVE} and M_{BG} was calculated to be 610.2 Counts, and the surface was estimated at 50.5 nm from a calculated regression line.

In FIG. 37A, FIG. 37B, and FIG. 37C, with the direction towards the particle inner portion as the positive direction with reference to the position of the surface estimated above, the peak positions of the additive elements were-0.9 nm for Mg, 4.9 nm for Al, and 1.9 nm for Al. Regarding the ratio of the detection intensity of the additive element at the peak position to the average value of the detection intensity of cobalt in the region where the count of cobalt was stable, the intensity ratios in the edge region (the surface without (001) orientation) were Mg/Co=0.11, Al/Co=0.05, and Ni/Co=0.05. The half width of the distribution of magnesium was 4.5 nm, and the half width of the distribution of nickel was 8.1 nm.

As described above, Sample 1 demonstrated that the basal region and the edge region each included a region where magnesium was distributed closer to the surface side of the positive electrode active material than aluminum was. It was also demonstrated that the edge region included a region where magnesium and nickel were distributed closer to the surface side of the positive electrode active material than aluminum was. Note that the edge region demonstrated that the peak position of magnesium and the peak position of nickel were close to each other, and the distribution of magnesium included a region overlapping with the distribution of nickel.

### REFERENCE NUMERALS

10: lithium ion battery, 11: positive electrode, 12: negative electrode, 13: separator, 21: positive electrode current collector, 22: positive electrode active material layer, 31: negative electrode current collector, 32: negative electrode active material layer, 41: conductive material, 42: graphene, 43: carbon black, 44: carbon fiber, 51: electrolyte, 100a: surface portion, 100b: inner portion, 100: positive electrode active material, 110: second positive electrode active material, 300: secondary battery, 301: positive electrode can, 302: negative electrode can, 303: gasket, 304: positive electrode, 305: positive electrode current collector, 306: positive electrode active material layer, 307: negative electrode, 308: negative electrode current collector, 309: negative electrode active material layer, 310: separator, 312: washer, 322: spacer, 500: secondary battery, 501: positive electrode current collector, 502: positive electrode active material layer, 503: positive electrode, 504: negative electrode current collector, 505: negative electrode active material layer, 506: negative electrode, 507: separator, 509: exterior body, 510: positive electrode lead electrode, 511: negative electrode lead electrode, 513: secondary battery, 514: terminal, 515: sealant, 517: antenna, 519: layer, 529: label, 531: secondary battery pack, 540: circuit board, 552: other, 590a: circuit system, 590b: circuit system, 590: control circuit, 601: positive electrode cap, 602: battery can, 603: positive electrode terminal, 604: positive electrode, 605: separator, 606: negative electrode, 607: negative electrode terminal, 608: insulating plate, 609: insulating plate, 611: PTC element, 613: safety valve mechanism, 614: conductive plate, 615: power storage system, 616: secondary battery, 620: control circuit, 621: wiring, 622: wiring, 623: wiring, 624: conductor, 625: insulator, 626: wiring, 627: wiring, 628: conductive plate, 701: commercial power source, 703: distribution board, 705: power storage controller, 706: indicator, 707: general load, 708: power storage load, 709: router, 710: service wire mounting portion, 711: measuring portion, 712: predicting portion, 713: planning portion, 790: control device, 791: power storage device, 796: underfloor space, 799: building, 903: mixture, 904: mixture, 911a: terminal, 911b: terminal, 913: secondary battery, 930a: housing, 930b: housing, 930: housing, 931a: negative electrode active material layer, 931: negative electrode, 932a: positive electrode active material layer, 932: positive electrode, 933: separator, 950a: wound body, 950: wound body, 951: terminal, 952: terminal, 1300: rectangular secondary battery, 1301a: first battery, 1301b: first battery, 1302: battery controller, 1303: motor controller, 1304: motor, 1305: gear, 1306: DCDC circuit, 1307: electric power steering, 1308: heater, 1309: defogger, 1310: DCDC circuit, 1311: second battery, 1312: inverter, 1313: stereo, 1314: power window, 1315: lamps, 1316: tire, 1317: rear motor, 1320: control circuit portion, 1321: control circuit portion, 1322: control circuit, 1324: switch portion, 1413: fixing portion, 1414: fixing portion, 1415: battery pack, 1421: wiring, 1422: wiring, 2001: automobile, 2002: transporter, 2003: transport vehicle, 2004: aircraft, 2005: artificial satellite, 2100: mobile phone, 2101: housing. 2102: display portion, 2103: operation button, 2104: external connection port, 2105: speaker, 2106: microphone, 2107: secondary battery, 2200: battery pack, 2201: battery pack, 2202: battery pack, 2203: battery pack, 2204: secondary battery, 2300: unmanned aircraft, 2301: secondary battery, 2302: rotor, 2303: camera, 2603: vehicle, 2604: charge equipment, 2610: solar panel, 2611: wiring, 2612: power storage device, 4000a: frame, 4000b: display portion, 4000: glasses-type device, 4001a: microphone portion, 4001b: flexible pipe, 4001c: earphone portion, 4001: headset-type device, 4002a: housing, 4002b: secondary battery, 4002: device, 4003a: housing, 4003b: secondary battery, 4003: device, 4005a: display portion, 4005b: belt portion, 4005: watch-type device, 4006a: belt portion, 4006b: wireless power feeding and receiving portion, 4006: belt-type device, 6300: cleaning robot, 6301: housing, 6302: display portion, 6303: camera, 6304: brush, 6305: operation button, 6306: secondary battery, 6310: dust, 6400: robot, 6401: illuminance sensor, 6402: microphone, 6403: upper camera, 6404: speaker, 6405: display portion, 6406: lower camera, 6407: obstacle sensor, 6408: moving mechanism, 6409: secondary battery, 8600: motor scooter, 8601: side mirror, 8602: power storage device, 8603: indicator light, 8604: under-seat storage unit, 8700: electric bicycle, 8701: storage battery, 8702: power storage device, 8703: display portion, 8704: control circuit

1. A positive electrode active material comprising:
cobalt, oxygen, magnesium, aluminum, and nickel,
wherein a median diameter of the positive electrode active material is greater than or equal to 1 μm and less than or equal to 12 μm,
wherein the positive electrode active material comprises the magnesium and the aluminum in a surface portion,
wherein the surface portion is a region within 50 nm in depth from a surface of the positive electrode active material, and
wherein when the positive electrode active material is subjected to EDX line analysis in a depth direction, the positive electrode active material comprises a region where the magnesium is distributed closer to a surface side of the positive electrode active material than the aluminum is.

2. The positive electrode active material according to claim 1,
wherein the positive electrode active material has a layered rock-salt crystal structure belonging to a space group R-3m,
wherein the surface portion comprises a basal region comprising a surface parallel to a (001) plane of the crystal structure and an edge region comprising a surface in a direction intersecting with the (001) plane, and
wherein when the positive electrode active material is subjected to EDX line analysis in the depth direction, the edge region comprises a region where distribution of the magnesium and distribution of the nickel overlap with each other.

3. The positive electrode active material according to claim 2,
wherein the nickel is substantially absent in the basal region.

4. The positive electrode active material according to claim 1,
wherein when the positive electrode active material is analyzed by XPS, a number of atoms of the magnesium with respect to a number of atoms of the cobalt, Mg/Co, is greater than or equal to 0.400 and less than or equal to 1.500, and
wherein a number of atoms of the nickel with respect to the number of the atoms of the cobalt, Ni/Co, is greater than or equal to 0.050 and less than or equal to 0.150.

5. The positive electrode active material according to claim 4,
further comprising fluorine,
wherein when the positive electrode active material is analyzed by XPS, a number of atoms of the fluorine with respect to the number of the atoms of the cobalt, F/Co, is greater than or equal to 0.100 and less than or equal to 1.000.

6. A lithium ion battery comprising:
a positive electrode comprising the positive electrode active material according to claim 1; and
an electrolyte,
wherein the electrolyte comprises lithium hexafluorophosphate, ethylene carbonate, ethyl methyl carbonate, and dimethyl carbonate.

7. The lithium ion battery according to claim 6,
wherein given that a volume of a total content of the ethylene carbonate, the ethyl methyl carbonate, and the dimethyl carbonate in the electrolyte is 100 vol %, a volume ratio between the ethylene carbonate, the ethyl methyl carbonate, and the dimethyl carbonate is x:y:100-x-y, where 5≤x≤35 and 0<y<65.

8. The lithium ion battery according to claim 7,
wherein the electrolyte comprises the lithium hexafluorophosphate of more than or equal to 0.5 mol/L and less than or equal to 1.5 mol/L with respect to the volume of the total content of the ethylene carbonate, the ethyl methyl carbonate, and the dimethyl carbonate.

9. An electronic device comprising the lithium ion battery according to claim 6.

10. A vehicle comprising the lithium ion battery according to claim 6.
